(19) United States
(12) Patent Application Publication
(10) Pub. No.: US 2026/0129494 A1
(43) Pub. Date: May 7, 2026

(54) METHOD AND DEVICE FOR RECEIVING AND TRANSMITTING INFORMATION

(71) Applicant: Samsung Electronics Co., Ltd., Suwon-si (KR)

(72) Inventors: Zhe CHEN, Beijing (CN); Feifei SUN, Beijing (CN); Sa ZHANG, Beijing (CN)

(21) Appl. No.: 19/382,025

(22) Filed: Nov. 6, 2025

(30) Foreign Application Priority Data
Nov. 6, 2024 (CN) 202411579563.0
Nov. 15, 2024 (CN) 202411641673.5
Feb. 6, 2025 (CN) 202510134367.0
Mar. 26, 2025 (CN) 202510371135.7
Jun. 26, 2025 (CN) 202510875943.7

(51) Int. Cl. H04W 24/10

(52) U.S. Cl. CPC H04W 24/10

(57) ABSTRACT

The disclosure relates to a 5G or 6G communication system for supporting a higher data transmission rate. The disclosure provides a method performed by a user equipment (UE) in a wireless communication system and a UE performing the method. The method includes receiving a channel state information (CSI) reporting configuration, wherein the CSI reporting configuration is associated with a resource set for channel measurement; reporting X first CSI report(s), wherein CSI in each of the X first CSI report(s) is for reporting inference and/or prediction and is associated with F time instance(s), F≥1; reporting a second CSI report, wherein CSI in the second CSI report is determined based on comparison of a resource associated with a resource indicator included in CSI associated with each time instance in each of the X first CSI report(s) with a resource determined based on measurement of the resource set for channel measurement.

### CROSS-REFERENCE TO RELATED APPLICATIONS

This application is based on and claims priority under 35 U.S.C. § 119 to Chinese Patent Application No. 202411579563.0 filed on Nov. 6, 2024, Chinese Patent Application No. 202411641673.5 filed on Nov. 15, 2024, Chinese Patent Application No. 202510134367.0 filed on Feb. 6, 2025, Chinese Patent Application No. 202510371135.7 filed on Mar. 26, 2025, and Chinese Patent Application No. 202510875943.7 filed on Jun. 26, 2025, in the Chinese Intellectual Property Office, the disclosure of which is incorporated by reference herein in its entirety.

### BACKGROUND

### 1. Field

The present application relates to the technical field of a wireless communication, and more specifically, to a method and device for receiving and transmitting information.

### 2. Description of Related Art

In order to meet the increasing demand for wireless data communication services since the deployment of 4^{th} generation (4G) communication systems, efforts have been made to develop improved 5^{th} generation (5G) or pre-5G communication systems. Therefore, 5G or pre-5G communication systems are also called “Beyond 4G networks” or “Post-LTE systems.”

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid frequency shift keying (FSK) and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

Transmission from a base station to a user equipment (UE) is called downlink, and transmission from the UE to the base station is called uplink.

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

In order to enhance the scheduling efficiency of 5G wireless communication system, a base station may obtain channel state information (CSI) to schedule according to the CSI fed back by a terminal equipment. However, how to further enhance the performance of CSI reporting is a problem to be solved.

An aspect of the disclosure provides a method performed by a user equipment (UE) in a wireless communication system, the method includes receiving a channel state information (CSI) reporting configuration, wherein the CSI reporting configuration is associated with a resource set for channel measurement; reporting X first CSI report(s), wherein CSI in each of the X first CSI report(s) is for reporting inference and/or prediction and is associated with F time instance(s), F≥1; reporting a second CSI report, wherein CSI in the second CSI report is determined based on comparison of a resource associated with a resource indicator included in CSI associated with each time instance in each of the X first CSI report(s) with a resource determined based on measurement of the resource set for channel measurement.

In an example, the CSI reporting configuration indicates a number N1 of reported resources, each of the X first CSI report(s) includes N1 resource indicators, and wherein the CSI in the second CSI report is determined based on comparison of resources associated with the N1 resource indicators in CSI associated with the f-th time instance in the x-th CSI report of the X first CSI report(s) and the resource determined based on measurement of the resource set for channel measurement, wherein x is any integer value ranged from 1 to X, and f is any integer value ranged from 1 to F.

In an example, the comparison includes determining whether a resource with the highest measured Layer 1-Reference Signal Received Power (L1-RSRP) of the resource set for channel measurement determined based on measurement of the resource set for channel measurement is one of the resources associated with the N1 resource indicators in the CSI associated with the f-th time instance in the x-th CSI report.

In an example, the resources associated with the N1 resource indicators include a resource associated with each of the N1 resource indicators; or a resource associated with one of the N1 resource indicators.

In an example, the comparison includes determining whether the resource associated with one of the N1 resource indicators in the CSI associated with the f-th time instance in the x-th CSI report is one of N2 resources with the highest L1-RSRP of the resource set for channel measurement determined based on measurement of the resource set for channel measurement, N2≥1, wherein N2 is indicated by the CSI reporting configuration.

In an example, the comparison includes determining whether a difference of measured L1-RSRP of the resource associated with one of the N1 resource indicators in the CSI associated with the f-th time instance in the x-th CSI report and the highest measured L1-RSRP determined based on measurement of the resource set for channel measurement is less than a threshold, wherein the threshold is a predefined value, or the threshold is indicated by the base station, or the threshold is determined based on UE capability.

In an example, one of the N1 resource indicators is a resource indicator with the largest predicted L1-RSRP; or the first resource indicator of the N1 resource indicators.

In an example, wherein a value of the CSI in the second CSI report is k, 0≤k≤X, k is a number of CSI reports with results of corresponding comparison being true of the X first CSI report(s), and wherein accuracy rate corresponding to the CSI in the second CSI report is k/X, and a size of a field of the CSI in the second CSI report is ┌log₂ X┐ or log₂ X, wherein ┌log₂ X┐ represents round up of log₂ X.

In an example, the result of the corresponding comparison being true in the first CSI report includes: results of the comparison of all time instances associated with the first CSI report being true; or a result of the comparison of at least one time instance associated with the first CSI report being true.

In an example, a value of the CSI in the second CSI report is k, 0≤k≤F*X, k is a number of time instances with results of corresponding comparison associated with the X first CSI report(s) being true, and wherein accuracy rate corresponding to the CSI in the second CSI report is

$$\frac{k}{F \cdot X} ,$$

and a size of a field of the CSI in the second CSI report is ┌log₂(F·X)┐ or log₂(F·X) wherein ┌log₂(F·X)┐ represents round up of log₂(F·X).

In an example, the CSI reporting configuration indicates a resource set for prediction and/or inference, and wherein the resource indicator corresponds to a resource of the resource set for prediction and/or inference, and the resource associated with the resource indicator includes a resource of the resource set for channel measurement mapped with the resource of the resource set for prediction and/or inference corresponding to the resource indicator.

In an example, each resource of the resource set for prediction and/or inference is mapped with a resource of the resource set for channel measurement; or each resource of the resource set for channel measurement is mapped with a resource of the resource set for prediction and/or inference.

In an example, each resource of the resource set for prediction and/or inference is mapped with a resource of the resource set for channel measurement based on the CSI reporting configuration; or each resource of the resource set for channel measurement is mapped with a resource of the resource set for prediction and/or inference based on the CSI reporting configuration; or when a number of resources of the resource set for prediction and/or inference is the same as a number of resources of the resource set for channel measurement, the i-th resource of the resource set for prediction and/or inference is mapped with the i-th resource of the resource set for channel measurement; or the i-th resource of the resource set for prediction and/or inference is mapped with the ┌i/D┐-th resource of the resource set for channel measurement, where D≥1, and ┌i/D┐ represents round up of i/D.

In an example, D is indicated by the base station, or predefined, or determined based on the UE capability.

In an example, the X first CSI report(s) are no later than the second CSI report; or each time instance associated with each of the X first CSI report(s) is no later than the second CSI report.

In an example, when the first CSI report is aperiodic CSI report, X=1; or when the first CSI report is semi-persistent or periodic CSI report and/or the second CSI report is aperiodic CSI report, the X first CSI report(s) are the latest X first CSI report(s) with all associated time instances being before the DCI triggering the second CSI report; or when the first CSI report is semi-persistent or periodic CSI report and/or the second CSI report is semi-persistent or periodic CSI report, the X first CSI report(s) are the latest X first CSI report(s) with all associated time instances being no later than the second CSI report.

In an example, the measurement of the resource set for channel measurement is measurement of a transmission occasion of a resource of the resource set for channel measurement, and/or measurement of the resource set for channel measurement in a window associated with a time instance.

In an example, a transmission occasion associated with the f-th time instance associated with the x-th first CSI report of the X first CSI report(s) may be at least one of the followings, and X is any integer value ranged from 1 to X: the latest transmission occasion of a resource of the resource set for channel measurement no later than a CSI reference resource corresponding to the second CSI report; the x-th latest transmission occasion of the resource of the resource set for channel measurement no later than the CSI reference resource corresponding to the second CSI report; a transmission occasion of a resource of the resource set for channel measurement closest to the f-th time instance associated with the x-th CSI report.

In an example, a length of the window is determined based on a periodicity of the first CSI report and/or a periodicity associated with the resource set for channel measurement and/or a distance between adjacent time instances associated with the first CSI report.

In an example, a starting time domain resource and/or an ending time domain resource of the window associated with the f-th time instance associated with the x-th CSI report is determined based on at least one of the followings: the CSI reporting configuration; a time domain resource where the f-th time instance is located; the length of the window; the periodicity of the first CSI report; the periodicity associated with the resource set for channel measurement.

Another aspect of the disclosure provides a method performed by a base station in a wireless communication system, the method includes transmitting a channel state information (CSI) reporting configuration, wherein the CSI reporting configuration is associated with a resource set for channel measurement; receiving X first CSI report(s), wherein CSI in each of the X first CSI report(s) is for reporting inference and/or prediction and is associated with F time instance(s), F≥1; receiving a second CSI report, wherein CSI in the second CSI report is determined based on comparison of a resource associated with a resource indicator included in CSI associated with each time instance in each of the X first CSI report(s) with a resource determined based on measurement of the resource set for channel measurement.

In an example, the CSI reporting configuration indicates a number N1 of reported resources, each of the X first CSI report(s) includes N1 resource indicators, and wherein the CSI in the second CSI report is determined based on comparison of resources associated with the N1 resource indicators in CSI associated with the f-th time instance in the x-th CSI report of the X first CSI report(s) and the resource determined based on measurement of the resource set for channel measurement, wherein x is any integer value ranged from 1 to X, and f is any integer value ranged from 1 to F.

In an example, the comparison includes determining whether a resource with the highest measured Layer 1-Reference Signal Received Power (L1-RSRP) of the resource set for channel measurement determined based on measurement of the resource set for channel measurement is one of the resources associated with the N1 resource indicators in the CSI associated with the f-th time instance in the x-th CSI report.

In an example, the resources associated with the N1 resource indicators include a resource associated with each of the N1 resource indicators; or a resource associated with one of the N1 resource indicators.

In an example, the comparison includes determining whether the resource associated with one of the N1 resource indicators in the CSI associated with the f-th time instance in the x-th CSI report is one of N2 resources with the highest L1-RSRP of the resource set for channel measurement determined based on measurement of the resource set for channel measurement, N2≥1, wherein N2 is indicated by the CSI reporting configuration.

In an example, the comparison includes determining whether a difference of measured L1-RSRP of the resource associated with one of the N1 resource indicators in the CSI associated with the f-th time instance in the x-th CSI report and the highest measured L1-RSRP determined based on measurement of the resource set for channel measurement is less than a threshold, wherein the threshold is a predefined value, or the threshold is indicated by the base station, or the threshold is determined based on UE capability.

In an example, one of the N1 resource indicators is a resource indicator with the largest predicted L1-RSRP; or the first resource indicator of the N1 resource indicators.

In an example, wherein a value of the CSI in the second CSI report is k, 0≤k≤X, k is a number of CSI reports with results of corresponding comparison being true of the X first CSI report(s), and wherein accuracy rate corresponding to the CSI in the second CSI report is k/X, and a size of a field of the CSI in the second CSI report is ┌log₂ X┐ or log₂ X, wherein ┌log₂ X┐ represents round up of log₂ X.

In an example, the result of the corresponding comparison being true in the first CSI report includes: results of the comparison of all time instances associated with the first CSI report being true; or a result of the comparison of at least one time instance associated with the first CSI report being true.

In an example, a value of the CSI in the second CSI report is k, 0≤k≤F*X, k is a number of time instances with results of corresponding comparison associated with the X first CSI report(s) being true, and wherein accuracy rate corresponding to the CSI in the second CSI report is

$$\frac{k}{F \cdot X} ,$$

and a size of a field of the CSI in the second CSI report is ┌log₂(F·X)┐ or log₂(F·X), wherein ┌log₂(F·X)┐ represents round up of log₂(F·X).

In an example, the CSI reporting configuration indicates a resource set for prediction and/or inference, and wherein the resource indicator corresponds to a resource of the resource set for prediction and/or inference, and the resource associated with the resource indicator includes a resource of the resource set for channel measurement mapped with the resource of the resource set for prediction and/or inference corresponding to the resource indicator.

In an example, each resource of the resource set for prediction and/or inference is mapped with a resource of the resource set for channel measurement; or each resource of the resource set for channel measurement is mapped with a resource of the resource set for prediction and/or inference.

In an example, each resource of the resource set for prediction and/or inference is mapped with a resource of the resource set for channel measurement based on the CSI reporting configuration; or each resource of the resource set for channel measurement is mapped with a resource of the resource set for prediction and/or inference based on the CSI reporting configuration; or when a number of resources of the resource set for prediction and/or inference is the same as a number of resources of the resource set for channel measurement, the i-th resource of the resource set for prediction and/or inference is mapped with the i-th resource of the resource set for channel measurement; or the i-th resource of the resource set for prediction and/or inference is mapped with the ┌i/D┐-th resource of the resource set for channel measurement, where D≥1, and ┌i/D┐ represents round up of i/D.

In an example, D is indicated by the base station, or predefined, or determined based on the UE capability.

In an example, the X first CSI report(s) are no later than the second CSI report; or each time instance associated with each of the X first CSI report(s) is no later than the second CSI report.

In an example, when the first CSI report is aperiodic CSI report, X=1; or when the first CSI report is semi-persistent or periodic CSI report and/or the second CSI report is aperiodic CSI report, the X first CSI report(s) are the latest X first CSI report(s) with all associated time instances being before the DCI triggering the second CSI report; or when the first CSI report is semi-persistent or periodic CSI report and/or the second CSI report is semi-persistent or periodic CSI report, the X first CSI report(s) are the latest X first CSI report(s) with all associated time instances being no later than the second CSI report.

In an example, the measurement of the resource set for channel measurement is measurement of a transmission occasion of a resource of the resource set for channel measurement, and/or measurement of the resource set for channel measurement in a window associated with a time instance.

In an example, a transmission occasion associated with the f-th time instance associated with the x-th first CSI report of the X first CSI report(s) may be at least one of the followings, and X is any integer value ranged from 1 to X: the latest transmission occasion of a resource of the resource set for channel measurement no later than a CSI reference resource corresponding to the second CSI report; the x-th latest transmission occasion of the resource of the resource set for channel measurement no later than the CSI reference resource corresponding to the second CSI report; a transmission occasion of a resource of the resource set for channel measurement closest to the f-th time instance associated with the x-th CSI report.

In an example, a length of the window is determined based on a periodicity of the first CSI report and/or a periodicity associated with the resource set for channel measurement and/or a distance between adjacent time instances associated with the first CSI report.

In an example, a starting time domain resource and/or an ending time domain resource of the window associated with the f-th time instance associated with the x-th CSI report is determined based on at least one of the followings: the CSI reporting configuration; a time domain resource where the f-th time instance is located; the length of the window; the periodicity of the first CSI report; the periodicity associated with the resource set for channel measurement.

Another aspect of the disclosure provides a user equipment including a transceiver; and a controller coupled to the transceiver, the controller is configured to perform the above method which may be performed by the user equipment.

Yet another aspect of the disclosure provides a base station including a transceiver; and a controller coupled to the transceiver, the controller is configured to perform above the method which may be performed by the base station.

The method provided in the application improve the performance of CSI reporting, improving the scheduling efficiency of the communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of the disclosure will become more apparent from the following detailed description when taken in conjunction with the accompanying drawings.

FIG. 1 illustrates an overall structure of an example wireless communication network according to various embodiments of the disclosure;

FIGS. 2A and 2B respectively illustrate a transmission path and a reception path 250 in a wireless communication network according to various embodiments of the disclosure;

FIGS. 3A and 3B respectively illustrate structures of a user equipment (UE) and a base station in a wireless communication network according to various embodiments of the disclosure;

FIG. 4 illustrates a method performed by a user equipment (UE) according to various embodiments of the disclosure;

FIG. 5 illustrates a method performed by a base station according to various embodiments of the disclosure;

FIG. 6 illustrates a structure of a user equipment according to various embodiments of the disclosure; and

FIG. 7 illustrates a structure of a base station according to various embodiments of the disclosure.

### DETAILED DESCRIPTION

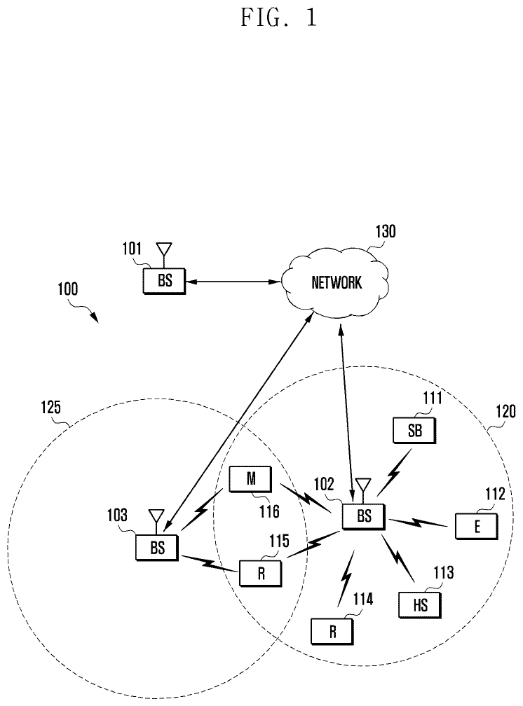

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

The various embodiments of the disclosure can be applied to various communication systems, such as: global system for mobile communications (GSM) system, code division multiple access (CDMA) system, broadband code division multiple access (WCDMA) system, general packet radio service (GPRS), long term evolution (LTE) system Frequency division duplex (FDD) systems, time division duplex (TDD) systems, universal mobile telecommunications systems (UMTS), global interoperability for microwave access (WiMAX) communication systems, fifth generation (5G) systems or new wireless (NR) systems, etc. In addition, the various embodiments of the disclosure can be applied to future oriented communication technologies.

FIG. 1 illustrates an example wireless networK100 according to various embodiments of the disclosure. The embodiment of the wireless networK100 shown in FIG. 1 is for illustration only. Other embodiments of the wireless networK100 can be used without departing from the scope of the disclosure.

The wireless networK100 includes a gNodeB (gNB) 101, a gNB 102, and a gNB 103. gNB 101 communicates with gNB 102 and gNB 103. gNB 101 also communicates with at least one Internet Protocol (IP) networK130, such as the Internet, a private IP network, or other data networks.

Depending on a type of the network, other well-known terms such as “base station” or “access point” can be used instead of “gNodeB” or “gNB.” For convenience, the terms “gNodeB” and “gNB” are used in this patent document to refer to network infrastructure components that provide wireless access for remote terminals. And, depending on the type of the network, other well-known terms such as “mobile station,” “user station,” “remote terminal,” “wireless terminal” or “user apparatus” can be used instead of “user equipment” or “UE.” For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the networK130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to networK130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless networK100, various changes can be made to FIG. 1. The wireless networK100 can include any number of gNBs and any number of UEs in any suitable arrangement, for example. Furthermore, gNB 101 can directly communicate with any number of UEs and provide wireless broadband access to the networK130 for those UEs. Similarly, each gNB 102-103 can directly communicate with the networK130 and provide direct wireless broadband access to the networK130 for the UEs. In addition, gNB 101, 102 and/or 103 can provide access to other or additional external networks, such as external telephone networks or other types of data networks.

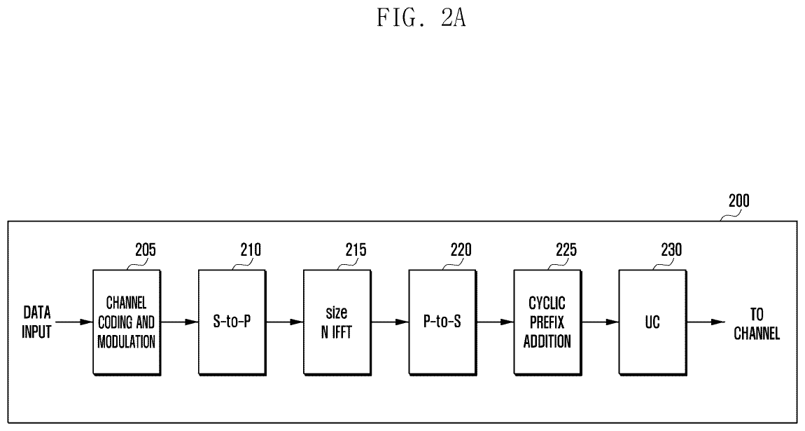

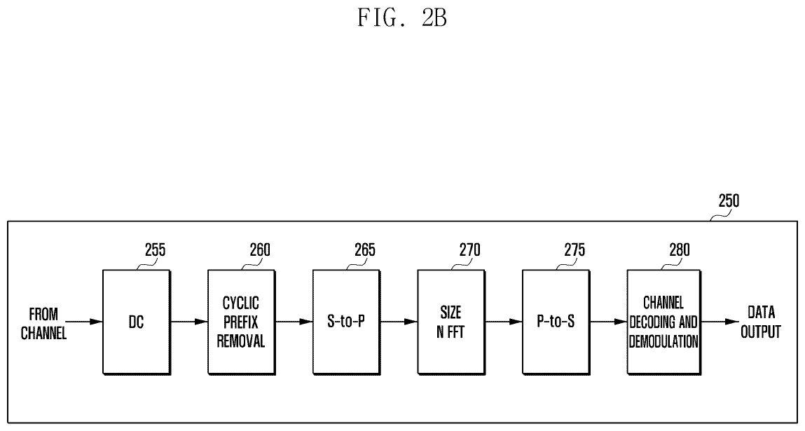

FIGS. 2A and 2B illustrate example wireless transmission and reception paths according to the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation blocK205, a Serial-to-Parallel (S-to-P) blocK210, a size N Inverse Fast Fourier Transform (IFFT) blocK215, a Parallel-to-Serial (P-to-S) blocK220, a cyclic prefix addition blocK225, and an up-converter (UC) 230. The reception path 250 includes a down-converter (DC) 255, a cyclic prefix removal blocK260, a Serial-to-Parallel (S-to-P) blocK265, a size N Fast Fourier Transform (FFT) blocK270, a Parallel-to-Serial (P-to-S) blocK275, and a channel decoding and demodulation blocK280.

In the transmission path 200, the channel coding and modulation blocK205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency domain modulated symbols. The Serial-to-Parallel (S-to-P) blocK210 converts (such as demultiplexes) serial modulated symbols into parallel data to generate N parallel symbol streams, where N is a size of the IFFT/FFT used in gNB 102 and UE 116. The size N IFFT blocK215 performs IFFT operations on the N parallel symbol streams to generate a time domain output signal. The Parallel-to-Serial blocK220 converts (such as multiplexes) parallel time domain output symbols from the Size N IFFT blocK215 to generate a serial time domain signal. The cyclic prefix addition blocK225 inserts a cyclic prefix into the time domain signal. The up-converter 230 modulates (such as up-converts) the output of the cyclic prefix addition blocK225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The downconverter 255 down-converts the received signal to a baseband frequency, and the cyclic prefix removal blocK260 removes the cyclic prefix to generate a serial time domain baseband signal. The Serial-to-Parallel blocK265 converts the time domain baseband signal into a parallel time domain signal. The Size N FFT blocK270 performs an FFT algorithm to generate N parallel frequency domain signals. The Parallel-to-Serial blocK275 converts the parallel frequency domain signal into a sequence of modulated data symbols. The channel decoding and demodulation blocK280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT blocK270 and IFFT blocK215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.)

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

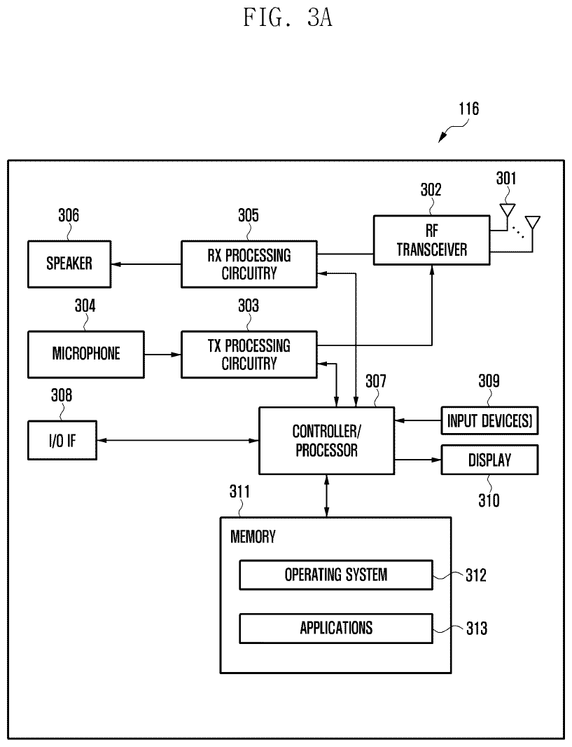

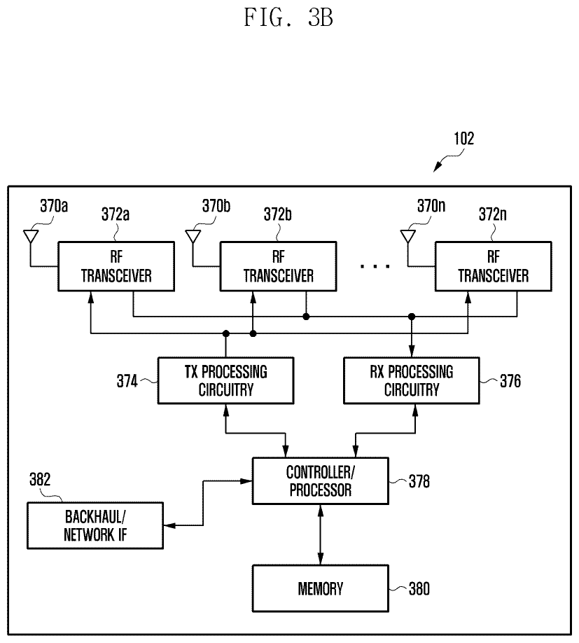

FIG. 3A illustrates an example UE 116 according to the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 301, a radio frequency (RF) transceiver 302, a transmission (TX) processing circuit 303, a microphone 304, and a reception (RX) processing circuit 305. UE 116 also includes a speaker 306, a controller/processor 307, an input/output (I/O) interface 308, an input device(s) 309, a display 310, and a memory 311. The memory 311 includes an operating system (OS) 312 and one or more applications 313.

The RF transceiver 302 receives an incoming RF signal transmitted by a gNB of the wireless networK100 from the antenna 301. The RF transceiver 302 down-converts the incoming RF signal to generate an intermediate frequency (IF) or baseband signal. The IF or baseband signal is transmitted to the RX processing circuit 305, where the RX processing circuit 305 generates a processed baseband signal by filtering, decoding and/or digitizing the baseband or IF signal. The RX processing circuit 305 transmits the processed baseband signal to speaker 306 (such as for voice data) or to controller/processor 307 for further processing (such as for web browsing data).

The TX processing circuit 303 receives analog or digital voice data from microphone 304 or other outgoing baseband data (such as network data, email or interactive video game data) from controller/processor 307. The TX processing circuit 303 encodes, multiplexes, and/or digitizes the outgoing baseband data to generate a processed baseband or IF signal. The RF transceiver 302 receives the outgoing processed baseband or IF signal from the TX processing circuit 303 and up-converts the baseband or IF signal into an RF signal transmitted via the antenna 301.

The controller/processor 307 can include one or more processors or other processing devices and execute an OS 312 stored in the memory 311 in order to control the overall operation of UE 116. For example, the controller/processor 307 can control the reception of forward channel signals and the transmission of backward channel signals through the RF transceiver 302, the RX processing circuit 305 and the TX processing circuit 303 according to well-known principles. In some embodiments, the controller/processor 307 includes at least one microprocessor or microcontroller.

The controller/processor 307 is also capable of executing other processes and programs residing in the memory 311, such as operations for channel quality measurement and reporting for systems with 2D antenna arrays as described in embodiments of the disclosure. The controller/processor 307 can move data into or out of the memory 311 as required by an execution process. In some embodiments, the controller/processor 307 is configured to execute the application 313 based on the OS 312 or in response to signals received from the gNB or the operator. The controller/processor 307 is also coupled to an I/O interface 308, where the I/O interface 308 provides UE 116 with the ability to connect to other devices such as laptop computers and handheld computers. I/O interface 308 is a communication path between these accessories and the controller/processor 307.

The controller/processor 307 is also coupled to the input device(s) 309 and the display 310. An operator of UE 116 can input data into UE 116 using the input device(s) 309. The display 310 may be a liquid crystal display or other display capable of presenting text and/or at least limited graphics (such as from a website). The memory 311 is coupled to the controller/processor 307. Apart of the memory 311 can include a random access memory (RAM), while another part of the memory 311 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the controller/processor 307 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher layer wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Embodiments of the present application are described in detail below with reference to the accompanying drawings.

In the disclosure, the term “channel state information (CSI)” may be used interchangeably with the terms “CSI parameter” or “CSI quantity.”

In the disclosure, CSI may include at least one of the followings: CSI reference signal (CSI-RS) resource indicator (CRI), rank indicator (RI), precoding matrix indicator (PMI), precoding vector indicator (PVI), channel quality indicator (CQI), layer indicator (LI), synchronization signal (SS)/physical broadcast channel (PBCH) block resource indicator (SSBRI), layer 1-reference signal received power (L1-RSRP), layer 1-single to interference noise ratio (L1-SINR), CapabilityIndex.

In the disclosure, the term “CSI reporting configuration” may be used interchangeably with the terms “CSI reporting configuration information” or “information for CSI reporting configuration” or “information for configuring CSI report.”

In the disclosure, the CSI may be the CSI reported by the UE in a report, or in a report instance.

In the disclosure, the term “reference signal” may be used interchangeably with the term “reference signal resource.”

In the disclosure, the reference signal may include at least one of the followings: a reference signal for synchronization, a reference signal for demodulation (e.g., a demodulation reference signal (DM-RS), a reference signal for obtaining of the channel state, a reference signal for phase tracking, a reference signal for mobility, a reference signal for positioning, a reference signal for channel measurement, a reference signal for interference measurement, a reference signal for sounding. Optionally, the reference signal for synchronization includes at least one of the followings: a primary synchronization signal, a secondary synchronization signal. Optionally, the reference signal for synchronization may include a synchronization signal/physical broadcast channel block (SS/PBCH block, SSB). Optionally, the reference signal for demodulation may include at least one of the followings: a reference signal for data channel demodulation and a reference signal for control channel demodulation. Optionally, the data channel may include at least one of the followings: a physical downlink shared channel (PDSCH) and a physical uplink shared channel (PUSCH). Optionally, the control channel may include at least one of the followings: a physical downlink control channel (PDCCH) and a physical uplink control channel (PUCCH). Optionally, the reference signal for obtaining of the channel state may include at least one of the followings: a reference signal for tracking, a reference signal for CSI acquisition, and a reference signal for beam management. Optionally, the reference signal for beam management includes at least one of the followings: a reference signal for obtaining L1-RSRP, a reference signal for obtaining L1-SINR. Optionally, obtaining L1-RSRP may be computing L1-RSRP. Optionally, obtaining L1-SINR may be computing L1-SINR. In the disclosure, the “reference signal for sounding” may be referred as a sounding reference signal (SRS).

In the disclosure, the term “beam” may include at least one of the followings: “quasi co-location (QCL) parameter,” “transmission configuration indication (TCI) state,” “spatial domain filter,” “antenna port,” “transmission and reception point (TRP),” “reference signal,” “beam information,” “beam index.” Optionally, a beam and another beam being the same may be a beam and another beam being quasi co-located.

In the disclosure, an antenna port can be defined such that the channel over which a symbol on the antenna port is conveyed can be inferred from the channel over which another symbol on the same antenna port is conveyed.

In the disclosure, two antenna ports are said to be quasi co-located if the large-scale properties of the channel over which a symbol on one antenna port is conveyed can be inferred from the channel over which a symbol on the other antenna port is conveyed. Optionally, the large-scale properties include one or more delay spread, Doppler spread, Doppler shift, average gain, average delay, and spatial Rx parameters.

In the disclosure, the term “QCL parameter” may be used interchangeably with the terms “QCL information,” “QCL assumption,” “QCL configuration,” “QCL configuration and/or QCL type.” Optionally, the QCL parameter may include/represent at least one of the followings: Doppler shift, Doppler spread, average delay, delay spread, spatial reception parameter. The spatial reception parameter may be a parameter for spatial reception. Optionally, the QCL parameter may include a combination of different types of parameters. For example, the QCL parameter may include Doppler shift, Doppler spread, average delay and delay spread, and such QCL parameter may be referred as QCL parameter type A. For example, the QCL parameter may include Doppler shift and Doppler spread, and such QCL parameter may be referred as QCL parameter type B. For example, the QCL parameter may include Doppler shift and average delay, and such QCL parameter may be referred as QCL parameter type C. For example, the QCL parameter may include spatial reception parameter, and such QCL parameter may be referred as QCL parameter type D. For example, two antenna ports are said to be quasi co-located if the large-scale properties of the channel over which a symbol on one antenna port is conveyed can be inferred from the channel over which a symbol on the other antenna port is conveyed. Optionally, the large-scale properties include one or more of delay spread, Doppler spread, Doppler shift, average gain, average delay, and spatial Rx parameters. For example, two antenna ports are said to be quasi co-located subject to QCL parameter type D if spatial Rx parameters of the channel over which a symbol on one antenna port is conveyed can be inferred from the channel over which a symbol on the other antenna port is conveyed.

In the disclosure, the term “TCI state” may be used interchangeably with the terms “TCI state configuration” or “TCI state configuration information” or “information for configuring the TCI state” or “information for indicating the TCI state.” Optionally, the TCI state may be a unified TCI state. Optionally, the TCI state may be at least one of an uplink TCI state (UL TCI state), a downlink TCI state (DL TCI state), a joint TCI state. Optionally, the unified TCI state may be an uplink TCI state (UL TCI state) and a downlink TCI state (DL TCI state), or a joint TCI state.

Optionally, a TCI state may include parameters configuring quasi co-location relation, these parameters configure the relation between the reference signal (e.g., one or two reference signals, or one or two downlink reference signals) and at least one of the followings: a demodulation reference signal (DM-RS) port of the PDSCH, a DM-RS port of the PDCCH, a CSI-RS port of a CSI-RS resource. Optionally, a quasi co-location relation is configured by a higher layer parameter (e.g., qcl-Type1) for the first downlink reference signal. Optionally, a quasi co-location relation is configured by a higher layer parameter (e.g., qcl-Type2) for the second downlink reference signal. In case of two downlink reference signals, the QCL types are not the same, regardless of whether the references are to the same DL RS or different DL RSs.

In the disclosure, the term “spatial domain filter” may be used interchangeably with the terms “spatial filter” or “uplink transmission spatial domain filter” or “spatial domain filter for uplink transmission” or “spatial domain filter for downlink reception.”

In the disclosure, the term “transmission occasion of reference signal resource” may be used interchangeably with the term “occasion of reference signal resource” or “reception occasion of reference signal resource” or “transmission occasion of reference signal” or “occasion of reference signal” or “reception occasion of reference signal.”

In the disclosure, the term “UE capability” may be used interchangeably with the terms “UE feature” or “UE feature group” or “UE capability parameter” or “reported UE capability” or “UE capability signaling” or “reported UE capability parameter.”

In the disclosure, a time domain resource may include/correspond to several time domain units.

In the disclosure, a time domain unit may be one of: a frame, a subframe, a slot, a sub-slot, a symbol. Optionally, the sub-slot may be a subset of a slot in time domain. For example, symbols included in the sub-slot are a subset of symbols included in the slot. Optionally, in the disclosure, the time domain unit may be one of: a second, a millisecond, a microsecond, a nanosecond, and a sample.

In the disclosure, a frequency domain resource may include/correspond to several frequency domain units.

In the disclosure, a frequency domain unit may be at least one of a band, a subband, a component carrier (CC), a bandwidth part (BWP), a resource block, a resource block group (RBG), a subcarrier, a carrier, a frequency band, a frequency range, a cell, a serving cell. The resource block may be a physical resource block (PRB) or a common resource block (CRB). The frequency range may be frequency range 1, frequency range 2 (e.g., frequency range 2-1 and/or frequency range 2-2).

In the disclosure, a time-frequency unit may be one of a resource element (RE), a resource element group (REG). The resource element group may include one or more resource elements. For example, a resource element group may include 6 or 12 resource elements.

In the disclosure, the starting time domain position of a channel or signal or resource is an earlier position in time domain, and the ending time domain position of a channel or signal or resource is a later position in time domain.

In the disclosure, the starting frequency domain position of a channel or signal or resource is a lower position in frequency domain, and the ending frequency domain position of a channel or signal or resource is a higher position in frequency domain.

In the disclosure, the term “PDCCH” may be used interchangeably with the terms “downlink control channel” or “control channel for downlink transmission” or “control channel for downlink.”

In the disclosure, the term “PDCCH” may be used interchangeably with the term “PDCCH candidate.”

In the disclosure, the term “PDSCH” may be used interchangeably with the terms “downlink data channel” or “data channel for downlink transmission” or “data channel for downlink.”

In the disclosure, the term “PUCCH” may be used interchangeably with the terms “uplink control channel” or “control channel for uplink transmission” or “control channel for uplink.”

In the disclosure, the term “PUSCH” may be used interchangeably with the terms “uplink data channel” or “data channel for uplink transmission” or “data channel for uplink.”

In the disclosure, the term “downlink control information (DCI)” may be used interchangeably with the terms “DCI format” or “control information for downlink.”

In the disclosure, the term “uplink control information (UCI)” may be used interchangeably with the term “control information for uplink.”

In the disclosure, detecting DCI includes: receiving and/or decoding DCI.

In the disclosure, the term “information bits of DCI/UCI” may be used interchangeably with the terms “information bits associated with DCI/UCI” or “information bits included in DCI/UCI” or “information bits corresponding to DCI/UCI.” Optionally, the information bits associated with DCI/UCI may include information bits of the DCI/UCI and check bits (for example, cyclic redundancy check (CRC) bits) corresponding to the DCI/UCI. Optionally, the information bits associated with DCI/UCI may include information bits of the DCI/UCI and bits (for example, cyclic redundancy check (CRC) bits) for checking the DCI/UCI.

In the disclosure, the term “information bits of PDSCH/PUSCH” may be used interchangeably with the term “information bits associated with PDSCH/PUSCH” or “information bits carried by PDSCH/PUSCH” or “information bits of TB included in PDSCH/PUSCH” or “information bits of TB carried by PDSCH/PUSCH.” Optionally, the information bits associated with the information bits carried by PDSCH/PUSCH may include the information bits of TB carried by PDSCH/PUSCH and the check bits (for example, cyclic redundancy check (CRC) bits) corresponding to the TB. Optionally, the information bits associated with PDSCH/PUSCH may include information bits of PDSCH/PUSCH and bits (for example, cyclic redundancy check (CRC) bits) for checking the TB carried by the PDSCH/PUSCH.

In the disclosure, the term “size of information field” may be used interchangeably with the terms “bitwidth of information field” or “number of information bits in information field.”

In the disclosure, the information bits of the DCI may be the information bits included in the DCI, or the information bits associated with the DCI, or the payload of the DCI.

In the disclosure, the existence of an information field may be that the size of the information field is greater than 0 bit. The absence of an information field may be that the size of the information field is equal to 0 bit.

In the disclosure, the value x of an information field may correspond to the (x+1)-th codepoint of the information field, x≥0. The term “value of an information field” may be used interchangeably with the term “codepoint of an information field.” The term “value x of an information field” may be used interchangeably with the term “(x+1)-th codepoint of an information field,” where x≥0.

In the disclosure, the term “control resource set (CORESET)” may be used interchangeably with the terms “control resource” or “resource for receiving control information” or “resource for monitoring PDCCH” or “resource for detecting control information.”

In the disclosure, the term “search space” may be used interchangeably with the terms “PDCCH search space” or “PDCCH search space set” or “PDCCH candidate search space” or “PDCCH candidate search space set” or “search space for searching PDCCH” or “search space for searching PDCCH candidate” or “search space set for searching PDCCH candidate” or “search space set for searching PDCCH candidate.” Optionally, the search space may be a common search space (CSS) or a UE-specific search space (USS). Optionally, the search space may be used for detecting DCI. Optionally, the search space may be used for detecting DCI format.

In the disclosure, the term “PDCCH candidate associated with search space” may be used interchangeably with the term “PDCCH candidate in search space.”

In the disclosure, the modulation scheme associated with the PDCCH candidate may be the modulation scheme used by the corresponding PDCCH candidate. The aggregation level associated with the PDCCH candidate may be the aggregation level of the corresponding PDCCH candidate.

In the disclosure, the UE may monitor the PDCCH (or monitor the PDCCH candidate) in PDCCH monitoring occasion(s). Optionally, the PDCCH monitoring occasion may be one or more (consecutive) time domain units. Optionally, the PDCCH monitoring occasion may be an occasion for monitoring the PDCCH, or an occasion for monitoring the PDCCH candidate.

In the disclosure, monitoring the PDCCH candidate may be receiving the PDCCH candidate and/or decoding according to the monitored DCI format.

In the disclosure, the DCI format may be at least one of the followings: DCI format 0_0, DCI format 01, DCI format 0_2, DCI format 0_3, DCI format 1_0, DCI format 1_1, DCI format 1_2, and DCI format 1_3. In the disclosure, the type of the DCI format may be one of the followings: DCI format 0_0, DCI format 0_1, DCI format 0_2, DCI format 0_3, DCI format 1_0, DCI format 1_1, DCI format 1_2, DCI format 1_3.

In the disclosure, hybrid automatic repeat request (HARQ) information may be hybrid automatic repeat request-acknowledgement (HARQ-ACK) information.

In the disclosure, the PDCCH may carry the DCI and/or the CRC corresponding to the DCI, or the DCI and/or the CRC corresponding to the DCI may be in the PDCCH. Optionally, the CRC may be scrambled in a specific manner. For example, optionally, the CRC may be scrambled based on a radio network temporary identifier (RNTI). Two PDCCHs having the same scrambling may be these two PDCCHs being scrambled by the same RNTI. Optionally, the RNTI may be one of a cell radio network temporary identifier (C-RNTI), a configured scheduling radio network temporary identifier (CS-RNTI).

In the disclosure, the higher layer parameter includes at least one of a radio resource control (RRC) parameter, a media access control (MAC)-control element (CE) (MAC-CE) parameter. The RRC parameter may be a parameter configured/indicated by RRC signaling. The MAC-CE parameter may be a parameter indicated/activated by MAC-CE signaling. Optionally, information being configured by a higher layer parameter may be the information being indicated/activated by the higher layer parameter.

In the disclosure, the higher layer signaling includes at least one of the RRC parameter, the parameter indicated by MAC-CE; or the higher layer signaling may include at least one of RRC signaling and MAC-CE signaling. Optionally, information being configured by higher layer signaling may be the information being indicated/activated by the higher layer signaling.

In the disclosure, the UE obtaining configuration information may be the UE receiving/being configured with the configuration information. In the disclosure, “obtaining configuration information” may be used interchangeably with the terms “receiving configuration information” or “being configured with configuration information.”

In the disclosure, a cell includes at least one of the followings: a serving cell, a candidate cell, a primary cell, a secondary cell, and a special cell. The special cell may be a current special cell.

In the disclosure, when the DCI schedules a channel or signal, a cell receiving or transmitting the channel or signal may be referred as a scheduled cell. A cell where the DCI is detected or a cell where the DCI is monitored/received may be referred as a scheduling cell.

In the disclosure, when the DCI schedules a channel or signal, a BWP receiving or transmitting the channel or signal may be referred as a scheduled BWP. A BWP where the DCI is detected, or a BWP where the PDCCH associated with the DCI is monitored/received may be referred as a scheduling BWP.

In the disclosure, “determining measurement” may be determining the result of the measurement, or obtaining the result of the measurement, or obtaining the measurement based on the reference signal, or obtaining the measurement based on the measurement resource, or obtaining the measurement for determining the CSI.

In the disclosure, “determining channel measurement” may be determining the result of the channel measurement, or obtaining the result of the channel measurement, or obtaining the channel measurement based on the reference signal, or obtaining the channel measurement based on the measurement resource, or obtaining the channel measurement for determining the CSI.

In the disclosure, “determining interference measurement” may be determining the result of the interference measurement, or obtaining the result of the interference measurement, or obtaining the interference measurement based on the reference signal, or obtaining the interference measurement based on the measurement resource, or obtaining the interference measurement used for determining the CSI.

In the disclosure, the term “uplink channel associated with CSI report” may be used interchangeably with the terms “uplink channel corresponding to the CSI report” or “uplink channel carrying the CSI report.”

In the disclosure, a numerology may refer to a set of parameters that define a basic time unit and frequency unit in the wireless communication system. These parameters may be used for determining the waveform, subcarrier spacing, and sampling rate of the signal. The numerology may include at least one of the followings: subcarrier spacing, cyclic prefix, symbol periodicity, sampling rate, slot length, frame structure. Optionally, the subcarrier spacing may be the frequency difference between two neighboring subcarriers, typically in Hertz (Hz). The subcarrier spacing decides the bandwidth and time resolution of the system. Optionally, the cyclic prefix is added at the beginning of the OFDM symbol. The length of the cyclic prefix is associated with the subcarrier spacing: the addition of the cyclic prefix is to reduce the impact of multipath effects. Optionally, the symbol periodicity may be the duration of one OFDM symbol. Optionally, the symbol periodicity may be the reciprocal of the subcarrier spacing. Optionally, the sampling rate may be the sampling frequency at which signals are received and transmitted. Optionally, the sampling rate is associated with the subcarrier spacing. Optionally, the slot may be a time period used for distinguishing uplink and downlink in a time division duplex (TDD) system. Optionally, the slot length is associated with the subcarrier spacing and the symbol periodicity. Optionally, the frame structure is used for defining the organization of slots within the frame, including the length of the frame and the number of slots. In 5G new radio (NR), multiple different numerology configurations may be supported to fit different frequency bands and application scenarios. For example, low frequency bands may use larger subcarrier spacing to support wider bandwidth and longer transmission distance, while high frequency bands may use smaller subcarrier spacing to support higher data rate and lower latency.

In the disclosure, a cell may be a primary cell (PCell) and/or a primary secondary cell (PSCell) and/or a secondary cell and/or a special cell. In the disclosure, the cell may be one of the primary cell and the secondary cell. The Special Cell may be the PCell or the PSCell. In dual connectivity operation, the special cell refers to the primary cell of a master cell group (MCG) or the primary secondary cell of a secondary cell group (SCG), otherwise, the special cell refers to the primary cell. A cell may be a serving cell or a non-serving cell.

In the disclosure, “measurement of resource set” may be used interchangeably with “measurement of resources in resource set” or “measurement of all resources in resource set.”

Various methods described in embodiments disclosed herein for comparing the resource associated with the resource indicator included in the CSI report with the resource determined based on measurement of the resource set may be indicated by at least one of RRC, MAC-CE, DCI.

In the disclosure, “A” being indicated by at least one of RRC, MAC-CE, DCI may mean that “A” is configured by RRC and then further indicated by MCA-CE or DCI.

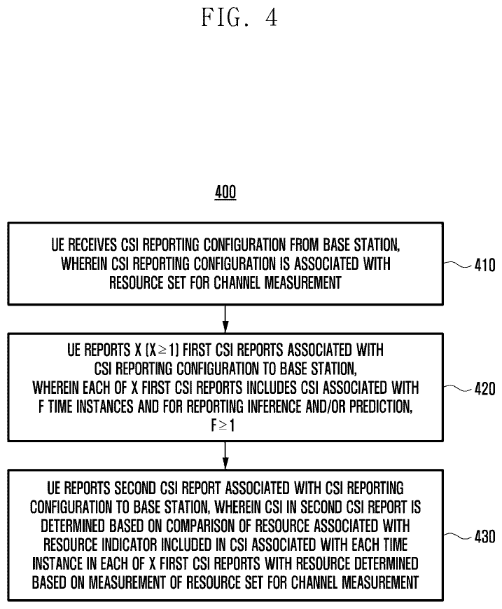

FIG. 4 illustrates a method 400 performed by a user equipment (UE) according to various embodiments of the disclosure. The method 400 includes: at 410, the UE receives a CSI reporting configuration from a base station, wherein the CSI reporting configuration is associated with a resource set for channel measurement; at 420, the UE reports X (X≥1) first CSI report(s) associated with the CSI reporting configuration to the base station, wherein each of the X first CSI report(s) includes CSI associated with F time instance(s) and for reporting inference and/or prediction, F≥1; and at 430, the UE reports a second CSI report associated with the CSI reporting configuration to the base station, wherein CSI in the second CSI report is determined based on comparison of a resource associated with a resource indicator included in CSI associated with each time instance in each of the X first CSI report(s) with a resource determined based on measurement of the resource set for channel measurement.

Each step in the above method 400 is described in detail below.

Each step in the above method 400 is described in detail below.

In order to better improve the accuracy of CSI reporting, Artificial Intelligence (AI)/Machine Learning (ML) technology can be used for CSI prediction. For example, the corresponding CSI is generated through the measurement of the reference signal by the AI model. For example, the predicted CSI is generated by inference. The performance of CSI prediction generated by the AI model may vary depending on the applicable scenarios and operating conditions of the AI model. Thus, there is a need to monitor the performance of the CSI prediction function of the AI model. Methods for monitoring the performance of CSI prediction are provided below. In the disclosure, the CSI prediction may be at least one of beam prediction, time domain prediction, and spatial domain prediction. In the disclosure, the term “model” may be used interchangeably with the term “AI/ML model” or “UE side model.” In the disclosure, the term “inference” may be used interchangeably with the term “model inference.” In the disclosure, the term “training” may be used interchangeably with the term “model training.”

The UE may receive/be configured with the CSI reporting configuration (e.g., CSI-ReportConfig). Optionally, the CSI reporting configuration may be for beam management. Optionally, the CSI reporting configuration may include a first CSI reporting configuration and/or a second CSI reporting configuration. Optionally, the UE may receive/be configured with the first CSI reporting configuration and/or the second CSI reporting configuration.
Optionally, the first CSI reporting configuration may be for prediction (or for inference), or for reporting the result of inference/prediction, or for reporting CSI for prediction/inference, or for generating the result of inference/prediction, or for generating CSI for prediction/inference. Optionally, the CSI report (e.g., the first CSI report) corresponding to the first CSI reporting configuration may be for prediction (e.g., for CSI prediction), or for inference (e.g., for CSI inference), or for reporting CSI for prediction/inference, or for reporting the result of inference/prediction. Here, the inference may be the inference of the UE side model. Here, the inference/prediction may be CSI inference/prediction, or inference/prediction of CSI. Optionally, CSI prediction may include at least one of beam prediction, time domain prediction, time domain beam prediction, time domain and/or spatial domain beam prediction. Optionally, the first CSI reporting configuration may be for beam management.
Optionally, the second CSI reporting configuration may be for monitoring (e.g., CSI monitoring), or for reporting the result of monitoring, or for reporting CSI for monitoring, or for generating the result of monitoring, or for generating CSI for monitoring. Optionally, the CSI report (for example, the second CSI report) corresponding to the second CSI reporting configuration may be for monitoring, or for reporting the result of monitoring, or for reporting CSI for monitoring. Here, the monitoring may be monitoring of the UE side model. Here, the monitoring may be CSI monitoring, or monitoring of CSI, or performance monitoring. Optionally, the second CSI reporting configuration and/or the second CSI report is used to monitor the first CSI report.
Optionally, the first CSI reporting configuration and the second CSI reporting configuration may be configured by a same configuration parameter (for example, CSI-ReportConfig), or the first CSI reporting configuration and the second CSI reporting configuration may be configured by different configuration parameters (for example, CSI-ReportConfig). Optionally, the first CSI reporting configuration and the second CSI reporting configuration being configured by the same configuration parameter (for example, CSI-ReportConfig) means that the first CSI reporting configuration and the second CSI reporting configuration are configured by one configuration parameter (for example, CSI-ReportConfig). For example, the first CSI reporting configuration and the second CSI reporting configuration may be respectively configured by the parameter CSI-ReportConfig.

The first CSI reporting configuration and associated UE behaviour are described below. Optionally, the first CSI reporting configuration may indicate (or include, or be configured with) at least one of the followings:
An associated ID. The associated ID is used to ensure the consistency across training and inference. Optionally, UE may assume similar/the same properties of a downlink transmission beam or a beam set or a beam list associated with the same associated ID. Optionally, the UE may determine/generate the CSI based on the assumption that the beams of the resource set associated with the CSI reporting configuration associated with the same associated ID or the order of the resources in the resource set are similar/the same. Optionally, the UE may determine/generate the CSI based on the assumption that the beams of the resource set associated with the same associated ID or the order of the resources in the resource set are similar/the same. Here, determining/generating the CSI may be predicting the CSI;
first resource set(s). Optionally, the first resource set is for prediction/inference. Optionally, the first resource set is for UE side inference. Optionally, the first resource set is for determining CRI (for prediction) and/or SSBRI (for prediction). For example, a CRI/SSBRI included in the CSI report associated with the first CSI reporting configuration indicates a resource in the first resource set. For example, a CRI/SSBRI included in the CSI report associated with the first CSI reporting configuration corresponds to a resource in the first resource set. Optionally, the first resource set may include K_{A} resources, where K_{A}≥1;
second resource set(s). Optionally, the second resource set is for measurement. Optionally, the second resource set is for channel measurement. Optionally, the second resource set may include K_{B} resources, where K_{B}≥1. Optionally, the UE may perform inference based on measurement of the second resource set. Optionally, the UE may generate an inference result based on measurement of the second resource set. Optionally, the UE may generate an inference result based on measurement of the second resource set as input to the model. Optionally, the UE may generate the predicted CSI based on measurement of the second resource set. Optionally, the UE may generate the predicted CSI based on measurement of the second resource set as input to the model. Optionally, the predicted CSI may be the output of model inference. Optionally, the predicted CSI may be determined based on the output of model inference. Optionally, the CSI may include CRI and/or SSBRI. Optionally, the CSI may include CRI for prediction and/or SSBRI for prediction. Optionally, measurement of the second resource set may be used as input to model inference. Optionally, the input to the model inference may be determined based on measurement of the second resource set;
The number of the reported resources (N1). Optionally, N1 may be indicated by a parameter (e.g., nrofReportedRS) indicating the number of the reported resources. Optionally, the number may be the number of RS resources to be reported per report. Optionally, the number may be the number of predicted reference signal resources to be reported per report. Optionally, the number may be the number of reference signal resources to be reported per report associated with one time instance. Optionally, the number may be the number of resources reported by the UE in one report instance;
Time domain behaviour of the first CSI reporting configuration. Optionally, the time domain behaviour may be configured by a reporting configuration type parameter (e.g., reportConfigType). The time domain behaviour may be one of periodic report, semi-persistent report, and aperiodic report. The time domain behaviour of the CSI reporting configuration may correspond to one of periodic CSI report, semi-persistent CSI report, and periodic CSI report. Optionally, periodic report is carried by PUCCH. Optionally, semi-persistent report is carried by PUCCH or PUSCH. Optionally, aperiodic report is carried by PUSCH;
A report quantity. The report quantity refers to the CSI related quantity to report. The report quantity may be at least one of the followings: CRI; CRI and L1-RSRP; SSBRI; SSBRI and L1-RSRP. When the report quantity is CRI, the UE reports (only) CRI, or the UE reports (only) CRI in one report instance. When the report quantity is SSBRI, the UE reports (only) SSBRI, or the UE reports (only) SSBRI in one report instance. When the report quantity is CRI and L1-RSRP, the UE reports CRI and L1-RSRP, or the UE reports CRI and L1-RSRP in one report instance. Optionally, CRI and L1-RSRP are one-to-one corresponding. Optionally, the L1-RSRP may be the predicted L1-RSRP for the corresponding CRI. When the report quantity is SSBRI and L1-RSRP, the UE reports SSBRI and L1-RSRP, or the UE reports SSBRI and L1-RSRP in one report instance. Optionally, SSBRI and L1-RSRP are one-to-one corresponding. Optionally, the L1-RSRP may be the predicted L1-RSRP for the corresponding SSBRI; And/or
Time domain information. Optionally, the time domain information is information for time domain prediction. Optionally, the time domain information may be information for beam time domain prediction. Optionally, the time domain information may be information for spatial domain and time domain prediction. In the disclosure, the term “time domain information” may be referred to as “information for time domain prediction” or “information on indicating the time instances associated with the report for time domain prediction.” The time domain information may include at least one of the followings:
   The number of time instances (F). Optionally, this number may be the number of time instance to be reported per report;
   The separation/offset between two time instances. For example, the separation/offset between two adjacent time instances. The separation between time instances may be F_D (e.g., F_D time domain units); and/or
   An offset (F_offset) between a time instance and a reference time domain resource. For example, the separation/offset between the earliest time instance and the reference time domain resource. For example, the time domain unit separation/offset between the earliest time instance and the reference time domain resource. The reference time domain resource may be the time domain resource where the CSI report is located, or the time domain resource where the CSI reference resource corresponding to the CSI report is located, or the tine domain resource where the latest transmission occasion of the resources in the first resource set no later than the CSI reference resource corresponding to the CSI report is located.

Optionally, the UE may determine and/or report the CSI based on the first CSI reporting configuration. Optionally, the report carrying the CSI associated with the first CSI reporting configuration may be referred to as the first CSI report. The UE may determine and/or report the predicted CSI based on the first CSI reporting configuration. Optionally, the predicted CSI may be at least one of the followings: predicted CRI, predicted SSBRI, and predicted L1-RSRP. Optionally, the CSI included in the first CSI report may be associated with N1 resources. Optionally, the CSI included in the first CSI report may be associated with N1 resources and N1 L1-RSRP corresponding to the N1 resources. Optionally, the N1 resources associated with the CSI may be the N1 resources indicated by the CSI. Optionally, the N1 resources associated with the CSI may be indicated by indicators in the CSI. Optionally, the indicator may be used to indicate the resource. An indicator indicating a resource may be referred to as a resource indicator. Optionally, in one report instance, the UE may report N1 CRIs/SSBRIs. Optionally, in one report instance, the UE may report N1 CRIs/SSBRIs and N1 L1-RSRP. Here, N1 CRIs/SSBRIs and N1 L1-RSRP may be one-to-one mapped, or one-to-one corresponding. In the disclosure, a CSI report may be a report in one report instance. L1-RSRP is determined based on the mapped/corresponding CRI/SSBRI. Optionally, the relation between CRI/SSBRI and the resources in the first resource set is as follows:
Optionally, the value k of SSBRI corresponds to the (k+1)-th resource in the first resource set. Optionally, when the resources included in the first resource set are SSB resources, the value k of SSBRI corresponds to the (k+1)-th resource in the first resource set. Optionally, k≥0. Optionally, the configuration information associated with/corresponding to the first resource set may include one or more entries of resource configuration information (for example, SSB resource configuration information). Optionally, an entry of SSB resource configuration information corresponds to a SSB resource. Optionally, the value k of SSBRI corresponds to the (k+1)-th entry in the configuration information associated with the first resource set;
Optionally, the value k of CRI corresponds to the (k+1)-th resource in the first resource set. Optionally, when the resources included in the first resource set are CSI-RS resources, the value k of the CRI corresponds to the (k+1)-th resource in the first resource set. Optionally, k≥0. Optionally, the configuration information associated with/corresponding to the first resource set may include one or more entries of resource configuration information (for example, CSI-RS resource configuration information). Optionally, an entry of CSI-RS resource configuration information corresponds to a CSI-RS resource (for example, a non-zero power (NZP) CSI-RS resource). Optionally, the value k of CRI corresponds to the (k+1)-th entry in the configuration information associated with the first resource set; and/or
In the disclosure, the first resource set may also be a first set, wherein the first set is a set including K_{A} elements. Description about “resource” may equally apply to description of “element” in the first set.

The second CSI reporting configuration and associated UE behaviour are described below.

Optionally, the second CSI reporting configuration may be used for measurement and/or reporting of CSI. Optionally, the second CSI reporting configuration may be for model monitoring. Optionally, the second CSI reporting configuration may be for monitoring (reporting) the result of inference. Optionally, the second CSI reporting configuration may be used to monitor (report) the inference result of the UE side. Optionally, the second CSI reporting configuration may be used to generate the monitoring result. Optionally, the second CSI reporting configuration may indicate (or include, or be configured with) at least one of the followings:
A third resource set. Optionally, the third resource set is for measurement. Optionally, the third resource set is for channel measurement. Optionally, the third resource set is for monitoring. Optionally, the third resource set is for performance monitoring. Optionally, the third resource set is for UE side model performance monitoring. Optionally, the third resource set may include K_{M} resources, where K_{M}≥1. Optionally, the UE may generate the CSI report based on measurement of the third resource set.
   Optionally, the third resource set may be determined based on the first resource set and/or the second resource set. Optionally, the third resource set may be the same as the first resource set or the second resource set. Optionally, the third resource set may be configured via a RRC parameter as the same resource set as the first resource set. Optionally, the third resource set may be configured via a RRC parameter as the same resource set as the second resource set. Here, being the same resource set means that the resources in the two resource sets are (exactly) the same. Optionally, the third resource set may be a subset of the first resource set. Optionally, the resources included in the third resource set may be indicated as one or more of the resources in the first resource set via a bitmap, for example, via a bitmap including K_{A} bits, with the k-th bit in the K_{A} bits corresponding to the k-th resource in the first resource set. Optionally, 1≤k≤K_{A}. Optionally, a bit value of 1 indicates that the corresponding resource in the first resource set is indicated and/or included in the third resource set. Optionally, a bit value of 0 indicates that the corresponding resource in the first resource set is not indicated and/or is not included in the third resource set. Optionally, the bitmap may be indicated by the second CSI reporting configuration;
The associated CSI reporting configuration. Here, the associated CSI reporting configuration may be the first CSI reporting configuration. Optionally, the second CSI reporting configuration may include a parameter indicating the ID of the first CSI reporting configuration. When the first CSI reporting configuration and the second CSI reporting configuration are configured by the same configuration parameter (e.g., CSI-ReportConfig), the associated CSI reporting configuration is not configured.
The number of resources (N2). Optionally, N2 may be indicated by the parameter nrofReportedRS. The use of N2 is described below;
Time domain behaviour of the second CSI reporting configuration. Optionally, the time domain behaviour may be configured by the parameter reportConfigType. The time domain behaviour may be one of periodic report, semi-persistent report, and aperiodic report. The time domain behaviour of the second CSI reporting configuration may correspond to one of periodic CSI report, semi-persistent CSI report, and periodic CSI report. Optionally, periodic report is carried by PUCCH. Optionally, semi-persistent report is carried by PUCCH or PUSCH. Optionally, aperiodic report is carried by PUSCH;
The report quantity. The report quantity refers to the CSI related quantity to report. The report quantity may be at least one of the followings: beam accuracy indicator (BAI); CRI and L1-RSRP; SSBRI and L1-RSRP. When the report quantity is BAI, the UE reports (only) BAI, or the UE reports (only) BAI in one report instance. When the report quantity is CRI and L1-RSRP, the UE reports CRI and L1-RSRP, or the UE reports CRI and L1-RSRP in one report instance. Optionally, CRI and L1-RSRP are one-to-one corresponding. When the report quantity is SSBRI and L1-RSRP, the UE reports SSBRI and L1-RSRP, or the UE reports SSBRI and L1-RSRP in one report instance. Optionally, SSBRI and L1-RSRP are one-to-one corresponding. Refer below for relevant description of BAI; and/or
X. For example, optionally, the second CSI reporting configuration may include a parameter, where the parameter is used to indicate X. The use of X is described below.

Optionally, the UE may report X (X≥1) first CSI report(s) associated with the first CSI reporting configuration. Optionally, the UE may report X (X≥1) first CSI report(s) for inference/prediction. Optionally, the UE may report X (X≥1) first CSI report(s) for reporting CSI for inference/prediction. Optionally, each of the X first CSI report(s) includes N1 resource indicators. Here, the resource indicator may be SSBRI and/or CRI. Optionally, a resource indicator corresponds to a resource in the first resource set. Refer above for description of the resource indicator associated with the first CSI report. Optionally, the N1 resource indicators may indicate/correspond to the best N1 resource(s) (top/best N1 resources) in the first resource set. Optionally, the N1 resource indicators may indicate the strongest N1 resources in the first resource set. Optionally, the N1 resource indicators may indicate N1 resources with the highest predicted L1-RSRP in the first resource set. Optionally, X may be indicated by the base station, for example, indicated by at least one of RRC, MAC-CE, and DCI. X may be predefined. For example, when the first CSI reporting configuration is associated with aperiodic CSI report, X=1. Optionally, the value of X may be one of 1, 2, 3, 4, 5, 6, 7, 8. Optionally, X may be related to UE capability. For example, the value of X is less than or equal to the maximum value indicated by UE capability signaling.

Optionally, the UE may determine and/or report the CSI based on the second CSI reporting configuration. Optionally, the UE may report the CSI associated with the second CSI reporting configuration. Optionally, the report carrying the CSI associated with the second CSI reporting configuration may be referred to as the second CSI report. Optionally, the UE may report the second CSI report for monitoring. Optionally, the UE may report the second CSI report for reporting the CSI for monitoring. Optionally, the UE may determine and/or report the CSI report based on the second CSI reporting configuration. Optionally, the CSI associated with the second CSI reporting configuration may be the difference of L1-RSRP and/or BAI. Optionally, the CSI associated with the second CSI reporting configuration (or the CSI included in the second CSI report) may be determined based on the followings (or the comparison of the following two):
The resources associated with the resource indicators included in each of the X first CSI report(s); and/or
The resource(s) determined based on measurement of the third resource set. Optionally, the resource determined based on measurement of the third resource set may be one or more resources in the third resource set determined based on measurement of the third resource set. Optionally, the resource determined based on measurement of the third resource set may be one or more resources in the third resource set determined based on measurement of all resources in the third resource set.

The above method of generating the CSI for performance monitoring may allow the UE to compare the result of one or more CSI prediction and the measurement result of the resource set for monitoring and reflect the result of the comparison in the CSI report, in order for the UE to report the CSI for performance monitoring. The CSI for performance monitoring can facilitate the base station to obtain the performance metrics of the UE side model for corresponding model management, improving the reliability of the UE side AI model.

Optionally, the CSI associated with the second CSI reporting configuration (or the CSI included in the second CSI report) may be determined based on comparison of the resources associated with the resource indicators included in each of the X first CSI report(s) and the resource(s) determined based on measurement of the third resource set (e.g., the resources in the third resource set). Optionally, the measurement of the third resource set may be measurement of the resources of the third resource set. Optionally, the measurement of the third resource set may be measurement of all resources in the third resource set.

Optionally, the above comparison may be comparison of the resource associated with at least one of the N1 resource indicators in the x-th (1≤x≤X) CSI report of the X first CSI report(s) and the resource(s) in the third resource set determined based on measurement of the third resource set. Optionally, x may be an integer value. Optionally, x may be any integer value ranged from 1 to X.

Optionally, the above comparison may be (determining) whether the resources associated with the N1 resource indicators in the x-th CSI report of the X first CSI report(s) are in N2 resources with the highest (measured) L1-RSRP in the third set determined based on measurement of the third resource set. For example, each of the N1 resource indicators is associated with a resource. The UE compares whether the N1 resources associated with the N1 resource indicators in the x-th CSI report of the X first CSI report(s) are in the N2 resources with the highest (measured) L1-RSRP in the third resource set. This comparison method may be referred to as Method #IA. Here, the N1 resources being in the N2 resources can be considered as that the N1 resources are all in the N2 resources, or each of the N1 resources is in the N2 resources. Here, the N1 resources being in the N2 resources can be considered as that there are N1 resources of the N2 resources same as the N1 resources. Optionally, N1≤N2. Refer below for relevant description of N2. For example, predicted resources are CSI-RS #1 and CSI-RS #2, and three resources with the highest measured L1-RSRP in the third resource set are CSI-RS #1, CSI-RS #2, and CSI-RS #3, then the predicted resources are in the three resources with the highest measured L1-RSRP in the third resource set. For example, predicted resources are CSI-RS #1 and CSI-RS #2, and three resources with the highest measured L1-RSRP in the third resource set are CSI-RS #2, CSI-RS #3, and CSI-RS #4, then the predicted resources are not in the three resources with the highest measured L1-RSRP in the third resource set. This method allows the UE to compare whether the optimal beam in the set for monitoring is in the beams predicted by the UE, thereby helping the base station to determine whether the beam prediction matches the measurement result of the actually monitored beams, so that the base station adjusts accordingly when the prediction result deviates from the monitoring result, improving the reliability of the communication system.

Optionally, the above comparison may be (determining) whether the resource with the highest (measured) L1-RSRP in the third resource set determined based on measurement of the third resource set is the same as one of the resources associated with the N1 resource indicators in the x-th CSI report of the X first CSI report(s). For example, each of the N1 resource indicators is associated with a resource. The UE compares whether the resource with the highest (measured) L1-RSRP in the third resource set is the same as one of the N1 resources associated with the N1 resource indicators in the x-th CSI report of the X first CSI report(s). This comparison method may be referred to as Method #1. Optionally, the resources associated with the N1 resource indicators may be resources associated with one of the N1 resource indicators. For example, a resource indicator of the N1 resource indicators is associated with a resource. The UE compares whether the resource with the highest (measured) L1-RSRP in the third resource set is the same as the resource associated with one of the N1 resource indicators in the x-th CSI report of the X first CSI report(s). This comparison method may be referred to as Method #2. This method allows the UE to compare whether the optimal beam in the set for monitoring is in the beams predicted by the UE, thereby helping the base station to determine whether the beam prediction matches the measurement result of the actually monitored beams, so that the base station adjusts accordingly when the prediction result deviates from the monitoring result, improving the reliability of the communication system.

Optionally, the above comparison may be (determining) whether the resource associated with one of the N1 resource indicators in the x-th CSI report of the X first CSI report(s) is the same as one of the N2 (N2≥1) resources in the third resource set determined based on measurement of the third resource set. Optionally, N2 resource(s) may correspond to the top/best N2 resource(s) in the third resource set. Optionally, the N2 resource(s) may correspond to the strongest N2 resources in the third resource set. Optionally, the N2 resource(s) may correspond to the N2 resources with the highest (measured) L1-RSRP in the third resource set. Optionally, N2 may be indicated by the base station. For example, N2 is indicated by at least one of RRC, MAC-CE, or DCI. For example, N2 may be indicated by the second CSI reporting configuration. N2 may be predefined. This comparison method may be referred to as Method #3. This method allows the UE to compare whether the beam predicted by the UE is in the optimal group of beams in set for monitoring, thereby helping the base station to determine whether the beam prediction matches the measurement result of the actually monitored beams, so that the base station adjusts accordingly when the prediction result deviates from the monitoring result, improving the reliability of the communication system.

Optionally, the above comparison may be (determining) whether the difference between the (measured) L1-RSRP of the resource associated with one of the N1 resource indicators in the x-th CSI report of the X first CSI report(s) and the highest (measured) L1-RSRP determined based on measurement of the third resource set is less than a threshold (or less than/equal to the threshold, or greater than the threshold, or greater than/equal to the threshold). Optionally, the threshold may be predefined, or indicated by the base station, or determined based on the UE capability. Here, the threshold may be T dB. Optionally, T≥0. Optionally, T may be predefined. Optionally, the value of T may be one of 0, 1, 2, 3, 4, 5, 6, 7, 8. Optionally, the value of T may be indicated by the base station, for example, via the second CSI reporting configuration. The value of T may be indicated by at least one of RRC, MAC-CE, DCI. Optionally, the value of T may be determined based on the UE capability. For example, the value of T is determined based on the indication of the reported UE capability signaling. This comparison method may be referred to as Method #4. This method allows the UE to compare whether the measured L1-RSRP of the optimal beam predicted by the UE and the measured L1-RSRP of the optimal beam in the set for monitoring are within a certain range, thereby helping the base station to determine whether the beam prediction matches the measurement result of the actually monitored beams, so that the base station adjusts accordingly when the prediction result deviates from the monitoring result, improving the reliability of the communication system.

Optionally, the UE may use one of Method #IA, Method #1, Method #2, Method #3, and Method #4 for comparison based on indication from the base station or a predefined method.

In the above methods, one of the N1 resource indicators may be at least one of the followings:
The resource indicator corresponding to the resource with the largest L1-RSRP. For example, the resource indicator with the largest corresponding L1-RSRP of the N1 indicators. For example, the resource indicator corresponding to the resource with the largest L1-RSRP of the K_{A} resources. For example, the resource indicator corresponding to the resource with the largest L1-RSRP in the first resource set. Optionally, when N1 resource indicators correspond to L1-RSRP, one of the N1 resource indicators may be the indicator corresponding to the resource with the largest L1-RSRP. Here, L1-RSRP may be predicted L1-RSRP;
The resource indicator corresponding to top/best resource. For example, the resource indicator corresponding to the best resource of the K_{A} resources. For example, the resource indicator corresponding to the best resource in the first resource set. For example, the resource indicator corresponding to the best resource of the N1 resources. Here, the N1 resources refer to resources corresponding to the N1 resource indicators. Optionally, when N1 resource indicators do not correspond to L1-RSRP, one of the N1 resource indicators may be the indicator corresponding to the best resource of the N1 resource indicators;
The resource indicator corresponding to the strongest resource. For example, the resource indicator corresponding to the strongest resource of the K_{A} resources. For example, the resource indicator corresponding to the strongest resource in the first resource set. For example, the resource indicator corresponding to the strongest resource of the N1 resources. Here, the N1 resources refer to resources corresponding to the N1 resource indicators. Optionally, when N1 resource indicators do not correspond to L1-RSRP, one of the N1 resource indicators may be the indicator corresponding to the strongest resource of the N1 resource indicators; and/or
   First (or last) resource indicator. Optionally, when N1 resource indicators do not correspond to L1-RSRP, one of the N1 resource indicators may be the first (or last) resource indicator of the N1 resource indicators. Optionally, the first (or last) resource indicator may be determined based on the order of CSI information bits associated with/corresponding to the N1 resource indicators.

In the disclosure, the resource corresponding to L1-RSRP may mean that there is a corresponding L1-RSRP for the resource. The resource not corresponding to L1-RSRP may mean that there is no corresponding L1-RSRP for the resource. In the disclosure, “resource corresponds to L1-RSRP” may be understood as the first CSI report includes CRI/SSBRI and the corresponding L1-RSRP, or the first CSI report is configured to report CRI/SSBRI and L1-RSRP. In the disclosure, “resource does not correspond to L1-RSRP” may be understood as the first CSI report includes only CRI/SSBRI, or the first CSI report is configured to report only CRI/SSBRI.

The determination method of CSI (e.g., BAI) is described below.

Optionally, the value of BAI is indicated by a BAI field. Optionally, the value k of BAI means that there are k CSI reports with corresponding comparison results being true in the X first CSI report(s). Optionally, the value k of BAI refers to the number of CSI reports with corresponding comparison results being true of the X first CSI report(s). Optionally, the value k of BAI refers to the number of comparisons with the comparison results associated with the X first CSI report(s) being true. Optionally, the value k of BAI refers to the number of CSI with associated comparison results being true of the X CSI associated with the X first CSI report(s). Optionally, the value k of BAI refers to the number of comparisons with associated comparison results being true of the X CSI associated with the X first CSI report(s). Here, the CSI report may refer to the CSI included in the CSI report (or the inference result included in the CSI report). In the disclosure, the term “CSI report” may be used interchangeably with the term “CSI included in CSI report” or “inference result included in CSI report.” For example, the number of CSI reports may be considered as the number of inference results included in the CSI report. For example, the number of CSI reports may be considered as the number of CSI included in the CSI report. Optionally, k≥0. Optionally, k≤X.

The method of deciding the comparison result is described below. Optionally, if A and B are the same, the result of the comparison of A and B may be considered true. If A and B are different, the result of the comparison of A and B may be considered false. For example, when the resource associated with at least one of the N1 resource indicators in the x-th CSI report of the X first CSI report(s) is the same as/mapped with the resource determined based on measurement of the third resource set, the result of the comparison may be considered true. For example, when the resource associated with at least one of the N1 resource indicators in the x-th CSI report of the X first CSI report(s) is different (or is not mapped with) from the resource determined based on measurement of the third resource set, the result of the comparison may be considered false. Optionally, if A and B are less than (or less than/equal to) a specific threshold, the result of the comparison of whether A and B are less than (or less than/equal to) the specific threshold may be considered true; otherwise, the result of the comparison may be considered false.

In the disclosure, the result of the comparison being true may also be referred to as the metric (or performance metric) related to the comparison is met. For example, if comparing whether A and B are the same, “A and B are the same” can be understood as the metric related to the comparison. The result of the comparison is true when the metric related to the comparison is met (e.g., “A and B are the same” is met).

In the disclosure, the result of the comparison being false may also be referred to as the metric (or performance metric) related to the comparison is not met. For example, if comparing whether A and B are the same, “A and B are the same” can be understood as the metric related to the comparison. The result of the comparison is false when the metric related to the comparison is not met (e.g., “A and B are not the same” is not met).

In the disclosure, X first CSI report(s) may correspond to X occasion(s) of CSI report. Optionally, the X first CSI report(s) may be the first CSI reports in the X occasion(s) of CSI report. If the CSI report is not transmitted in an occasion of CSI report, the UE may assume that the comparison result corresponding to the CSI report is predefined. For example, the comparison result is true. For example, the comparison result is false. For example, for the computation/determination of BAI, if the CSI report is not transmitted in an occasion of CSI report, the UE may assume the comparison result corresponding to the CSI report to be true. For example, for the computation/determination of BAI, if the CSI report is not transmitted in an occasion of CSI report, the UE may assume the comparison result corresponding to the CSI report to be false. This method can enable the UE and the base station to have the same understanding of the comparison result corresponding to the possible CSI report when the UE does not transmit a CSI report in the corresponding occasion of CSI report, preventing the base station and the UE from interpreting the corresponding beam accuracy based on the different comparison results corresponding to the CSI report and improving the reliability of the communication system.

Optionally, the accuracy rate corresponding to BAI is x. Optionally, the accuracy rate corresponding to BAI may be the accuracy rate of inference/prediction. Optionally, the accuracy rate may be the accuracy rate of the first CSI report. Optionally, the accuracy rate may be the accuracy rate of the inference/prediction result associated with the first CSI report. Optionally, the accuracy rate may be the accuracy rate of the inference/prediction associated with the first CSI reporting configuration. Optionally, the accuracy rate may be the accuracy rate of the report associated with the first CSI reporting configuration. Optionally, the accuracy rate may be the accuracy rate of inference/prediction (of the report) associated with the first CSI reporting configuration. Optionally, the accuracy rate may be the accuracy rate of the inference/prediction result (of the report) associated with the first CSI reporting configuration. Optionally, the value k of BAI may mean that there are k CSI reports with corresponding comparison results being true in the X first CSI report(s). Optionally, the value k of BAI may refer to the number of CSI reports with corresponding comparison results being true of the X first CSI report(s).

Optionally, the value k of BAI may mean that there are k CSI reports with corresponding comparison results being false in the X first CSI report(s). Optionally, the value k of BAI may refer to the number of CSI reports with corresponding comparison results being false of the X first CSI report(s). In this case, the accuracy rate corresponding to BAI is

$$\frac{X - k}{X}$$

or k/X.

Optionally, the size of the BAI field (or the field corresponding to BAI) is ┌log₂ X┐ or ┌log₂ X┐. Here, ┌·┐ is a round up operation. Optionally, the size of the BAI field (or the field corresponding to BAI) is determined based on X+1. For example, the size of the BAI field (or the field corresponding to BAI) is equal to ┌log₂(X+1)┐, or log₂(X+1), or

$$⌈ {log}_{2} \frac{X + 1}{A} ⌉ , or {log}_{2} \frac{X + 1}{A} .$$

Here, A may be an integer greater than or equal to 1. For example, A may be one of 1, 2, 3, 4, 5, 6, 7 and 8. Optionally, A may be predefined or a may be indicated/configured by the base station. Since the value range of BAI may be 0 to X, that is, there are X+1 values that BAI can indicate, determining the size of BAI field based on X+1 can avoid that some values from 0 to X cannot be indicated, improving the reliability of CSI reporting of the UE and further improving the reliability of the communication system.

Optionally, X refers to the total number of CSI reports that are compared. Optionally, X refers to the total number of CSI reports that are compared in one report instance. Optionally, X refers to the total number of CSI reports used to determine the BAI in one report instance. Optionally, X may be the number of CSI in the CSI report. Optionally, X may be the number of CSI in the X first CSI report(s). For example, each of the X CSI reports includes one CSI. For example, X CSI reports include X CSI. In the disclosure, the CSI in the first CSI report may be referred to as prediction result, or inference result. Optionally, X (or the value of X) may be indicated by the base station, or predefined, or determined based on the UE capability. For example, the value of X may be one of 1, 2, 3, 4, 5, 6, 7, 8, 12, 16, and 32. For example, X may be indicated by at least one of RRC, MAC-CE, and DCI. For example, X may be indicated by the second CSI reporting configuration.

The above method enables the UE to obtain the value of X (that is, the total number of CSI reports that are compared), so that the UE may obtain the corresponding beam accuracy rate through the number of CSI reports (k) with true/false reporting results, thereby saving the overhead of CSI reporting.

Another method of determining CSI (e.g., BAI) is described below. Optionally, the accuracy rate corresponding to BAI is m/M. Optionally, the accuracy rate corresponding to BAI may be the accuracy rate of inference/prediction. Optionally, the accuracy rate may be the accuracy rate of the first CSI report. Optionally, the accuracy rate may be the accuracy rate of the inference/prediction result associated with the first CSI report. Optionally, the accuracy rate may be the accuracy rate of the inference/prediction associated with the first CSI reporting configuration. Optionally, the accuracy rate may be the accuracy rate of the report associated with the first CSI reporting configuration. Optionally, the accuracy rate may be the accuracy rate of inference/prediction (of the report) associated with the first CSI reporting configuration. Optionally, the accuracy rate may be the accuracy rate of the inference/prediction result (of the report) associated with the first CSI reporting configuration. Optionally, the value of BAI may be m. Optionally, the value m of BAI may mean that there are m comparison results corresponding to measurement associated with the third resource set that are true. Optionally, the value m of BAI may refer to the number of measurements with corresponding comparison results being true of one or more measurements associated with the third resource set. For example, the one or more measurements associated with the third resource set may be M measurements associated with the third resource set. Optionally, M≥1. Optionally, the m measurements associated with the third resource set are from the M measurements associated with the third resource set. Optionally, 0≤m≤M.

Optionally, the value m of BAI may mean that there are m comparison results corresponding to measurement associated with the third resource set that are false. Optionally, the value m of BAI may refer to the number of measurements with corresponding comparison results being false of one or more measurements associated with the third resource set. In this case, the accuracy rate corresponding to BAI is

$$\frac{M - m}{M}$$

or m/M.

Optionally, the size of the BAI field (or the field corresponding to BAI) is ┌log₂ M┐ or log₂ M. Here, ┌·┐ is a round up operation. Optionally, the size of the BAI field (or the field corresponding to BAI) is determined based on M+1. For example, the size of the BAI field (or the field corresponding to BAI) is equal to ┌log₂(M+1)┐, or log₂(M+1), or

$$⌈ {log}_{2} \frac{M + 1}{B} ⌉ , or {log}_{2} \frac{M + 1}{B} .$$

Here, B may be an integer greater than or equal to 1. For example, B may be one of 1, 2, 3, 4, 5, 6, 7 and 8. Optionally, B may be predefined or a may be indicated/configured by the base station. Since the value range of BAI may be 0 to M, that is, there are M+1 values that BAI can indicate, determining the size of BAI field based on M+1 can avoid that some values from 0 to M cannot be indicated, improving the reliability of CSI reporting of the UE and further improving the reliability of the communication system.

Optionally, M refers to the total number of the one or more measurements associated with the third resource set that are compared. Optionally, M refers to the total number of measurements that are compared in one report instance (for example, in the report instance related to the second CSI report). Optionally, M refers to the total number of measurements used to determine BAI in one report instance. Optionally, M (or the value of M) may be indicated by the base station, or predefined, or determined based on the UE capability. For example, the value of M may be one of 1, 2, 3, 4, 5, 6, 7, 8, 12, 16, and 32. For example, M may be indicated by at least one of RRC, MAC-CE, and DCI. For example, M may be indicated by the second CSI reporting configuration.

The above method allows the UE to obtain the value of m, so that the UE may obtain the corresponding beam accuracy through the number of measurements (m) with true/false reporting results, thereby saving the overhead of CSI reporting.

Another method of determining CSI (e.g., BAI) is described below. Optionally, the value of BAI is determined by quantification of at least one of the followings:

$$\frac{X - k}{X} ; \frac{k}{X} ; \frac{M - m}{M} ; \frac{m}{M} .$$

Here, refer above for the description of X, k, M and m. Here, the value of BAI is called p. Optionally, p is an integer. Optionally, p≥0. Below is described by taking k/X as an example. The description of k/X also applies to

$$\frac{X - k}{X} or \frac{M - m}{M}$$

or m/M.
Optionally, {δ₀, δ₁, . . . , δ_{M}_{_{q}}} represents M_{q}+1 values. Optionally, the M_{q}+1 values are equally spaced. Optionally, δ₀ is equal to 0. Optionally, δ_{M}_{_{q}} is equal to 1. Optionally, δ_{M}_{_{q}}₋₁<1. Optionally, the value of δ_{M}_{_{q}}₋₁ may be predefined or indicated by the base station. Optionally, the value of δ_{M}_{_{q}}₋₁ may be one of 1, 0.75, 0.5, 0.25, 0.125. Optionally,

$${δ}_{i} = i \times \frac{{δ}_{{M}_{q} - 1}}{{M}_{q} - 1} ,$$

i=0, 1, . . . , M_{q}−1. Optionally,

$${δ}_{i} = i \times \frac{{δ}_{{M}_{q}}}{{M}_{q}} ,$$

i=0, 1, . . . , M_{q}. Optionally, M_{q}=2^{C}, where C represents the number of bits of the CSI field corresponding to BAI. Optionally, [δ_{M}_{_{q}}₋₁,1] represents “out-of-range.” Optionally, the value p of BAI indicates that the value of k/X corresponding to BAI is between δₚ and δₚ₊₁. Between δₚ and δₚ₊₁ means greater than or equal to δₚ and less than or equal to δₚ₊₁. Optionally, p≥0. Optionally, p≤M_{q}−1. Optionally,

$$\frac{{δ}_{{M}_{q}}}{{M}_{q}}$$

corresponds to quantization step size. Optionally, the quantization step size may be predefined or indicated by the base station.
Optionally, {δ₀, δ₁, . . . , δ_{M}_{_{q}}} represents M_{q}+1 values. Optionally, M_{q} values in {δ₀, δ₁, . . . , δ_{M}_{_{q}}₋₁} are equally spaced. Optionally, δ₀ is equal to 0. Optionally, δ_{M}_{_{q}} is equal to 1. Optionally, δ_{M}_{_{q}}₋₁≤1. Optionally, δ_{M}_{_{q}}₋₁<1. Optionally, the value of δ_{M}_{_{q}}₋₁ may be predefined or indicated by the base station. Optionally, the value of δ_{M}_{_{q}}₋₁ may be one of 1, 0.75, 0.5, 0.25, 0.125. Optionally, [δ_{M}_{_{q}}₋₁, δ_{M}_{_{q}}] represents “out-of-range.” Optionally,

$${δ}_{i} = i \times \frac{{δ}_{{M}_{q} - 1}}{{M}_{q} - 1} ,$$

i=0, 1, . . . , M−1. Optionally, M_{q}=2^{C}, where C represents the number of bits of the CSI field corresponding to BAI. Optionally, the value p of BAI indicates that the value of k/X corresponding to BAI is between δₚ and δₚ₊₁. Between δₚ and δₚ₊₁ means greater than or equal to δₚ and less than or equal to δₚ₊₁. Optionally, p≥0. Optionally, p≤M_{q}−1. Optionally,

$$\frac{{δ}_{{M}_{q} - 1}}{{M}_{q} - 1}$$

may correspond to the quantization step size. Optionally, the quantization step size may be predefined or indicated by the base station.
Optionally, {δ₀, δ₁, . . . , δ_{M}_{_{q}}} represents M_{q}+1 values. Optionally, M_{q} values in {δ₁, δ₂, . . . , δ_{M}_{_{q}}} are equally spaced. Optionally, δ₀ is equal to 0. Optionally, δ_{M}_{_{q}} is equal to 1. Optionally, δ₁≥1. Optionally, δ₁≥1. Optionally, the value of δ₁ may be predefined or indicated by the base station. Optionally, the value of δ₁ may be one of 1, 0.75, 0.5, 0.25, 0.125. Optionally, [δ₀,δ₁] represents “out-of-range.” Optionally,

$${δ}_{i} = {δ}_{1} + ( i - 1 ) \times \frac{{δ}_{{M}_{q}} - {δ}_{1}}{{M}_{q} - 1} ,$$

i=1, . . . , M Optionally, M_{q}=2^{C}, where C represents the number of bits of the CSI field corresponding to BAI. Optionally, the value p of BAI indicates that the value of k/X corresponding to BAI is between δₚ and δₚ₊₁. Between δₚ and δₚ₊₁ means greater than or equal to δₚ and less than or equal to δₚ₊₁. Optionally, p≥0. Optionally, p≤M_{q}−1. Optionally,

$$\frac{{δ}_{{M}_{q}} - {δ}_{1}}{{M}_{q} - 1}$$

may correspond to the quantization step size. Optionally, the quantization step size may be predefined or indicated by the base station.
Optionally, the value of C may be at least one of 1, 2, 3, 4, 5, 6, 7. Optionally, the value of C may be predefined. Optionally, the value of C may be indicated by the base station. Optionally, the value of C may be determined based on the UE capability.

Another method of determining CSI (e.g., BAI) is described below. Optionally, the BAI may include X bits. For example, BAI includes a bit sequence: b1, b2, . . . , bX. Optionally, b1 may be the Least Significant Bit (LSB), and bX may be the Most Significant Bit (MSB). Optionally, bx corresponds to the comparison result the x-th first CSI report. Optionally, 1≤x≤X. For example, a first value (e.g., 1) of bx indicates that the comparison result of the x-th first CSI report (of the X first CSI report(s)) is true. For example, a second value (e.g., 0) of bx indicates that the comparison result of the x-th first CSI report (of the X first CSI report(s)) is false. Refer above for the comparison method associated with the first CSI report.

The above method allows the UE to indicate the comparison result of each of the X first CSI report(s), so that the base station can perform model management accordingly, improving the performance of the communication system.

The resource corresponding to the resource indicator is the resource in the first resource set, and the resource determined by measurement of all resources in the third resource set is the resource in the third resource set. In order to facilitate the comparison between the resource corresponding to the resource indicator and the resource in the third resource set (to decide the comparison result), it is necessary to provide the mapping relation between the resources in the first resource set and the resources of the third resource set, define the method for determining comparison operation of CSI to ensure the reliability of the communication system. The method of determining the resource associated with the resource indicator is discussed below.

Optionally, the resource associated with the resource indicator refers to the resource in the first resource set corresponding to the resource indicator. Optionally, the resource in the first resource set being the same as the resource in the third resource set means at least one of the followings:
The resource ID corresponding to the resource in the first resource set is the same as the resource ID corresponding to the resource in the third resource set. Optionally, the resource ID may be a CSI-RS resource ID (e.g., NZP-CSI-RS-ResourceId) or an SSB index;
The position of the resource of the first resource set in the first resource set is the same as the position of the resource of the third resource set in the third resource set. For example, the k-th resource in the first resource set is the same as the k-th resource in the third resource set. For example, if the numbers of the resources included in the first resource set and the third resource set are the same, the k-th resource in the first resource set is the same as the k-th resource in the third resource set;
The position of the resource of the first resource set in the first resource set and the position of the resource of the third resource set in the third resource set meet a specific relation. For example, the i-th resource in the first resource set is the same as the ┌i/D┐-th resource in the third resource set. For example, if the numbers of the resources included in the first resource set and the third resource set are different, the i-th resource in the first resource set is the same as the ┌i/D┐-th resource in the third resource set. Refer below for description of D;
The QCL reference signal associated with the resource in the first resource set is the same as the QCL reference signal associated with the resource in the third resource set, or the QCL reference signal associated with the resource in the first resource set is the same as the resource in the third resource set, or the QCL reference signal associated with the resources in the first resource set is the same as the resource in the third resource set. Optionally, the QCL reference signal refers to the reference signal used to provide/indicate a QCL source. Optionally, the QCL reference signal refers to the reference signal associated with a specific QCL type. Optionally, the QCL type corresponding to the QCL reference signal may be type A and/or type D. Here, the QCL reference signal associated with the resource may be the reference signal QCLed with the resource. Optionally, the reference signal may be CSI-RS and/or SSB;
The TCI state associated with/corresponding to the resource in the first resource set is the same as the TCI state associated with/corresponding to the resource in the third resource set. For example, a resource may be indicated/configured with a TCI state. Optionally, TCI states being the same means that the IDs of the TCI states are the same. Optionally, TCI states being the same means that the reference signals used to determine the QCL source indicated by the TCI states are the same. Optionally, TCI states being the same means that the reference signals used to determine the QCL source of type D indicated by the TCI states are the same. Optionally, reference signals being the same may mean that the IDs of the reference signals are the same. Optionally, the reference signals are of the same type. Optionally, the type of the reference signal may be SSB or CSI-RS; and/or
The resource in the first resource set is mapped with the resource in the third resource set. For example, if a resource in the first resource set is mapped with a resource in the third resource set, the two resources may be considered the same. The mapping method of the resources in the first resource set and the resources of the third resource set is described below.

Optionally, the resource associated with the resource indicator refers to the resource in the first resource set corresponding to the resource indicator. Optionally, the resource in the first resource set being different from the resource in the third resource set means at least one of the followings:
The resource ID corresponding to the resource in the first resource set is different from the resource ID corresponding to the resource in the third resource set. Optionally, the resource ID may be a CSI-RS resource ID (e.g., NZP-CSI-RS-ResourceId) or an SSB index;
The position of the resource of the first resource set in the first resource set is different from the position of the resource of the third resource set in the third resource set. For example, if the resource in the first resource set is the k-th resource in the first resource set and the resource in the third resource set is the j-th resource in the third resource set, and k≠j, the two resources may be considered to be different. For example, the k-th resource in the first resource set is different from the j-th resource in the third resource set, where k≠j. For example, if the numbers of the resources included in the first resource set and the third resource set are the same, the k-th resource in the first resource set is not the same as the j-th resource in the third resource set, where k≠j;
The position of the resource of the first resource set in the first resource set and the position of the resource of the third resource set in the third resource set do not meet a specific relation. For example, the i-th resource in the first resource set is different from the j-th resource in the third resource set, where j≠┌i/D┐. For example, if the numbers of the resources included in the first resource set and the third resource set are different, the i-th resource in the first resource set is different from the j-th resource in the third resource set, where j≠┌i/D┐. Refer below for description of D;
The QCL reference signal associated with the resource in the first resource set is different from the QCL reference signal associated with the resource in the third resource set, or the QCL reference signal associated with the resource in the first resource set is different from the resource in the third resource set, or the QCL reference signal associated with the resource in the first resource set is different from the resource in the third resource set. Optionally, the QCL reference signal refers to the reference signal used to provide/indicate a QCL source. Optionally, the QCL reference signal refers to the reference signal associated with a specific QCL type. Optionally, the QCL type corresponding to the QCL reference signal may be type A and/or type D. Here, the QCL reference signal associated with the resource may be the reference signal QCLed with the resource. Optionally, the reference signal may be CSI-RS and/or SSB. Optionally, the type of reference signal may be SSB or CSI-RS;
The TCI state associated with/corresponding to the resource in the first resource set is different from the TCI state associated with/corresponding to the resource in the third resource set. For example, a resource may be indicated/configured with a TCI state. Optionally, TCI states being different means that the IDs of the TCI states are different. Optionally, TCI states being different means that the reference signals used to determine the QCL source indicated by the TCI states are different. Optionally, TCI states being different means that the reference signals used to determine the QCL source of type D indicated by the TCI states are different. Optionally, reference signals being different may be the IDs of the reference signals are different. Optionally, the types of the reference signals are different; and/or
The resource in the first resource set is not mapped with the resource in the third resource set. For example, if a resource in the first resource set is not mapped with a resource in the third resource set, the two resources may be considered different. The mapping method of the resources in the first resource set and the resources in the third resource set is described below.

Optionally, the resource associated with the resource indicator refers to resource in the third resource set mapped with the resource in the first resource set corresponding to the resource indicator. Optionally, each resource in the first resource set may be mapped with the resource (e.g., a resource, or at least one resource) in the third resource set.
Optionally, each resource in the first resource set is mapped with the resource in the third resource set based on indication from the base station. Optionally, when the first resource set is different from the third resource set, each resource in the first resource set is mapped with the resource in the third resource set based on the indication of the base station. Optionally, the first resource set being different from the third resource set means that the number of the resources in the first resource set is different from (for example, greater than/less than) the number of the resources in the third resource set. For example, K_{A}>K_{M}. For example, K_{A}<K_{M}. Optionally, the resource in the third resource set mapped with each resource in the first resource set is indicated by the base station. Optionally, the indication of the base station may be indicated by at least one of RRC signaling, MAC-CE, and DCI. Optionally, the indication of the base station may be indicated by the second CSI reporting configuration. For example, the first resource set includes {resource #1, resource #2, resource 3}, and the third resource set includes {resource #4, resource #5}, where the base station indicates that resource #1 is mapped with resource #4, resource #2 is mapped with resource #5, and resource #3 is mapped with resource #4. Optionally, the indication of the base station may include a bitmap. For example, the bitmap includes K_{A} bits. The k-th bit in the K_{A} bits corresponds to the k-th resource in the first resource set. Optionally, the k-th bit of the K_{A} bits is the k-th LSB (or the k-th MSB) in the bitmap. Optionally, 1≤k≤K_{A}. Optionally, k may be an integer ranged from 1 to K_{A}. When the value of a bit is a first value (for example, 1), the resource in the first resource set corresponding to the bit is mapped with a resource in the third resource set. Optionally, the number of bits of the first value in the bitmap is K_{M}. Optionally, the i-th bit (e.g., non-zero bit) of the first value of the K_{A} bits corresponds to the i-th resource in the third resource set. Optionally, the i-th bit (e.g., non-zero bit) of the first value of the K_{A} bits may be determined based on the indicated order (e.g., the indicated order of bits in the bitmap). Optionally, the i-th bit of the first value of the K_{A} bits is the i-th LSB (or the MSB) of the first value in the bitmap. Optionally, 1≤i≤K_{M}. Optionally, i may be an integer ranged from 1 to K_{M}. When the value of a bit is a second value (for example, 0), the resource in the first resource set corresponding to the bit is not mapped with a resource in the third resource set.
Optionally, the i-th resource in the first resource set is mapped with the i-th resource in the third resource set, 1≤i≤K_{A}. Optionally, when the first resource set is the same as the third resource set, the i-th resource in the first resource set is mapped with the i-th resource in the third resource set, 1≤i≤K_{A}. Optionally, the first resource set being the same as the third resource set means that the number of the resources in the first resource set is the same as the number of the resources in the third resource set. For example, K_{A}=K_{M}. Optionally, the first resource set being the same as the third resource set means that (all) resource IDs in the first resource set are the same as (all) resource IDs in the third resource set.
Optionally, the i-th resource in the first resource set is mapped with the ┌i/D┐-th entry or the ┌i/D┐-th resource in the third resource set. Optionally, D≥1. Optionally, 1≤i≤K_{A}. Optionally, D refers to a down-sampling factor. Optionally, D may be determined based on at least one of the following methods: indicated by the base station, predefined, and UE capability. Optionally, D may be indicated by the second CSI reporting configuration. Optionally, D is a positive integer. D may be one of 1, 2, 3, 4, 5, 6, 7, 8, 16, 32, 64.
Optionally, the resource in the first resource set may be mapped with the resource in the third resource set based on the QCL reference signal. Optionally, the resource in the first resource set is mapped with the resource in the third resource set associated with the same QCL reference signal. Optionally, if the QCL reference signal associated with the resource in the first resource set is the same as the QCL reference signal associated with the resource in the third resource set, the two resources are mapped. Optionally, if the QCL reference signals associated with the resource in the first resource set and the resource in the third resource set are the same, the two resources are mapped. Optionally, if the QCL reference signal associated with the resource in the first resource set is the same as the resource in the third resource set, the two resources are mapped. Refer above for description of the QCL reference signal.
Optionally, the resource in the first resource set may be mapped with the resource in the third resource set based on the TCI state. Optionally, the resource in the first resource set is mapped with the resource in the third resource set associated with the same TCI state. Optionally, if the TCI state associated with the resource in the first resource set is the same as the TCI state associated with the resource in the third resource set, the two resources are mapped. Refer above for description of the TCI state.

Optionally, each resource in the third resource set may be mapped with the resource in the first resource set.
Optionally, each resource in the third resource set is mapped with the resource in the first resource set based on indication of the base station. Optionally, when the first resource set is different from the third resource set, each resource in the third resource set is mapped with the resource in the first resource set based on the indication of the base station. Optionally, the first resource set being different from the third resource set means that the number of the resources in the first resource set is different from (for example, greater than/less than) the number of the resources in the third resource set. For example, K_{A}>K_{M}. For example, K_{A}<K_{M}. Optionally, the resource in the first resource set mapped with each resource in the third resource set is indicated by the base station. Optionally, the indication of the base station may be indicated by at least one of RRC signaling, MAC-CE, and DCI. Optionally, the indication of the base station may be indicated by the second CSI reporting configuration. For example, the first resource set includes {resource #1, resource #2, resource 3}, and the third resource set includes {resource #4, resource #5}, where the base station indicates that resource #4 is mapped with resource #1 and resource #2, and resource #5 is mapped with resource #3.

Optionally, the N1 resources in the third resource set may be mapped with the resources in the first resource set corresponding to the N1 resource indicators in the (predicted) first CSI report. Optionally, for one measurement associated with the third resource set, the N1 resources in the third resource set may be mapped with the resources in the first resource set corresponding to the N1 resource indicators in the (predicted) first CSI report. Optionally, N1≤K_{M}. Optionally, the N1 resources in the third resource set may be the first N1 (or last N1) resources in the third resource set. Here, the first N1 (or last N1) resources are determined based on the order (e.g., ascending/descending order) of the IDs of the resources. Here, the first N1 (or last N1) resources are determined based on the order (for example, ascending/descending order) in one or more resource configuration information corresponding to the third resource set. Optionally, the n-th resource of the N1 resources in the third resource set is mapped with the resource corresponding to the n-th resource indicator of the N1 resource indicators in the first CSI report. Optionally, the measurement of the third resource set is after the first CSI report (for example, the time domain resource where the first CSI report is located). Optionally, the time domain offset between the measurement of the third resource set and the first CSI report (for example, the time domain resource where the first CSI report is located) is greater than or equal to a specific threshold. Optionally, the N1 resources in the third resource set are determined based on the latest first CSI report before the corresponding measurement of the third resource set. Optionally, the N1 resources in the third resource set are determined based on the latest first CSI report before the specific threshold from the corresponding measurement of the third resource set. Optionally, the specific threshold may be predefined or configured by the base station. Optionally, the specific threshold may be indicated by at least one of RRC, MAC-CE, and DCI. In this method, the beam corresponding to the measured resource in the third resource set is determined based on the first CSI report, therefore, the base station may process after receiving the associated CSI report. Therefore, the corresponding measurement is performed after the first CSI report or after the specific threshold from the first CSI report.

The method of determining the X first CSI report(s) is discussed below. The following method enables the base station to correctly interpret that the CSI in the second CSI report is used to monitor which first CSI reports, so that the base station adjusts based on the reported monitoring results for the UE side model, improving the reliability of the communication system.

Optionally, the X first CSI report(s) may be the X first CSI report(s) no later than the second CSI report. Optionally, the X first CSI report(s) being the X first CSI report(s) no later than the second CSI report means that the time domain unit where the X first CSI report(s) are located is no later than the time domain unit where the second CSI report is located. In the disclosure, the term “no later than” may be used interchangeably with the term “earlier than.” Optionally, the X first CSI report(s) may be the X first CSI report(s) earlier than the second CSI report. Optionally, the X first CSI report(s) being the X first CSI report(s) earlier than the second CSI report means that the time domain unit where the X first CSI report(s) are located is earlier than the time domain unit where the second CSI report is located. Optionally, the X first CSI report(s) may be the X first CSI report(s) closest to the second CSI report. Optionally, the X first CSI report(s) may be the latest X first CSI report(s) before the second CSI report. Optionally, the X first CSI report(s) may be the latest X first CSI report(s) no later than the second CSI report. Optionally, the X first CSI report(s) may be the closest X first CSI report(s) before the second CSI report (the X first CSI report(s) closest to the second CSI report, or to the time domain unit where the second CSI report is located). Optionally, the X first CSI report(s) may be the latest X first CSI report(s) no later than the second CSI report (the X first CSI report(s) closest to the second CSI report, or to the time domain unit where the second CSI report is located). Optionally, the X first CSI report(s) may be the X first CSI report(s) closest to the time domain unit where the second CSI report is located.

Optionally, when the second CSI report is aperiodic CSI report, the second CSI report may be triggered/scheduled/indicated by DCI. Optionally, the X first CSI report(s) refer to the X first CSI report(s) before the DCI, or the X first CSI report(s) no later than the DCI. Optionally, when a first condition is met, the X first CSI report(s) refer to the X first CSI report(s) before the DCI, or the X first CSI report(s) no later than the DCI. Optionally, when the first condition is met, the X first CSI report(s) refer to the latest X first CSI report(s) before the DCI, or the latest X first CSI report(s) no later than the DCI. Optionally, the first condition includes at least one of the followings:
The first CSI reporting configuration is associated with semi-persistent CSI report/periodic CSI report. For example, the first CSI reporting configuration corresponds to semi-persistent CSI report/periodic CSI report. For example, the first CSI report is semi-persistent CSI report/periodic CSI report;
The second CSI reporting configuration is associated with aperiodic CSI report. For example, the second CSI reporting configuration corresponds to aperiodic CSI report. For example, the second CSI report is aperiodic CSI report; and/or
The second CSI report is triggered/scheduled by DCI.

Optionally, the X first CSI report(s) refer to the X first CSI report(s) no later than the second CSI report, or the X first CSI report(s) earlier than the second CSI report. Optionally, when a second condition is met, the X first CSI report(s) refer to the X first CSI report(s) no later than the second CSI report, or the X first CSI report(s) earlier than the second CSI report. Optionally, when the second condition is met, the X first CSI report(s) refer to the latest X first CSI report(s) no later than the second CSI report, or the latest X first CSI report(s) earlier than the second CSI report. Optionally, when the second condition is met, the X first CSI report(s) refer to the X first CSI report(s) no later than the CSI reference resource corresponding to the second CSI report, or the X first CSI report(s) earlier than the CSI reference resource corresponding to the second CSI report. Optionally, when the second condition is met, the X first CSI report(s) refer to the latest X first CSI report(s) no later than the CSI reference resource corresponding to the second CSI report, or the latest X first CSI report(s) earlier than the CSI reference resource corresponding to the second CSI report. Optionally, the second condition includes at least one of the followings:
The first CSI reporting configuration is associated with semi-persistent CSI report/periodic CSI report. For example, the first CSI reporting configuration corresponds to semi-persistent CSI report/periodic CSI report. For example, the first CSI report is semi-persistent CSI report/periodic CSI report; and/or
The second CSI reporting configuration is associated with semi-persistent CSI report/periodic CSI report. For example, the second CSI reporting configuration corresponds to semi-persistent CSI report/periodic CSI report. For example, the second CSI report is semi-persistent CSI report/periodic CSI report.

Optionally, the X first CSI report(s) refer to the X first CSI report(s) within a window. Optionally, the time domain position of a window may be determined by the length of the window and/or the starting point (e.g., starting time domain resource) and/or ending point (e.g., ending time domain resource) of the window.

Optionally, the length of the window may be indicated by the base station, or the length of the window may be predefined. For example, the base station may indicate the number of time domain units associated with/corresponding to the length of the window via at least one of RRC signaling, MAC-CE, and DCI. Optionally, the length of the window may be determined based on the CSI report periodicity associated with the first CSI reporting configuration and/or the periodicity associated with the third resource set. Optionally, when the first CSI report is periodic CSI report, and/or the resources included in the third resource set are SSBs or semi-persistent/periodic CSI-RSs, the length of the window is determined based on the CSI report periodicity associated with the first CSI reporting configuration and/or the periodicity associated with the third resource set. Optionally, the length of the window is determined based on the longer/shorter periodicity of the CSI report periodicity associated with the first CSI reporting configuration and the periodicity associated with the third resource set. Optionally, the length of the window is determined based on the maximum/minimum value of the CSI report periodicity associated with the first CSI reporting configuration and the periodicity associated with the third resource set.

Optionally, the starting time domain resource/ending time domain resource of the window is determined based on at least one of the followings:
The indication of the base station, for example, the indication of the second CSI reporting configuration;
The time domain resource where the second CSI report is located, or the time domain resource where the CSI reference resource corresponding to the second CSI report is located;
The length of the window. Refer above for the determination method of the length of the window;
The CSI report periodicity associated with the first CSI reporting configuration; and/or
The periodicity associated with the third resource set.

Optionally, the starting time domain resource/ending time domain resource of the window is determined based on the time domain resource where the second CSI report is located and/or the indication of the base station. For example, the distance between the starting time domain resource/ending time domain resource of the window and the time domain resource where the second CSI report is located is predefined or indicated by the base station. For example, the distance between the starting time domain resource/ending time domain resource of the window and the time domain resource (for example, the first time domain resource, or the last time domain resource) of the channel carrying the second CSI report is predefined or indicated by the base station. For example, the time domain resource offset between the starting time domain resource/ending time domain resource of the window and the time domain resource where the second CSI report is located is Y, where Y may be predefined or indicated by the base station. For example, the value of Y may be one of 1, 2, 3, 4, 5, 6, 7, 8, 12, 16, and 32. For example, Y may be indicated by at least one of RRC, MAC-CE, and DCI. For example, when the time domain resource where the second CSI report is located is slot n, the time domain resource where the starting time domain resource/ending time domain resource of the window is located is slot n−Y or n+Y.

Optionally, the starting time domain resource/ending time domain resource of the window is determined based on the time domain resource where the CSI reference resource corresponding to the second CSI report is located and/or the indication of the base station. For example, the distance between the starting time domain resource/ending time domain resource of the window and the time domain resource where the CSI reference resource corresponding to the second CSI report is located is predefined or indicated by the base station. For example, the distance between the starting time domain resource/ending time domain resource of the window and the time domain resource (for example, the first time domain resource, or the last time domain resource) of the CSI reference resource corresponding to the second CSI report is predefined or indicated by the base station. For example, the time domain resource offset between the starting time domain resource/ending time domain resource of the window and the time domain resource where the CSI reference resource corresponding to the second CSI report is located is Z, where Z may be predefined or indicated by the base station. For example, the value of Z may be one of 1, 2, 3, 4, 5, 6, 7, 8, 12, 16, and 32. For example, Z may be indicated by at least one of RRC, MAC-CE, and DCI. For example, when the time domain resource where the CSI reference resource corresponding to the second CSI report is located is slot n, the time domain resource where the starting time domain resource/ending time domain resource of the window associated with the second CSI report is located is slot n−Z or n+Z. Optionally, the starting time domain resource/ending time domain resource of the window is determined based on the time domain resource where the second CSI report is located and/or the CSI report periodicity associated with the first CSI reporting configuration and/or the periodicity associated with the third resource set. The CSI report periodicity associated with the first CSI reporting configuration and/or the periodicity associated with the third resource set may be the maximum/minimum value of the CSI report periodicity associated with the first CSI reporting configuration and the periodicity associated with the third resource set. Optionally, the index of the slot where the starting time domain resource/ending time domain resource of the window is located is n*P, where P is determined based on the CSI report periodicity associated with the first CSI reporting configuration and/or the periodicity associated with the third resource set. For example, P is the number of slots corresponding to the CSI report periodicity associated with the first CSI reporting configuration. Here, n is an integer. The index of the slot associated with the starting time domain resource/ending time domain resource of the window is n*P, where n is n that minimizes the offset between the slot corresponding to n*P and the slot where the second CSI report is located.

Optionally, the N1 resources associated with the first CSI report (for example, the resources corresponding to the N resource indicators) are mapped with the resource in the third resource set. Optionally, the N1 resources associated with one (or each) first CSI report of the X CSI reports are mapped with the resource in the third resource set. Optionally, the X CSI reports meet the following condition: the N1 resources associated with at least one (or each) first CSI report of the X CSI reports are mapped with the resource in the third resource set. Optionally, N1 resources associated with the first CSI report being mapped with the resource in the third resource set means that at least one resource of the N1 resources associated with the first CSI report (for example, the resources corresponding to the N1 resource indicators) is mapped with the resource in the third resource set. Optionally, the first CSI report being mapped with the third resource set means that each of the N1 resources reported in the first CSI report (for example, each of the resources corresponding to the N1 resource indicators) is mapped with the resource in the third resource set. Refer other part of description in the disclosure for the mapping method of the resources. For example, the X first CSI report(s) refer to the latest X first CSI report(s) no later than the CSI reference resource corresponding to the second CSI report where each of the reported N1 resources (for example, each of the resources corresponding to the N1 resource indicators) is mapped with the resource in the third resource set.

Optionally, if one (or each) first CSI report of the X CSI reports is not mapped with the resource in the third resource set, the second CSI report is not transmitted (or the second CSI report is dropped). Optionally, the first CSI report being not mapped with the resource in the third resource set means that at least one of the N1 resources reported in the first CSI report (for example, at least one of the resources corresponding to the N1 resource indicators) is not mapped with the resource in the third resource set. Optionally, the first CSI report being not mapped with the resource in the third resource set means that each of the N1 resources reported in the first CSI report (for example, each of the resources corresponding to the N1 resource indicators) is not mapped with the resources in the third resource set. This method allows the UE to avoid reporting when the predicted beams associated with the X CSI reports are not mapped to the resource in the resource set for monitoring since the comparison result is already known by the base station, saving energy consumption of the UE and improving the efficiency of the communication system.

The determination method of the measurement of the third resource set is discussed below. The following method may enable the UE to use the measurement result of the monitoring set closer in time domain to the report for the first CSI report for comparison, in order to improve the timeliness/accuracy of performance monitoring.

Optionally, the measurement of the third resource set may refer to the measurement result of the third resource set. Optionally, the measurement of the third resource set may refer to the measurement of the transmission occasion of the resource in the third resource set, and/or the measurement of the resource in the third resource set, and/or the measurement of all resources in the third resource set. Here, each of the X first CSI report(s) may be compared with measurement of the third resource set. Each of the X first CSI report(s) may be compared with the associated/corresponding measurement of the third resource set. Here, the transmission occasion may be considered the measurement occasion. In the disclosure, the term “occasion of resource” may be used interchangeably with the term “transmission occasion of resource” or “measurement of resource” or “measurement occasion of resource.” Optionally, the transmission occasion associated with the x-th (1≤x≤X) CSI report of the X first CSI report(s) may be at least one of the followings:
The transmission occasion of the resource in the third resource set no later than (or earlier than) the second CSI report. For example, the latest transmission occasion of the resource in the third resource set no later than (or earlier than) the second CSI report. For example, the x-th latest transmission occasion of the resource in the third resource set no later than (or earlier than) the second CSI report;
The transmission occasion of the resource in the third resource set no later than (or earlier than) the CSI reference resource corresponding to the second CSI report; for example, the latest transmission occasion of the resource in the third resource set no later than (or earlier than) the CSI reference resource corresponding to the second CSI report. For example, the x-th latest transmission occasion of the resource in the third resource set no later (or earlier) than the CSI reference resource corresponding to the second CSI report;
The closest transmission occasion of the resource in the third resource set. For example, the transmission occasion of the resource in the third resource set with minimal distance to the x-th CSI report. Optionally, the distance between the x-th CSI report and the transmission occasion of the resource may be the distance between the time domain resource where the x-th CSI report is located and the time domain resource where the transmission occasion of the resource is located. Optionally, the distance between the x-th CSI report and the transmission occasion of the resource may be the distance between the time domain unit of the channel carrying the CSI report and the time domain unit of the transmission occasion of the resource. Optionally, the distance between the x-th CSI report and the transmission occasion of the resource may be the distance between the first time domain unit (or the last time domain unit) where the channel carrying the CSI report is located and the first time domain unit (or the last time domain unit) where the transmission occasion of the resource is located. Optionally, the distance between the x-th CSI report and the transmission occasion of the resource may be the distance between the first time domain unit (or the last time domain unit) of the channel carrying the CSI report and the first time domain unit (or the last time domain unit) of the transmission occasion of the resource. For example, if the CSI report is before the transmission occasion of the resource, the distance is the distance between the last time domain unit of the channel carrying the CSI report and the first time domain unit of the transmission occasion of the resource. If the CSI report is after the transmission occasion of the resource, the distance is the distance between the first time domain unit of the channel carrying the CSI report and the last time domain unit of the transmission occasion of the resource. Here, the distance may be the offset of the time domain resource(s). Optionally, if two transmission occasions are equally distant from one CSI report, the later transmission occasion is used for comparison. Optionally, if two transmission occasions are equally distant from one CSI report, the earlier transmission occasion is used for comparison. Here, the unit of time domain resource may be slot or symbol; and/or
The closest transmission occasion of the resource in the third resource set. For example, the transmission occasion of the resource in the third resource set with minimal distance to the CSI reference resource corresponding to the x-th CSI report. Optionally, the distance between the CSI reference resource corresponding to the x-th CSI report and the transmission occasion of the resource may be the distance between the time domain resource where the CSI reference resource corresponding to the x-th CSI report is located and the time domain resource where the transmission occasion of the resource is located. Optionally, the distance between the CSI reference resource corresponding to the x-th CSI report and the transmission occasion of the resource may be the distance between the time domain unit of the CSI reference resource corresponding to the x-th CSI report and the time domain unit of the transmission occasion of the resource. Optionally, the distance between the CSI reference resource corresponding to the x-th CSI report and the transmission occasion of the resource may be the first time domain unit (or the last time domain unit) where the CSI reference resource corresponding to the x-th CSI report is located and the first time domain unit (or the last time domain unit) where the transmission occasion of the resource is located. Optionally, the distance between the CSI reference resource corresponding to the x-th CSI report and the transmission occasion of the resource may be the distance between the first time domain unit (or the last time domain unit) of the CSI reference resource corresponding to the x-th CSI report and the first time domain unit (or the last time domain unit) of the transmission occasion of the resource. For example, if the CSI reference resource corresponding to the CSI report is before the transmission occasion of the resource, the distance is the distance between the last time domain unit of the CSI reference resource corresponding to the CSI report and the first time domain unit of the transmission occasion of the resource. If the CSI reference resource corresponding to the CSI report is after the transmission occasion of the resource, the distance is the distance between the first time domain unit of the CSI reference resource corresponding to the CSI report and the last time domain unit of the transmission occasion of the resource. Here, the distance may be the offset of the time domain resource(s). Optionally, if two transmission occasions are equally distant from the CSI reference resource corresponding to one CSI report, the later transmission occasion is used for comparison. Optionally, if two transmission occasions are equally distant from one CSI report, the earlier transmission occasion is used for comparison. Here, the unit of time domain resource may be slot or symbol.

Optionally, the measurement of the third resource set may refer to the measurement of the third resource set in a window associated with the first CSI report. Optionally, the measurement of the third resource set may refer to measurement of the transmission occasion of the resource in the third resource set, and/or measurement of the resource in the third resource set. Here, each of the X first CSI report(s) may be compared with measurement of the third resource set in the window. Each of the X first CSI report(s) may be compared with measurement of the third resource set in the associated/corresponding window. Here, the transmission occasion may be considered the measurement occasion. The time domain position of a window may be determined by the length of the window and the starting point (e.g., starting time domain resource) and/or ending point (e.g., ending time domain resource) of the window. The window associated with the first CSI report is described below.

Optionally, the length of the window associated with the x-th (1≤x≤X) CSI report of the X first CSI report(s) is indicated by the base station. For example, the base station indicates the number of time domain units associated with/corresponding to the length of the window via at least one of RRC signaling, MAC-CE, and DCI. Optionally, the length of the window associated with the x-th (1≤x≤X) CSI report of the X first CSI report(s) is determined based on the CSI report periodicity associated with the first CSI reporting configuration and/or the periodicity associated with the third resource set. Optionally, when the first CSI report is periodic CSI report, and/or the resources included in the third resource set are SSBs or semi-persistent/periodic CSI-RSs, the length of the window associated with the x-th (1≤x≤X) CSI report of the X first CSI report(s) is determined based on the CSI report periodicity associated with the first CSI reporting configuration and/or the periodicity associated with the third resource set. Optionally, the length of the window associated with the x-th (1≤x≤X) CSI report of the X first CSI report(s) is determined based on the longer/shorter periodicity of the CSI report periodicity associated with the first CSI reporting configuration and the periodicity associated with the third resource set. Optionally, the length of the window associated with the x-th (1≤x≤X) CSI report of the X first CSI report(s) is determined based on the maximum/minimum value of the CSI report periodicity associated with the first CSI reporting configuration and the periodicity associated with the third resource set. For example, the length of the window associated with the x-th (1≤x≤X) CSI report of the X first CSI report(s) is a*P. Optionally, P may correspond to the periodicity associated with the third resource set, or the CSI report periodicity associated with the first CSI reporting configuration, or the maximum periodicity/minimum periodicity of the periodicity associated with the third resource set and the CSI report periodicity associated with the first CSI reporting configuration. Here, a may be a scaling factor. The value of a may be one of 1, 2, 3, 4, 5, 6, 7, 8, 12, 16, and 32. Optionally, a may be predefined. Optionally, a may be indicated by the base station. For example, a may be indicated by at least one of RRC signaling, MAC-CE, and DCI. Here, the CSI report periodicity associated with the CSI reporting configuration refers to the CSI report periodicity corresponding to the CSI reporting configuration. For example, if the CSI report corresponding to the CSI reporting configuration is periodic or semi-persistent, the CSI reporting configuration includes a report slot configuration parameter reportSlotConfig, which may indicate the periodicity of the CSI report. Here, the periodicity associated with the third resource set refers to the periodicity of the resource in the third resource set. For example, when the third resource set includes semi-persistent/periodic CSI-RS, the periodicity associated with the third resource set refers to the periodicity of the CSI-RS. For example, when the third resource set includes SSB, the periodicity associated with the third resource set refers to the periodicity of SSB.

Optionally, the starting time domain resource/ending time domain resource of the window associated with the x-th (1≤x≤X) CSI report of the X first CSI report(s) is determined based on at least one of the followings:
The indication of the base station, for example, the indication of the second CSI reporting configuration;
The time domain resource where the x-th CSI report is located, or the time domain resource where the CSI reference resource corresponding to the x-th CSI report is located;
The length of the window. Refer above for the determination method of the length of the window;
The CSI report periodicity associated with the first CSI reporting configuration; and/or
The periodicity associated with the third resource set.

Optionally, the starting time domain resource/ending time domain resource of the window associated with the x-th (1≤x≤X) CSI report of the X first CSI report(s) is determined based on the time domain resource where the x-th CSI report is located and/or the indication of the base station. For example, the distance between the starting time domain resource/ending time domain resource of the window associated with the x-th (1≤x≤X) CSI report of the X first CSI report(s) and the time domain resource where the CSI reporting is located is predefined or indicated by the base station. For example, the distance between the starting time domain resource/ending time domain resource of the window associated with the x-th (1≤x≤X) CSI report of the X first CSI report(s) and the time domain resource of the channel carrying the CSI report (for example, the first time domain resource, or the last time domain resource) is predefined or indicated by the base station. For example, the time domain resource offset between the starting time domain resource/ending time domain resource of the window associated with the x-th CSI report and the time domain resource where the CSI report is located is Y, where Y may be predefined or indicated by the base station. For example, the value of Y may be one of 1, 2, 3, 4, 5, 6, 7, 8, 12, 16, and 32. For example, Y may be indicated by at least one of RRC, MAC-CE, and DCI. For example, when the time domain resource where the x-th CSI report is located is slot n, the time domain resource where the starting time domain resource/ending time domain resource of the window associated with the x-th CSI report is located is slot n−Y or n+Y.

Optionally, the starting time domain resource/ending time domain resource of the window associated with the x-th (1≤x≤X) CSI report of the X first CSI report(s) is determined based on the time domain resource where the CSI reference resource corresponding to the x-th CSI report is located and/or the indication of the base station. For example, the distance between the starting time domain resource/ending time domain resource of the window associated with the x-th (1≤x≤X) CSI report in the X first CSI report(s) and the time domain resource where the CSI reference resource corresponding to the x-th CSI report is located is predefined or indicated by the base station. For example, the distance between the starting time domain resource/ending time domain resource of the window associated with the x-th (1≤x≤X) CSI report of the X first CSI report(s) and the time domain resource of the CSI reference resource corresponding to the x-th CSI report (for example, the first time domain resource, or the last time domain resource) is predefined or indicated by the base station. For example, the time domain resource offset between the starting time domain resource/ending time domain resource of the window associated with the x-th CSI report and the time domain resource where the CSI reference resource corresponding to the x-th CSI report is located is Z, where Z is predefined or indicated by the base station. For example, the value of Z may be one of 1, 2, 3, 4, 5, 6, 7, 8, 12, 16, and 32. For example, Z may be indicated by at least one of RRC, MAC-CE, and DCI. For example, when the time domain resource where the CSI reference resource corresponding to the x-th CSI report is located is slot n, the time domain resource where the starting time domain resource/ending time domain resource of the window associated with the x-th CSI report is located is slot n−Z or n+Z. Optionally, the starting time domain resource/ending time domain resource of the window associated with the x-th (1≤x≤X) CSI report of the X first CSI report(s) is determined based on the time domain resource where the x-th CSI report is located and/or the CSI report periodicity associated with the first CSI reporting configuration and/or the periodicity associated with the third resource set. The CSI report periodicity associated with the first CSI reporting configuration and/or the periodicity associated with the third resource set may be the maximum/minimum value of the CSI report periodicity associated with the first CSI reporting configuration and the periodicity associated with the third resource set. Optionally, the index of the slot where the starting time domain resource/ending time domain resource of the window associated with the x-th CSI report is located is n*P, where P is determined based on the CSI report periodicity associated with the first CSI reporting configuration and/or the periodicity associated with the third resource set. For example, P is the number of slots corresponding to the CSI report periodicity associated with the first CSI reporting configuration. Here, n is an integer. The index of the slot associated with the starting time domain resource/ending time domain resource of the window associated with the x-th (1≤x≤X) CSI report is n*P, where n is n that minimizes the offset between the slot corresponding to n*P and the slot where the first CSI report is located. Optionally, if there is more than one n such that the offset between the slot corresponding to n*P and the slot where the first CSI report is located is minimized, the window corresponding to the smaller/larger value of n is used for comparison.

The determination method of M measurements associated with the third resource set is discussed below. The following method can enable the base station to correctly interpret the CSI in the second CSI report corresponds to which measurements of the third resource set, so that the base station adjusts based on the reported monitoring results for the UE side model, improving the reliability of the communication system. Additionally, the M measurements associated with the third resource set may be used to determine the BAI, refer above for description.

Optionally, the measurement of the third resource set may refer to the measurement result of the third resource set. Optionally, the measurement of the third resource set may refer to the measurement of the transmission occasion of the resource in the third resource set, and/or the measurement of the resource in the third resource set, and/or the measurement of all resources in the third resource set. Here, the transmission occasion may be considered the measurement occasion. In the disclosure, the term “occasion of resource” may be used interchangeably with the term “transmission occasion of resource” or “measurement of resource” or “measurement occasion of resource.”

Optionally, the M measurements associated with the third resource set refer to the M latest measurements associated with the third resource set. Optionally, the M measurements associated with the third resource set refer to the latest M measurements associated with the third resource set. Optionally, the M measurements associated with the third resource set refer to the latest M measurements associated with the third resource set no later than the CSI reference resource corresponding to the second CSI report. Optionally, the M measurements associated with the third resource set refer to the latest M measurements associated with the third resource set no later than the second CSI report. Optionally, M may be equal to X. For example, M=X.

Optionally, the M measurements associated with the third resource set refer to M measurements associated with the third resource set in a window.

Optionally, the M measurements associated with the third resource set refer to measurements associated with the third resource set in M windows. Optionally, the M windows are no later than the second CSI report. Optionally, optionally, the M windows are no later than the CSI reference resource corresponding to the second CSI report. Optionally, the latest window of the M windows is no later than the second CSI report. Optionally, the latest window of the M windows is no later than the CSI reference resource corresponding to the second CSI report. Optionally, at least one of the M windows includes the first CSI report. Optionally, each of the M windows includes the first CSI report. Optionally, the M windows meet the following condition: at least one (or each) window of the M windows includes the first CSI report. A window including the first CSI report means that a window includes the time domain resource for carrying the first CSI report. Optionally, M may be equal to X. For example, M=X.

Optionally, the length of the window may be indicated by the base station, or the length of the window may be predefined. Optionally, the window may be a window related to M measurements associated with third resource set. Optionally, the window may be one window (or each window) of the M windows. For example, the base station may indicate the number of time domain units associated with/corresponding to the length of the window via at least one of RRC signaling, MAC-CE, and DCI. Optionally, the length of the window may be determined based on the CSI report periodicity associated with the first CSI reporting configuration and/or the periodicity associated with the third resource set. Optionally, when the first CSI report is periodic CSI report, and/or the resources included in the third resource set are SSBs or semi-persistent/periodic CSI-RSs, the length of the window is determined based on the CSI report periodicity associated with the first CSI reporting configuration and/or the periodicity associated with the third resource set. Optionally, the length of the window is determined based on the longer/shorter periodicity of the CSI report periodicity associated with the first CSI reporting configuration and the periodicity associated with the third resource set. Optionally, the length of the window is determined based on the maximum/minimum value of the CSI report periodicity associated with the first CSI reporting configuration and the periodicity associated with the third resource set.

Optionally, the distance between adjacent windows of the M windows may be indicated by the base station, or the length of the window may be predefined. Optionally, the distance between adjacent windows of the M windows may be the distance between time domain units (for example, the first time domain unit, or the last time domain unit) of the adjacent windows. For example, the base station may indicate the number of time domain units associated with/corresponding to the distance between adjacent windows via at least one of RRC signaling, MAC-CE, and DCI. Optionally, the length of the distance may be determined based on the CSI report periodicity associated with the first CSI reporting configuration and/or the periodicity associated with the third resource set. Optionally, when the first CSI report is periodic CSI report, and/or the resources included in the third resource set are SSBs or semi-persistent/periodic CSI-RSs, the length of the distance is determined based on the CSI report periodicity associated with the first CSI reporting configuration and/or the periodicity associated with the third resource set. Optionally, the length of the distance is determined based on the longer/shorter periodicity of the CSI report periodicity associated with the first CSI reporting configuration and the periodicity associated with the third resource set. Optionally, the length of the distance is determined based on the maximum/minimum value of the CSI report periodicity associated with the first CSI reporting configuration and the periodicity associated with the third resource set. Optionally, the distance between adjacent windows may be equal to the length of the windows.

Optionally, the starting time domain resource/ending time domain resource of the window (for example, the last window of the M windows, or the first window of the M windows, or a window related to M measurements associated with the third resource set) is determined based on at least one of the followings:
The indication of the base station, for example, the indication of the second CSI reporting configuration;
The time domain resource where the second CSI report is located, or the time domain resource where the CSI reference resource corresponding to the second CSI report is located;
The length of the window. Refer above for the determination method of the length of the window;
The CSI report periodicity associated with the first CSI reporting configuration; and/or
The periodicity associated with the third resource set.

Optionally, the starting time domain resource/ending time domain resource of the window is determined based on the time domain resource where the second CSI report is located and/or the indication of the base station. For example, the distance between the starting time domain resource/ending time domain resource of the window and the time domain resource where the second CSI report is located is predefined or indicated by the base station. For example, the distance between the starting time domain resource/ending time domain resource of the window and the time domain resource (for example, the first time domain resource, or the last time domain resource) of the channel carrying the second CSI report is predefined or indicated by the base station. For example, the time domain resource offset between the starting time domain resource/ending time domain resource of the window and the time domain resource where the second CSI report is located is Y, where Y may be predefined or indicated by the base station. For example, the value of Y may be one of 1, 2, 3, 4, 5, 6, 7, 8, 12, 16, and 32. For example, Y may be indicated by at least one of RRC, MAC-CE, and DCI. For example, when the time domain resource where the second CSI report is located is slot n, the time domain resource where the starting time domain resource/ending time domain resource of the window is located is slot n−Y or n+Y.

Optionally, the starting time domain resource/ending time domain resource of the window is determined based on the time domain resource where the CSI reference resource corresponding to the second CSI report is located and/or the indication of the base station. For example, the distance between the starting time domain resource/ending time domain resource of the window and the time domain resource where the CSI reference resource corresponding to the second CSI report is located is predefined or indicated by the base station. For example, the distance between the starting time domain resource/ending time domain resource of the window and the time domain resource (for example, the first time domain resource, or the last time domain resource) of the CSI reference resource corresponding to the second CSI report is predefined or indicated by the base station. For example, the time domain resource offset between the starting time domain resource/ending time domain resource of the window and the time domain resource where the CSI reference resource corresponding to the second CSI report is located is Z, where Z may be predefined or indicated by the base station. For example, the value of Z may be one of 1, 2, 3, 4, 5, 6, 7, 8, 12, 16, and 32. For example, Z may be indicated by at least one of RRC, MAC-CE, and DCI. For example, when the time domain resource where the CSI reference resource corresponding to the second CSI report is located is slot n, the time domain resource where the starting time domain resource/ending time domain resource of the window is located is slot n−Z or n+Z. Optionally, the starting time domain resource/ending time domain resource of the window is determined based on the time domain resource where the second CSI report is located and/or the CSI report periodicity associated with the first CSI reporting configuration and/or the periodicity associated with the third resource set. The CSI report periodicity associated with the first CSI reporting configuration and/or the periodicity associated with the third resource set may be the maximum/minimum value of the CSI report periodicity associated with the first CSI reporting configuration and the periodicity associated with the third resource set.

Optionally, the CSI (e.g., BAI) in the second CSI report may be determined based on comparison of each of the M measurements associated with the third resource set with the CSI in the first CSI report. Optionally, the CSI (e.g., BAI) in the second CSI report may be determined based on comparison of each of the M measurements associated with the third resource set with the resource associated with the resource indicator included in the first CSI report. Optionally, the CSI (e.g., BAI) in the second CSI report may be determined based on comparison of the m1-th measurement of the M measurements associated with the third resource set associated with the resource associated with the resource indicator included in the (corresponding) first CSI report. Optionally, m1 may be any integer ranged from 1 to M. Optionally, one of the M measurements associated with the third resource set may be compared with the CSI in the first CSI report associated with/corresponding to the measurement. Optionally, one of the M measurements associated with the third resource set may be compared with the resource associated with the resource indicator included in the first CSI report associated with/corresponding to the measurement. Refer above for the method of comparing the measurement associated with the third resource set with the resource associated with the resource indicator included in the CSI report. Optionally, the CSI in the first CSI report may be the N1 resource indicators included in the first CSI report. Optionally, the CSI in the first CSI report may be the resources associated with the N1 resource indicators included in the first CSI report.

The method of determining the CSI in the first CSI report for comparison corresponding to the M measurements associated with the third resource set is discussed below. Optionally, the m1-th measurement of the M measurements associated with the third resource set may be compared with the CSI in the first CSI report corresponding to/associated with the m1-th measurement. Optionally, 1≤m1≤M.

Optionally, the CSI in the first CSI report corresponding to the m1-th measurement of the M measurements associated with the third resource set may be determined based on at least one of the followings:
Optionally, the CSI in the first CSI report corresponding to the m1-th measurement may be determined based on the time domain resource of the transmission occasion associated with the m1-th measurement and the time domain resource of the first CSI report carrying the CSI. Optionally, the CSI in the first CSI report corresponding to the m1-th measurement of the M measurements is the CSI carried by the closest/farthest first CSI report from the time domain resource associated with the m1-th measurement. Optionally, the first CSI report is no later/no earlier than the time domain resources associated with the m1-th measurement. Optionally, the closest/farthest first CSI report refers to the closest/farthest first CSI report from the corresponding uplink channel. Optionally, if there are two first CSI reports with the same distance from the time domain resource associated with the measurement, the earlier/later (or prior/posterior) first CSI report is associated with the m1-th measurement; and/or
Optionally, the CSI in the first CSI report corresponding to the m1-th measurement may be determined based on the time domain resource of the transmission occasion associated with the m1-th measurement and the time domain resource of the CSI reference resource corresponding to the first CSI report carrying the CSI. Optionally, the CSI in the first CSI report corresponding to the m1-th measurement of the M measurements is the CSI carried by the first CSI report with corresponding CSI reference resource is closest/farthest from the time domain resource associated with the m1-th measurement. Optionally, the CSI reference resource corresponding to the first CSI report is no later/earlier than the time domain resource associated with the m1-th measurement. Optionally, if there are two CSI reference resources corresponding to the first CSI reports with the same distance from the time domain resources associated with the measurement, the first CSI report with the earlier/later (or prior/posterior) CSI reference resource is associated with the m1-th measurement.

Optionally, the CSI in the first CSI report corresponding to the m1-th measurement of the M measurements associated with the third resource set may be the CSI in the first CSI report in the window associated with the m1-th measurement. Optionally, refer above for the method of determining the window associated with the measurement associated with the third resource set. Optionally, the length of the window associated with the m1-th measurement of the M measurements associated with the third resource set is indicated by the base station. For example, the base station indicates the number of time domain units associated with/corresponding to the length of the window via at least one of RRC signaling, MAC-CE, and DCI. Optionally, the length of the window is determined based on the CSI report periodicity associated with the first CSI reporting configuration and/or the periodicity associated with the third resource set. Optionally, when the first CSI report is periodic CSI report, and/or the resources included in the third resource set are SSBs or semi-persistent/periodic CSI-RSs, the length of the window is determined based on the CSI report periodicity associated with the first CSI reporting configuration and/or the periodicity associated with the third resource set. Optionally, the length of the window is determined based on the longer/shorter periodicity of the CSI report periodicity associated with the first CSI reporting configuration and the periodicity associated with the third resource set. Optionally, the length of the window is determined based on the maximum/minimum value of the CSI report periodicity associated with the first CSI reporting configuration and the periodicity associated with the third resource set. For example, the length of the window is a*P. Optionally, P may correspond to the periodicity associated with the third resource set, or the CSI report periodicity associated with the first CSI reporting configuration, or the maximum periodicity/minimum periodicity of the periodicity associated with the third resource set and the CSI report periodicity associated with the first CSI reporting configuration. Here, a may be a scaling factor. The value of a may be one of 1, 2, 3, 4, 5, 6, 7, 8, 12, 16, and 32. Optionally, a may be predefined. Optionally, a may be indicated by the base station. For example, a may be indicated by at least one of RRC signaling, MAC-CE, and DCI. Here, the CSI report periodicity associated with the CSI reporting configuration refers to the CSI report periodicity corresponding to the CSI reporting configuration. For example, if the CSI report corresponding to the CSI reporting configuration is periodic or semi-persistent, the CSI reporting configuration includes a report slot configuration parameter reportSlotConfig, which may indicate the periodicity of CSI report. Here, the periodicity associated with the third resource set refers to the periodicity of the resource in the third resource set. For example, when the third resource set includes semi-persistent/periodic CSI-RS, the periodicity associated with the third resource set refers to the periodicity of the CSI-RS. For example, when the third resource set includes SSB, the periodicity associated with the third resource set refers to the periodicity of SSB.

Optionally, the starting time domain resource/ending time domain resource of the window associated with the m1-th measurement of the M measurements associated with the third resource set is determined based on at least one of the followings:
The indication of the base station, for example, the indication of the second CSI reporting configuration;
The time domain resource of the m1-th measurement; for example, the time domain resource of the transmission occasion of the m1-th measurement;
The length of the window. Refer above for the determination method of the length of the window;
The CSI report periodicity associated with the first CSI reporting configuration; and/or
The periodicity associated with the third resource set.

Optionally, the starting time domain resource/ending time domain resource of the window associated with the m1-th measurement of the M measurements associated with the third resource set is determined based on the time domain resource associated with the m1-th measurement and/or the indication of the base station. For example, the distance between the starting time domain resource/ending time domain resource of the window associated with the m1-th measurement and the time domain resource where the transmission occasion of the m1-th measurement is located is predefined or indicated by the base station. For example, the distance of the starting time domain resource/ending time domain resource of the window associated with the m1-th measurement and the time domain resource (for example, the first time domain resource, or the last time domain resource) associated with the transmission occasion of the m1-th measurement/the transmission occasion of the m1-th measurement is located is predefined or indicated by the base station. For example, the time domain resource offset between the starting time domain resource/ending time domain resource of the window associated with the m1-th measurement and the time domain resource where the transmission occasion of the m1-th measurement is located is Y, where Y may be predefined or indicated by the base station. For example, the value of Y may be one of 1, 2, 3, 4, 5, 6, 7, 8, 12, 16, and 32. For example, Y may be indicated by at least one of RRC, MAC-CE, and DCI. For example, when the time domain resource where the transmission occasion of the m1-th measurement is located is slot n, the time domain resource where the starting time domain resource/ending time domain resource of the window associated with the m1-th measurement is located is slot n−Y or n+Y.

In some cases, the UE may report the CSI associated with F (F≥1) time instances. Optionally, the UE may determine and/or report the CSI associated with the F time instance(s) based on the first CSI reporting configuration. Optionally, the report carrying the CSI associated with the first CSI reporting configuration may be referred to as the first CSI report. Optionally, the UE may determine and/or report the CSI based on the first CSI reporting configuration. Optionally, when the first CSI reporting configuration includes/is associated with time domain information, the UE may report the CSI for the F time instance(s). The UE may determine and/or report the predicted CSI based on the first CSI reporting configuration. Optionally, the predicted CSI may be at least one of the followings: predicted CRI, predicted SSBRI, and predicted L1-RSRP. In one report instance, the UE may report the CSI associated with the F time instance(s). Here, the CSI associated with the F time instance(s) may be F CSI associated with the F time instance(s). For example, each of the F time instance(s) is associated with one CSI. Here, the CSI associated with one time instance may be referred to as the CSI for one time instance, or the CSI of one time instance. It may be considered that the CSI is applied/effective in the corresponding/associated time instance. It may be considered that the CSI is applicable in the corresponding/associated time instance. It may be considered that the CSI is predicted for the associated/corresponding time instance. It may be considered that CSI is the predicted CSI applicable to the corresponding time instance. It may be considered that CSI is the CSI for the corresponding time instance. It may be considered that the CSI is for the corresponding time instance. Optionally, the CSI associated with a time instance may include N1 CRIs/SSBRIs. Optionally, the CSI associated with a time instance may include N1 CRIs/SSBRIs and N1 L1-RSRP. Optionally, in one report instance, the UE may report the CSI for the F time instance(s), where the CSI for each time instance may include N1 CRIs/SSBRIs. In one report instance, the UE may report the CSI for the F time instance(s), where the CSI for each time instance may include N1 CRIs/SSBRIs and N1 L1-RSRP. Here, N1 CRIs/SSBRIs and N1 L1-RSRP may be one-to-one mapped, or one-to-one corresponding. In the disclosure, a CSI report may be a report in a report instance. L1-RSRP is determined based on the mapped/corresponding CRI/SSBRI. When the first resource set is configured, the CRI/SSBRI corresponds to the resource in the first resource set. Refer above for specific corresponding method. When the first resource set is not configured, the CRI/SSBRI corresponds to the resource in the second resource set. Optionally, the relation between CRI/SSBRI and the resource in the second resource set is as follows:
Optionally, the value k of SSBRI corresponds to the (k+1)-th resource in the second resource set. Optionally, when the resources included in the second resource set are SSB resources, the value k of SSBRI corresponds to the (k+1)-th resource in the second resource set. Optionally, k≥0. Optionally, the configuration information associated with/corresponding to the second resource set may include one or more entries of resource configuration information (for example, SSB resource configuration information). Optionally, one entry of SSB resource configuration information corresponds to an SSB resource. Optionally, the value k of SSBRI corresponds to the (k+1)-th entry in the configuration information associated with the second resource set;
Optionally, the value k of CRI corresponds to the (k+1)-th resource in the second resource set. Optionally, when the resources included in the second resource set are CSI-RS resources, the value k of CRI corresponds to the (k+1)-th resource in the second resource set. Optionally, k≥0. Optionally, the configuration information associated with/corresponding to the second resource set may include one or more entries of resource configuration information (for example, CSI-RS resource configuration information). Optionally, one entry of CSI-RS resource configuration information corresponds to a CSI-RS resource (for example, NZP CSI-RS resource). Optionally, the value k of CRI corresponds to the (k+1)-th entry in the configuration information associated with the second resource set; and/or
In the disclosure, the second resource set may also be a second set, wherein the second set is a set including K_{B} elements. Description about “resource” may equally apply to description of “element” in the second set.

The time instance is explained further below. Optionally, the time instance may be a time point, or a time period. Optionally, the time period may include one or more time domain units. Optionally, the time period may include one or more consecutive time domain units. Optionally, the earliest time domain unit of the one or more consecutive time domain units included in the time period may be referred to as the starting time domain unit. Optionally, the latest time domain unit of the one or more consecutive time domain units included in the time period may be referred to as the ending time domain unit. Optionally, the time point may be defined by the time domain unit. For example, the time point may be the starting of the time domain unit or the ending of the time domain unit. The time domain unit (e.g., the starting time domain unit, or the ending time domain unit, or the time domain unit defining the time point) associated with the time period or time point may be referred to as the time instance associated with the time domain unit. Optionally, the time domain unit may be one of symbol, slot, sub-slot, subframe, millisecond, and second. Optionally, the F time instance(s) may be determined based on the time domain information. Optionally, the CSI reporting configuration is associated with/includes/is configured with the parameter for indicating the time domain information. Optionally, the time domain information is for prediction. Optionally, the time domain information is for time domain prediction (for example, time domain beam prediction, or time domain downlink beam prediction).

Optionally, the F time instance(s) are determined based on the reference time domain resource. Optionally, the time domain unit associated with at least one time instance (or each time instance) of the F time instance(s) is determined based on the reference time domain resource. Refer above for description of the reference time domain resource.
Optionally, each of the F time instance(s) may be configured with an offset parameter. For example, the f-th time instance of the F time instance(s) is configured with F_D_{f}. Optionally, 1≤f≤F. Optionally, the time domain unit associated with the f-th time instance of the F time instance(s) is n+F_D_{f}, where the time domain unit n is the time domain unit associated with the reference time domain resource. Optionally, the time domain unit associated with the reference time domain resource may be the first time domain unit (or the last time domain unit) where the reference time domain resource is located.
Optionally, the first time instance (or the earliest time instance) of the F time instance(s) may be configured with an offset parameter (e.g., F_D). Optionally, the time domain unit associated with the first (or earliest) time instance of the F time instance(s) is time domain unit n+F_D, where time domain unit n is the time domain unit associated with the reference time domain resource. Optionally, the time domain unit associated with the reference time domain resource may be the first time domain unit (or the last time domain unit) where the reference time domain resource is located. Optionally, the time domain unit where the f-th/f-th earliest time instance of the F time instance(s) is located is the time domain unit n+F_D+(f−1)*F_offset. Optionally, 1≤f≤F. Optionally, the f-th time instance of the F time instance(s) is determined based on the order in time domain of the time domain units associated with the time instances (for example, from front to back, or from back to front). For example, time instance #1 is associated with slot #3, time instance #2 is associated with slot #2, and time instance #3 is associated with slot #5, where the second time instance is time instance #2. F_D may be the offset between the reference time domain resource and the time instance. F_Dⱼ may be the offset between the reference time domain resource and the j-th time instance. Optionally, F_D may be indicated by the base station, or predefined, or determined based on the UE capability. For example, the value of F_D may be indicated by at least one of RRC, MAC-CE, and DCI. Optionally, F_Dⱼ may be indicated by the base station, or predefined, or determined based on the UE capability. For example, the value of F_Dⱼ may be indicated by at least one of RRC, MAC-CE, and DCI. Optionally, F_offset may be indicated by the base station, or predefined, or determined based on the UE capability. For example, the value of F_offset may be indicated by at least one of RRC, MAC-CE, and DCI. Optionally, the length of the time instance may be indicated by the base station, or predefined, or determined based on the UE capability. For example, the length of the time instance may be indicated by at least one of RRC, MAC-CE, DCI. The length of the time instance may be the number of time domain units occupied by the time instance, or the number of time domain units included in the time instance.

Optionally, the UE may report X (X≥1) first CSI report(s) associated with the first CSI reporting configuration. Optionally, the UE may report X (X≥1) first CSI report(s) for inference/prediction. Optionally, the UE may report X (X≥1) first CSI report(s) for reporting CSI for inference/prediction. Optionally, each of the X first CSI report(s) includes the CSI associated with F time instance(s). Optionally, the CSI associated with each of the F time instance(s) includes N1 resource indicators. Here, the resource indicator may be SSBRI and/or CRI. Optionally, the resource indicator corresponds to a resource in the first resource set, the resource indicator corresponds to or a resource in the second resource set. Refer above for corresponding method. Optionally, the N1 resource indicators may indicate/correspond to the best N1 resource(s) (top/best N1 resources) in the first resource set/second resource set. Optionally, the N1 resource indicators may indicate the strongest N1 resources in the first resource set/second resource set. Optionally, the N1 resource indicators may indicate N1 resources with the highest predicted L1-RSRP in the first resource set/second resource set. Optionally, X may be indicated by the base station, for example, indicated by at least one of RRC, MAC-CE, and DCI. X may be predefined. For example, when the first CSI reporting configuration is associated with aperiodic CSI report, X=1. Optionally, the value of X may be one of 1, 2, 3, 4, 5, 6, 7, 8. Optionally, X may be related to UE capability. For example, the value of X is less than or equal to the maximum value indicated by UE capability signaling.

Optionally, the periodicity of the CSI report corresponding to the first CSI reporting configuration associated with the second CSI reporting configuration may be the same as the periodicity of the resource in the third resource set associated with the second CSI reporting configuration. Optionally, this method is applicable to the case that the CSI report corresponding to the first CSI reporting configuration is periodic CSI report and/or semi-persistent CSI report. Optionally, this method is applicable to the case that the resources associated with the third resource set associated with the second CSI reporting configuration are periodic resources (for example, periodic CSI-RS resources and/or SSB resources) or semi-persistent resources (for example, semi-persistent CSI-RS resources). This method can allow the CSI report for model inference is one-to-one corresponding to the transmission occasion of the resource for model monitoring, which is convenient for comparison by the UE, reducing the complexity of the UE to compute the CSI and further reducing the hardware cost of the UE.

Optionally, the UE may determine and/or report the CSI based on the second CSI reporting configuration. Optionally, the UE may report the CSI associated with the second CSI reporting configuration. Optionally, the report carrying the CSI associated with the second CSI reporting configuration may be referred to as the second CSI report. Optionally, the UE may report the second CSI report for monitoring. Optionally, the UE may report the second CSI report for reporting the CSI for monitoring. Optionally, the UE may determine and/or report the CSI report based on the second CSI reporting configuration. Optionally, the CSI associated with the second CSI reporting configuration may be BAI. Optionally, the CSI associated with the second CSI reporting configuration (or the CSI included in the second CSI report) may be determined based on the followings (or the comparison of the following two):
The resources associated with the resource indicators included in the CSI associated with each of the F time instance(s) in each of the X first CSI report(s); and/or
The resource(s) determined based on measurement of the third resource set. Optionally, the resource determined based on measurement of the third resource set may be the resource in the third resource set determined based on measurement of all the resources in the third resource set. Optionally, the resource determined based on measurement of the third resource set may be one or more resources in the third resource set determined based on measurement of the third resource set. Optionally, the resource determined based on measurement of the third resource set may be one or more resources in the third resource set determined based on measurement of all resources in the third resource set.

The above method of generating the CSI for performance monitoring may allow the UE to compare the result of the CSI prediction associated with the time instance and the measurement result of the resource set for monitoring and reflect the result of the comparison in the CSI report, in order for the UE to report the CSI for performance monitoring. The CSI for performance monitoring can facilitate the base station to obtain the performance metrics of the UE side model for corresponding model management, improving the reliability of the UE side AI model.

Optionally, the CSI associated with the second CSI reporting configuration (or the CSI included in the second CSI report) may be determined based on comparison of the resources associated with the resource indicators in the CSI associated with each of the F time instance(s) included in each of the X first CSI report(s) and the resource determined based on measurement of the third resource set (e.g., the resources in the third resource set). Optionally, the measurement of the third resource set may be measurement of the resources of the third resource set. Optionally, the measurement of the third resource set may be measurement of all resources in the third resource set.

Optionally, the above comparison may be comparison of the resource associated with at least one of the N1 resource indicators in the CSI associated with the f-th time instance in the x-th (1≤x≤X) CSI report of the X first CSI report(s) and the resource determined based on measurement of the third resource set. Optionally, the f-th time instance refers to the f-th time instance of the F time instance(s). Optionally, 1≤f≤F.

Optionally, the above comparison may be (determining) whether the resources associated with the N1 resource indicators associated with the f-th time instance in the x-th CSI report of the X first CSI report(s) are in N2 resources with the highest (measured) L1-RSRP in the third set determined based on measurement of the third resource set. For example, each of the N1 resource indicators is associated with a resource. The UE compares whether the N1 resources associated with the N1 resource indicators associated with the f-th time instance in the x-th CSI report of the X first CSI report(s) are in the N2 resources with the highest (measured) L1-RSRP in the third resource set. This comparison method may be referred to as Method #5A. Here, the N1 resources being in the N2 resources can be considered as that the N1 resources are all in the N2 resources, or each of the N1 resources is in the N2 resources. Here, the N1 resources being in the N2 resources can be considered as that there are N1 resources of the N2 resources same as the N1 resources. Optionally, N1N2. Refer below for relevant description of N2. For example, predicted resources are CSI-RS #1 and CSI-RS #2, and three resources with the highest measured L1-RSRP in the third resource set are CSI-RS #1, CSI-RS #2, and CSI-RS #3, then the predicted resources are in the three resources with the highest measured L1-RSRP in the third resource set. For example, predicted resources are CSI-RS #1 and CSI-RS #2, and three resources with the highest measured L1-RSRP in the third resource set are CSI-RS #2, CSI-RS #3, and CSI-RS #4, then the predicted resources are not in the three resources with the highest measured L1-RSRP in the third resource set. This method allows the UE to compare whether the optimal beam in the set for monitoring is in the beams predicted by the UE, thereby helping the base station to determine whether the beam prediction matches the measurement result of the actually monitored beams, so that the base station adjusts accordingly when the prediction result deviates from the monitoring result, improving the reliability of the communication system.

Optionally, the above comparison may be (determining) whether the resource with the highest (measured) L1-RSRP in the third resource set determined based on measurement of the third resource set is the same as one of the resources associated with the N1 resource indicators in the CSI associated with the f-th time instance in the x-th CSI report of the X first CSI report(s). For example, each of the N1 resource indicators is associated with a resource. The UE compares whether the resource with the highest (measured) L1-RSRP in the third resource set is the same as one of the N1 resources associated with the N1 resource indicators in the CSI associated with the f-th time instance in the x-th CSI report of the X first CSI report(s). This comparison method may be referred to as Method #5. Optionally, the resources associated with the N1 resource indicators may be resources associated with one of the N1 resource indicators. For example, a resource indicator of the N1 resource indicators is associated with a resource. The UE compares whether the resource with the highest (measured) L1-RSRP in the third resource set is the same as the resource associated with one of the N1 resource indicators in the CSI associated with the f-th time instance in the x-th CSI report of the X first CSI report(s). This comparison method may be referred to as Method #6. This method allows the UE to compare whether the optimal beam in the set for monitoring is in the beams predicted by the UE, thereby helping the base station to determine whether the beam prediction matches the measurement result of the actually monitored beams, so that the base station adjusts accordingly when the prediction result deviates from the monitoring result, improving the reliability of the communication system.

Optionally, the above comparison may be (determining) whether the resource associated with one of the N1 resource indicators in the CSI associated with the f-th time instance in the x-th CSI report of the X first CSI report(s) is the same as one of the N2 (N2≥1) resources in the third resource set determined based on measurement of the third resource set. Optionally, N2 resource(s) may correspond to the top/best N2 resource(s) in the third resource set. Optionally, the N2 resource(s) may correspond to the strongest N2 resources in the third resource set. Optionally, the N2 resource(s) may correspond to the N2 resources with the highest (measured) L1-RSRP in the third resource set. Optionally, N2 may be indicated by the base station. For example, N2 is indicated by at least one of RRC, MAC-CE, or DCI. N2 may be predefined. This comparison method may be referred to as Method #7. This method allows the UE to compare whether the beam predicted by the UE is in the optimal group of beams in set for monitoring, thereby helping the base station to determine whether the beam prediction matches the measurement result of the actually monitored beams, so that the base station adjusts accordingly when the prediction result deviates from the monitoring result, improving the reliability of the communication system.

Optionally, the above comparison may be (determining) whether the difference between the (measured) L1-RSRP of the resource associated with one of the N1 resource indicators in the CSI associated with the f-th time instance in the x-th CSI report of the X first CSI report(s) and the highest (measured) L1-RSRP determined based on measurement of the third resource set is less than a threshold. Here, the threshold may be denoted as T dB. Optionally, T≥0. Optionally, T may be predefined. Optionally, the value of T may be one of 0, 1, 2, 3, 4, 5, 6, 7, 8. Optionally, the value of T may be indicated by the base station, for example, via the second CSI reporting configuration. Optionally, the value of T may be determined based on the UE capability. For example, the value of T is determined based on the indication of the reported UE capability signaling. This comparison method may be referred to as Method #8. This method allows the UE to compare whether the measured L1-RSRP of the optimal beam predicted by the UE and the measured L1-RSRP of the optimal beam in the set for monitoring are within a certain range, thereby helping the base station to determine whether the beam prediction matches the measurement result of the actually monitored beams, so that the base station adjusts accordingly when the prediction result deviates from the monitoring result, improving the reliability of the communication system.

Optionally, the UE may use one of Method #5A, Method #5, Method #6, Method #7, and Method #8 for comparison based on indication from the base station or a predefined method.

In the above methods, refer above for description of one of the N1 resource indicators. The description of one of the N1 resource indicators and the description associated with the first resource set is also applicable to the second resource set.

The determination method of CSI (e.g., BAI) is described below. BAI may be associated with one of the following Methods:
Method #A: Optionally, the value of BAI is indicated by a BAI field. Optionally, the value k of BAI means that there are k CSI reports with corresponding comparison results being true in the X first CSI report(s). Optionally, the value k of BAI refers to the number of CSI reports with corresponding comparison results being true of the X first CSI report(s). Optionally, k≥0. Optionally, k≤X. Optionally, the value k of BAI refers to the number of comparisons with the comparison results associated with the X first CSI report(s) being true. Optionally, the value k of BAI refers to the number of CSI with associated comparison results being true of the X CSI associated with the X first CSI report(s). Optionally, the value k of BAI refers to the number of comparisons with associated comparison results being true of the X CSI associated with the X first CSI report(s). Here, the CSI report may refer to the CSI included in the CSI report (or the inference result included in the CSI report). In the disclosure, the term “CSI report” may be used interchangeably with the term “CSI included in CSI report” or “inference result included in CSI report.” For example, the number of CSI reports may be considered as the number of inference results included in the CSI report. For example, the number of CSI reports may be considered as the number of CSI included in the CSI report;
Method #B: Optionally, the value k of BAI means that there are k time instances with corresponding comparison results being true of the time instances (for example, X*F time instances) associated with the X first CSI report(s). Optionally, the value k of BAI refers to the number of time instances with corresponding comparison results being true of the time instances (for example, X*F time instances) associated with the X first CSI report(s). Optionally, k≥0. Optionally, k≤X*F; and/or
Method #C: Optionally, the value k of BAI means that there are k time instance(s) with corresponding comparison results being true of the f-th time instances (for example, X time instances) associated with each CSI report of the X first CSI report(s). Optionally, the value k of BAI refers to the number of time instances with corresponding comparison results being true of the time instances (for example, X*F time instances) associated with the X first CSI report(s). Optionally, k≥0. Optionally, k≤X. Optionally, F BAIs may be included in the second CSI report. Optionally, the f-th BAI of the F BAIs is determined based on comparison associated the f-th time instance. Optionally, the f-th BAI of the F BAIs is determined based on comparison associated with the f-th time instance of each CSI report of the X first CSI report(s).

The method of deciding the comparison result is described below. Optionally, if A and B are the same, the result of the comparison of A and B may be considered true. If A and B are different, the result of the comparison of A and B may be considered false. For example, when the resource associated with at least one of the N1 resource indicators in the CSI associated with the f-th time instance associated with the x-th CSI report of the X first CSI report(s) is the same as/mapped with the resource determined based on measurement of the third resource set, the result of the comparison may be considered true. For example, when the resource associated with at least one of the N1 resource indicators in the CSI associated with the f-th time instance associated with the x-th CSI report of the X first CSI report(s) is different (or is not mapped with) from the resource determined based on measurement of the third resource set, the result of the comparison may be considered false.

In the disclosure, X first CSI report(s) may correspond to X occasion(s) of CSI report. Optionally, the X first CSI report(s) may be the first CSI reports in the X occasion(s) of CSI report. If the CSI report is not transmitted in an occasion of CSI report, the UE may assume that the comparison result corresponding to the CSI report is predefined. For example, the comparison result is true. For example, the comparison result is false. For example, for the computation/determination of BAI, if the CSI report is not transmitted in an occasion of CSI report, the UE may assume the comparison result corresponding to the CSI report to be true. For example, for the computation/determination of BAI, if the CSI report is not transmitted in an occasion of CSI report, the UE may assume the comparison result corresponding to the CSI report to be false. In the disclosure, the X first CSI report(s) may correspond to X occasion(s) of CSI report. Optionally, the X first CSI report(s) may be the first CSI reports in the X occasion(s) of CSI report. If the CSI report is not transmitted in one occasion of CSI report, the UE may assume that the comparison results corresponding to the F time instance(s) associated with the CSI report are predefined. For example, the comparison results are true. For example, the comparison results are false. For example, for computation/determination of BAI, if the CSI report is not transmitted in one occasion of CSI report, the UE may assume that the comparison results corresponding to all time instances associated with the CSI report are true. For example, for computation/determination of BAI, if the CSI report is not transmitted in one occasion of CSI report, the UE may assume that the comparison results corresponding to all time instances associated with the CSI report are false. This method can enable the UE and the base station to have the same understanding of the comparison result corresponding to the possible CSI report when the UE does not transmit a CSI report in the corresponding occasion of CSI report, preventing the base station and the UE from interpreting the corresponding beam accuracy based on the different comparison results corresponding to the CSI report and improving the reliability of the communication system.

When Method #A or Method #C is used, the accuracy rate corresponding to BAI is k/X. Optionally, the accuracy rate may be the accuracy rate of the first CSI report. Optionally, the accuracy rate may be the accuracy rate of the inference result associated with the first CSI report. Optionally, the accuracy rate may be the accuracy rate of the inference/prediction associated with the first CSI reporting configuration. Optionally, the accuracy rate may be the accuracy rate of the report associated with the first CSI reporting configuration. Optionally, the accuracy rate may be the accuracy rate of inference (of the report) associated with the first CSI reporting configuration. Optionally, the accuracy rate may be the accuracy rate of the inference result (of the report) associated with the first CSI reporting configuration.
Optionally, the value k of BAI may mean that there are k CSI reports with corresponding comparison results being true in the X first CSI report(s). Optionally, the value k of BAI may refer to the number of CSI reports with corresponding comparison results being true of the X first CSI report(s). Optionally, the comparison result of the first CSI report being true means that the comparison results of all time instances (for example, F time instance(s)) associated with the first CSI report are true, or the comparison result of at least one time instance associated with the first CSI report is true. Optionally, when Method #C is used, the comparison result of the first CSI report being true means that the comparison result of the f-th time instance associated with the first CSI report is true.
Optionally, the value k of BAI may mean that there are k CSI reports with corresponding comparison results being false in the X first CSI report(s). Optionally, the value k of BAI may refer to the number of CSI reports with corresponding comparison results being false of the X first CSI report(s). In this case, the accuracy rate corresponding to BAI is

$$\frac{X - k}{X} .$$

Optionally, the comparison result of the first CSI report being false means that the comparison results of all time instances (for example, F time instance(s)) associated with the first CSI report are false, or the comparison result of at least one time instance associated with the first CSI report is false.
Optionally, the size of the field of BAI (or the field corresponding to BAI) is ┌log₂ X┐ or ┌log₂ X┐. Optionally, the size of the BAI field (or the field corresponding to BAI) is determined based on X+1. For example, the size of the BAI field (or the field corresponding to BAI) is equal to ┌log₂(X+1)┐, or log₂(X+1), or

$$⌈ {log}_{2} \frac{X + 1}{A} ⌉ , or {log}_{2} \frac{X + 1}{A} .$$

Here, A may be an integer greater than or equal to 1. For example, A may be one of 1, 2, 3, 4, 5, 6, 7 and 8. Optionally, A may be predefined or a may be indicated/configured by the base station. Since the value range of BAI may be 0 to X, that is, there are X+1 values that BAI can indicate, determining the size of BAI field based on X+1 can avoid that some values from 0 to X cannot be indicated, improving the reliability of CSI reporting of the UE and further improving the reliability of the communication system.

When Method #B is used, the accuracy rate corresponding to BAI is

$$\frac{k}{F X} ∘$$

Optionally, the accuracy rate may be the accuracy rate of the CSI associated with the time instance in the first CSI report. Optionally, the accuracy rate may be the accuracy rate of the inference result associated with each time instance associated with the first CSI report. Optionally, the accuracy rate may be the accuracy rate of the inference/prediction associated with the first CSI reporting configuration. Optionally, the accuracy rate may be the accuracy rate of the CSI associated with each time instance in the report associated with the first CSI reporting configuration. Optionally, the accuracy rate may be the accuracy rate of the inference (of the report) associated with the first CSI reporting configuration. Optionally, the accuracy rate may be the accuracy rate of the inference result (of the report) associated with the first CSI reporting configuration.
Optionally, the value k of BAI may mean that there are k time instances with corresponding comparison results being true of the time instances (for example, X*F time instances) associated with the X first CSI report(s). Optionally, the value k of BAI may refer to the number of time instances with corresponding comparison results being true associated with the X first CSI report(s).
Optionally, the value k of BAI may mean that there are k time instances with corresponding comparison results being false of the time instances (for example, X*F time instances) associated with the X first CSI report(s). Optionally, the value k of BAI may refer to the number of time instances with corresponding comparison results being false associated with the X first CSI report(s). In this case, the accuracy rate corresponding to BAI is FX-k

$$\frac{F \cdot X - k}{F \cdot X} .$$

Optionally, the size of the field of the BAI (or the field corresponding to BAI) is ┌log₂(F·X)┐ or log₂(F·X). Optionally, the size of the BAI field (or the field corresponding to BAI) is determined based on F·X+1. For example, the size of the BAI field (or the field corresponding to BAI) is equal to ┌log₂(F X+1)┐, or log₂(F·X+1), or

$$⌈ {log}_{2} \frac{F \cdot X + 1}{A} ⌉ , or {log}_{2} \frac{F \cdot X + 1}{A} .$$

Here, A may be an integer greater than or equal to 1. For example, A may be one of 1, 2, 3, 4, 5, 6, 7 and 8. Optionally, A may be predefined or a may be indicated/configured by the base station. Since the value range of BAI may be 0 to F·X, that is, there are F·X+1 values that BAI can indicate, determining the size of BAI field based on F·X+1 can avoid that some values from 0 to F·X cannot be indicated, improving the reliability of CSI reporting of the UE and further improving the reliability of the communication system

Here, refer above for relevant description of X. The above method allows the UE to obtain the corresponding beam accuracy rate through the number (k) of the time instances with reporting results being true/false, saving the overhead of CSI reporting.

Another method of determining CSI (e.g., BAI) is described below. Optionally, the accuracy rate corresponding to BAI is m/M. Optionally, the accuracy rate corresponding to BAI may be the accuracy rate of inference/prediction. Optionally, the accuracy rate may be the accuracy rate of the first CSI report. Optionally, the accuracy rate may be the accuracy rate of the inference/prediction result associated with the first CSI report. Optionally, the accuracy rate may be the accuracy rate of the inference/prediction associated with the first CSI reporting configuration. Optionally, the accuracy rate may be the accuracy rate of the report associated with the first CSI reporting configuration. Optionally, the accuracy rate may be the accuracy rate of inference/prediction (of the report) associated with the first CSI reporting configuration. Optionally, the accuracy rate may be the accuracy rate of the inference/prediction result (of the report) associated with the first CSI reporting configuration. Optionally, the value of BAI may be m. Optionally, the value m of BAI may mean that there are m comparison results corresponding to measurement associated with the third resource set that are true. Optionally, the value m of BAI may refer to the number of measurements with corresponding comparison results being true of one or more measurements associated with the third resource set. For example, the one or more measurements associated with the third resource set may be M measurements associated with the third resource set. Optionally, M≥1. Optionally, the m measurements associated with the third resource set are from the M measurements associated with the third resource set. Optionally, 0≤m≤M.

Optionally, the value m of BAI may mean that there are m comparison results corresponding to measurement associated with the third resource set that are false. Optionally, the value m of BAI may refer to the number of measurements with corresponding comparison results being false of one or more measurements associated with the third resource set. In this case, the accuracy rate corresponding to BAI is

$$\frac{M - m}{M}$$

or m/M.

Optionally, the size of the BAI field (or the field corresponding to BAI) is ┌log₂ M┐ or log₂ M. Here, ┌·┐ is a round up operation. Optionally, the size of the BAI field (or the field corresponding to BAI) is determined based on M+1. For example, the size of the BAI field (or the field corresponding to BAI) is equal to ┌log₂(M+1)┐, or log₂(M+1), or

$$⌈ {log}_{2} \frac{M + 1}{B} ⌉ , or {log}_{2} \frac{M + 1}{B} .$$

Here, B may be an integer greater than or equal to 1. For example, B may be one of 1, 2, 3, 4, 5, 6, 7 and 8. Optionally, B may be predefined or a may be indicated/configured by the base station. Since the value range of BAI may be 0 to M, that is, there are M+1 values that BAI can indicate, determining the size of BAI field based on M+1 can avoid that some values from 0 to M cannot be indicated, improving the reliability of CSI reporting of the UE and further improving the reliability of the communication system.

Optionally, M refers to the total number of the one or more measurements associated with the third resource set that are compared. Optionally, M refers to the total number of measurements that are compared in one report instance (for example, in the report instance related to the second CSI report). Optionally, M refers to the total number of measurements used to determine BAI in one report instance. Optionally, M (or the value of M) may be indicated by the base station, or predefined, or determined based on the UE capability. For example, the value of M may be one of 1, 2, 3, 4, 5, 6, 7, 8, 12, 16, and 32. For example, M may be indicated by at least one of RRC, MAC-CE, and DCI. For example, M may be indicated by the second CSI reporting configuration.

The above method allows the UE to obtain the value of m, so that the UE may obtain the corresponding beam accuracy rate through the number of measurements (m) with true/false reporting results, thereby saving the overhead of CSI reporting.

Another method of determining CSI (e.g., BAI) is described below. Optionally, the value of BAI is determined by quantification of at least one of the followings:

$$\frac{F \cdot X - k}{F \cdot X} ; \frac{k}{F \cdot X} ; \frac{X - k}{X} ; \frac{k}{X} ; \frac{M - m}{m} ; \frac{m}{M} .$$

Here, refer above for the description of X, k, M and m. Here, the value of BAI is called p. Optionally, p is an integer. Optionally, p≥0. Below is described by taking k/X as an example. The description of k/X also applies to

$$\frac{X - k}{X} or \frac{M - m}{M} or \frac{m}{M} or \frac{F \cdot X - k}{F \cdot X} or \frac{k}{F \cdot X} .$$

Optionally, {δ₀, δ₁, . . . , δ_{M}_{_{q}}} represents M_{q}+1 values. Optionally, the M_{q}+1 values are equally spaced. Optionally, δ₀ is equal to 0. Optionally, δ_{M}_{_{q}} is equal to 1. Optionally, δ_{M}_{_{q}}₋₁<1. Optionally, the value of δ_{M}_{_{q}}₋₁ may be predefined or indicated by the base station. Optionally, the value of δ_{M}_{_{q}}₋₁ may be one of 1, 0.75, 0.5, 0.25, 0.125. Optionally,

$${δ}_{i} = i \times \frac{{δ}_{{M}_{q} - 1}}{{M}_{q} - 1} ,$$

i=0, 1, . . . , M_{q}−1 Optionally,

$${δ}_{i} = i \times \frac{{δ}_{{M}_{q}}}{{M}_{q}} ,$$

i=0, 1, . . . , M_{q}. Optionally, M_{q}=2^{C}, where C represents the number of bits of the CSI field corresponding to BAI. Optionally, [δ_{M}_{_{q}}₋₁,1] represents “out-of-range.” Optionally, the value p of BAI indicates that the value of k/X corresponding to BAI is between δₚ and δₚ₊₁. Between δₚ and δₚ₊₁ means greater than or equal to δₚ and less than or equal to δₚ₊₁. Optionally, p≥0. Optionally, p≤M_{q}−1. Optionally,

$$\frac{{δ}_{{M}_{q}}}{{M}_{q}}$$

corresponds to quantization step size. Optionally, the quantization step size may be predefined or indicated by the base station.
Optionally, {δ₀, δ₁, . . . , δ_{M}_{_{q}}} represents M_{q}+1 values. Optionally, M_{q} values in {δ₀, δ₁, . . . , δ_{M}_{_{q}}₋₁} are equally spaced. Optionally, δ₀ is equal to 0. Optionally, δ_{M}_{_{q}} is equal to 1. Optionally, δ_{M}_{_{q}}₋₁≤1. Optionally, δ_{M}_{_{q}}₋₁<1. Optionally, the value of δ_{M}_{_{q}}₋₁ may be predefined or indicated by the base station. Optionally, the value of δ_{M}_{_{q}}₋₁ may be one of 1, 0.75, 0.5, 0.25, 0.125. Optionally, [δ_{M}_{_{q}}₋₁,δ_{M}_{_{q}}] represents “out-of-range.” Optionally,

$${δ}_{i} = i \times \frac{{δ}_{{M}_{q} - 1}}{{M}_{q} - 1} ,$$

i=0, 1, . . . , M_{q}−1. Optionally, M_{q}=2^{C}, where C represents the number of bits of the CSI field corresponding to BAI. Optionally, the value p of BAI indicates that the value of k/X corresponding to BAI is between δₚ and δₚ₊₁. Between δₚ and δₚ₊₁ means greater than or equal to δₚ and less than or equal to δₚ₊₁. Optionally, p≥0. Optionally, p≤M_{q}−1. Optionally,

$$\frac{{δ}_{{M}_{q} - 1}}{{M}_{q} - 1}$$

may correspond to the quantization step size. Optionally, the quantization step size may be predefined or indicated by the base station.
Optionally, {δ₀, δ₁, . . . , δ_{M}_{_{q}}} represents M_{q}+1 values. Optionally, M_{q} values in {δ₁, δ₂, . . . , δ_{M}_{_{q}}} are equally spaced. Optionally, δ₀ is equal to 0. Optionally, δ_{M}_{_{q}} is equal to 1. Optionally, δ₁≥1. Optionally, δ₁≥1. Optionally, the value of δ₁ may be predefined or indicated by the base station. Optionally, the value of δ₁ may be one of 1, 0.75, 0.5, 0.25, 0.125. Optionally, [δ₀,δ₁] represents “out-of-range.” Optionally,

$${δ}_{i} = {δ}_{1} + ( i - 1 ) \times \frac{{δ}_{{M}_{q}} - {δ}_{1}}{{M}_{q} - 1} ,$$

i=1, . . . , M_{q} Optionally, M_{q}=2^{C}, where C represents the number of bits of the CSI field corresponding to BAI. Optionally, the value p of BAI indicates that the value of k/X corresponding to BAI is between δₚ and δₚ₊₁. Between δₚ and δₚ₊₁ means greater than or equal to δₚ and less than or equal to δₚ₊₁. Optionally, p≥0. Optionally, p≤M_{q}−1. Optionally,

$$\frac{{δ}_{{M}_{q}} - {δ}_{1}}{{M}_{q} - 1}$$

may correspond to the quantization step size. Optionally, the quantization step size may be predefined or indicated by the base station.
Optionally, the value of C may be at least one of 1, 2, 3, 4, 5, 6, 7. Optionally, the value of C may be predefined. Optionally, the value of C may be indicated by the base station. Optionally, the value of C may be determined based on the UE capability.

Another method of determining CSI (e.g., BAI) is described below.

Optionally, the BAI may include X bits. For example, BAI includes a bit sequence: b1, b2, . . . , bX. Optionally, b1 may be the Least Significant Bit (LSB), and bX may be the Most Significant Bit (MSB). Optionally, bx corresponds to the comparison result the x-th first CSI report. Optionally, 1≤x≤X. For example, a first value (e.g., 1) of bx indicates that the comparison result of the x-th first CSI report (of the X first CSI report(s)) is true. For example, a second value (e.g., 0) of bx indicates that the comparison result of the x-th first CSI report (of the X first CSI report(s)) is false. Refer above for the comparison method associated with the first CSI report.

The above method allows the UE to indicate the comparison result of each of the X first CSI report(s), so that the base station can perform model management accordingly, improving the performance of the communication system.

Optionally, the BAI may include F*X bits. For example, BAI includes a bit sequence: b1, b2, . . . , bF*X. Optionally, b1 may be the Least Significant Bit (LSB), and bF*X may be the Most Significant Bit (MSB). Optionally, bm corresponds to the comparison result of a time instance associated with a first CSI report. Optionally, 1≤m≤F*X. For example, a first value (e.g., 1) of bm indicates that the comparison result of the corresponding time instance (in the X first CSI report(s)) is true. For example, a second value (e.g., 0) of bm indicates that the comparison result of the corresponding time instance is false. Here, the corresponding relation between m and the time instance associated with the first CSI report may be determined in the followings.
Optionally, m=F*(x−1)+f. For example, the f-th time instance associated with the x-th first CSI report of the X first CSI report(s) corresponds to bm, where m=F*(x−1)+f.
Optionally, bm corresponds to the

$$( m - ( ⌈ \frac{m}{F} ⌉ - 1 ) * F ) - th$$

time instance associated with the

$$( ⌈ \frac{m}{F} ⌉ ) - th$$

first CSI report of the X first CSI report(s).

The above method allows the UE to indicate the comparison result of each time instance associated with each first CSI report of the X first CSI report(s), so that the base station can perform model management accordingly, improving the performance of the communication system.

Optionally, the CSI report associated with/corresponding to the second CSI reporting configuration may include V BAIs. Optionally, V≥1. Optionally, V≤F. Optionally, each of the V BAIs corresponds to/is associated with a time instance. For example, V BAIs are one-to-one corresponding to V time instances. For example, the V time instances may come from the F time instance(s). For example, the V time instances may be a subset of the F time instance(s). Optionally, a BAI corresponding to a time instance means that the BAI is determined based on comparison associated with the time instance in the CSI report (for example, the CSI report corresponding to the first CSI reporting configuration). For example, a BAI is associated with the f-th time instance of the F time instance(s), and the BAI is determined based on the CSI associated with the f-th time instance in the CSI report.

Optionally, the V time instances may be predefined. For example, the V time instances are the first time instance of the F time instance(s). For example, the V time instances are the last time instance of the F time instance(s). For example, the V time instances refer to the F time instance(s).

Optionally, the V time instances may be indicated by the base station. For example, the second CSI reporting configuration includes a parameter, wherein the parameter indicates the V time instances. For example, the V time instances are the first V time instances of the F time instance(s). Optionally, the value of V may be indicated by the base station. For example, the second CSI reporting configuration includes a parameter, wherein the parameter indicates the value of V For example, the V time instances are indicated by a bitmap. The bitmap includes F bits, wherein the f-th bit corresponds to the f-th time instance of the F time instance(s). When a bit in the bitmap is a first value (for example, 1), the corresponding time instance is indicated. When a bit in the bitmap is a second value (for example, 0), the corresponding time instance is not indicated.

Optionally, the mapping order of V CSI fields corresponding to the V BAIs may be determined based on the time domain order (e.g., time domain sequence) of the V time instances corresponding to the V BAIs. Optionally, the mapping order of the V CSI fields may be the order of the V CSI fields in UCI. Optionally, the mapping order of the V CSI fields may be the order of the V CSI fields in the CSI report. Optionally, the mapping order of the V CSI fields may be the order of the information bits corresponding to the V CSI fields in the information bits carried by the CSI report. For example, the V BAIs correspond to BAI #1, BAI #2, . . . , BAI #V In the CSI report, the V BAIs are arranged from BAI #1 to BAI #V Optionally, BAI #1, BAI #2, . . . , BAI #V correspond to time instance #1, time instance #2, . . . , time instance #V of the V time instances. Optionally, time instance #v is the v-th time instance of the V time instances. Optionally, the time instance #v is the v-th earliest time instance of the V time instances. Optionally, time instance #v is the v-th latest time instance of the V time instances. Optionally, v≤V Optionally, v≥1. The above method defines the order of the CSI fields corresponding to the V BAIs in the CSI report, preventing the UE from mapping the CSI fields corresponding to the V BAIs in the CSI report in a wrong way and improving the reliability of the communication system.

The resource corresponding to the resource indicator is the resource in the first resource set, and the resource determined by measurement of all resources in the third resource set is the resource in the third resource set. In order to facilitate the comparison between the resource corresponding to the resource indicator and the resource in the third resource set (to decide the comparison result), it is necessary to provide the mapping relation between the resources in the first resource set and the resources of the third resource set, define the method for determining comparison operation of CSI to ensure the reliability of the communication system. Refer above for the method of determining the resource associated with the resource indicator. If the resource indicator corresponds to the resource in the second resource set, the description of the “first resource set” may be replaced with the description of the “second resource set” in the method for determining the resource associated with the resource indicator.

The method of determining the X first CSI report(s) is discussed below. The following method enables the base station to correctly interpret that the CSI in the second CSI report is used to monitor which first CSI reports, so that the base station adjusts based on the reported monitoring results for the UE side model, improving the reliability of the communication system.

Optionally, the X first CSI report(s) may be X CSI reports no later than the second CSI report. Optionally, the X first CSI report(s) being the X CSI reports no later than the second CSI report means that the time domain unit where the X first CSI report(s) are located is no later than the time domain unit where the second CSI report is located. Optionally, the X first CSI report(s) may be the X CSI reports earlier than the second CSI report. Optionally, the X first CSI report(s) being the X CSI reports earlier than the second CSI report means that the time domain unit where the X first CSI report(s) are located is earlier than the time domain unit where the second CSI report is located. Optionally, the X first CSI report(s) may be the X CSI reports closest to the second CSI report. Optionally, the X first CSI report(s) may be the latest X CSI reports before the second CSI report. Optionally, the X first CSI report(s) may be the latest X CSI reports no later than the second CSI report. Optionally, the X first CSI report(s) may be the closest X CSI reports before the second CSI report (the X first CSI report(s) closest to the second CSI report, or to the time domain unit where the second CSI report is located). Optionally, the X first CSI report(s) may be the latest X CSI reports no later than the second CSI report (the X CSI reports closest to the second CSI report, or to the time domain unit where the second CSI report is located). Optionally, the X first CSI report(s) may be the X CSI reports closest to the time domain unit where the second CSI report is located.

Optionally, at least one time instance associated with each of the X first CSI report(s) is no later than the second CSI report. Optionally, all time instances (for example, F time instance(s)) associated with each of the X first CSI report(s) are no later than the second CSI report. Optionally, all time instances (e.g., F*X time instances) associated with the X first CSI report(s) are no later than the second CSI report. In the disclosure, the term “no later than” may be used interchangeably with the term “earlier than” or “before.” Optionally, no later than the second CSI report may be no later than the time domain unit associated with the second CSI report. Optionally, the time domain unit associated with the second CSI report may be the time domain unit where (the transmission of) the second CSI report is located. Optionally, the time domain unit associated with the second CSI report may be the first time domain unit (or the starting time domain unit) or the last time domain unit (or the ending time domain unit) carrying the resource of the second CSI report. Optionally, the X first CSI report(s) are the latest X first CSI report(s) with (all) associated time instances being no later than the second CSI report. Optionally, the X first CSI report(s) are the X first CSI report(s) with associated time instances being no later than the second CSI report and are closest to the second CSI report (or to the time domain unit associated with the second CSI report).

Optionally, when the second CSI report is aperiodic CSI report, the second CSI report may be triggered/scheduled/indicated by DCI. Optionally, when the first condition is met, the X first CSI report(s) refer to the X first CSI report(s) with associated time instances being no later than the DCI, or the X first CSI report(s) with at least one of the associated time instances being no later than the DCI. Optionally, when the first condition is met, the X first CSI report(s) refer to the latest X first CSI report(s) with associated time instances being no later than the DCI, or the latest X first CSI report(s) with at least one of the associated time instances being no later than the DCI. Here, no later than the DCI refers to no later than the time domain unit associated with the DCI. Optionally, the time domain unit associated with the DCI may be the time domain unit where (the reception of) the DCI is located. Optionally, the time domain unit associated with DCI may be the first time domain unit (or the starting time domain unit) or the last time domain unit (or the ending time domain unit) of the resource carrying the DCI. Optionally, the latest X first CSI report(s) may be the X first CSI report(s) closest to the DCI. Optionally, the latest X first CSI report(s) may be the X first CSI report(s) closest to the time domain unit associated with the DCI. Optionally, refer above for description of the first condition.

Optionally, when the second condition is met, the X first CSI report(s) refer to the X first CSI report(s) no later than the second CSI report. Optionally, when the second condition is met, the X first CSI report(s) refer to the latest X first CSI report(s) no later than the second CSI report. Optionally, the latest X first CSI report(s) refer to the X first CSI report(s) closest to the second CSI report, or the X first CSI report(s) closest to the time domain unit associated with the second CSI report. Optionally, refer above for description of the second condition.

Optionally, the X first CSI report(s) refer to the X first CSI report(s) within a window. Optionally, the X first CSI report(s) refer to the X first CSI report(s) associated with a window. Optionally, at least one time instance associated with each of the X first CSI report(s) is in the window. Optionally, each time instance (e.g., each of the F time instance(s)) associated with each of the X first CSI report(s) is in the window. Optionally, the time domain position of a window may be determined by the length of the window and/or the starting point (e.g., starting time domain resource) and/or ending point (e.g., ending time domain resource) of the window.

Optionally, the length of the window may be indicated by the base station, or the length of the window may be predefined. For example, the base station may indicate the number of time domain units associated with/corresponding to the length of the window via at least one of RRC signaling, MAC-CE, and DCI. Optionally, the length of the window may be determined based on the CSI report periodicity associated with the first CSI reporting configuration and/or the periodicity associated with the third resource set. Optionally, when the first CSI report is periodic CSI report, and/or the resources included in the third resource set are SSBs or semi-persistent/periodic CSI-RSs, the length of the window is determined based on the CSI report periodicity associated with the first CSI reporting configuration and/or the periodicity associated with the third resource set. Optionally, the length of the window is determined based on the longer/shorter periodicity of the CSI report periodicity associated with the first CSI reporting configuration and the periodicity associated with the third resource set. Optionally, the length of the window is determined based on the maximum/minimum value of the CSI report periodicity associated with the first CSI reporting configuration and the periodicity associated with the third resource set.

Optionally, the starting time domain resource/ending time domain resource of the window is determined based on at least one of the followings:
The indication of the base station, for example, the indication of the second CSI reporting configuration;
The time domain resource where the second CSI report is located, or the time domain resource where the CSI reference resource corresponding to the second CSI report is located;
The length of the window. Refer above for the determination method of the length of the window;
The CSI report periodicity associated with the first CSI reporting configuration; and/or
The periodicity associated with the third resource set.

Optionally, the starting time domain resource/ending time domain resource of the window is determined based on the time domain resource where the second CSI report is located and/or the indication of the base station. For example, the distance between the starting time domain resource/ending time domain resource of the window and the time domain resource where the second CSI report is located is predefined or indicated by the base station. For example, the distance between the starting time domain resource/ending time domain resource of the window and the time domain resource (for example, the first time domain resource, or the last time domain resource) of the channel carrying the second CSI report is predefined or indicated by the base station. For example, the time domain resource offset between the starting time domain resource/ending time domain resource of the window and the time domain resource where the second CSI report is located is Y, where Y may be predefined or indicated by the base station. For example, the value of Y may be one of 1, 2, 3, 4, 5, 6, 7, 8, 12, 16, and 32. For example, Y may be indicated by at least one of RRC, MAC-CE, and DCI. For example, when the time domain resource where the second CSI report is located is slot n, the time domain resource where the starting time domain resource/ending time domain resource of the window is located is slot n−Y or n+Y.

Optionally, the starting time domain resource/ending time domain resource of the window is determined based on the time domain resource where the CSI reference resource corresponding to the second CSI report is located and/or the indication of the base station. For example, the distance between the starting time domain resource/ending time domain resource of the window and the time domain resource where the CSI reference resource corresponding to the second CSI report is located is predefined or indicated by the base station. For example, the distance between the starting time domain resource/ending time domain resource of the window and the time domain resource (for example, the first time domain resource, or the last time domain resource) of the CSI reference resource corresponding to the second CSI report is predefined or indicated by the base station. For example, the time domain resource offset between the starting time domain resource/ending time domain resource of the window and the time domain resource where the CSI reference resource corresponding to the second CSI report is located is Z, where Z may be predefined or indicated by the base station. For example, the value of Z may be one of 1, 2, 3, 4, 5, 6, 7, 8, 12, 16, and 32. For example, Z may be indicated by at least one of RRC, MAC-CE, and DCI. For example, when the time domain resource where the CSI reference resource corresponding to the second CSI report is located is slot n, the time domain resource where the starting time domain resource/ending time domain resource of the window associated with the second CSI report is located is slot n−Z or n+Z. Optionally, the starting time domain resource/ending time domain resource of the window is determined based on the time domain resource where the second CSI report is located and/or the CSI report periodicity associated with the first CSI reporting configuration and/or the periodicity associated with the third resource set. The CSI report periodicity associated with the first CSI reporting configuration and/or the periodicity associated with the third resource set may be the maximum/minimum value of the CSI report periodicity associated with the first CSI reporting configuration and the periodicity associated with the third resource set. Optionally, the index of the slot where the starting time domain resource/ending time domain resource of the window is located is n*P, where P is determined based on the CSI report periodicity associated with the first CSI reporting configuration and/or the periodicity associated with the third resource set. For example, P is the number of slots corresponding to the CSI report periodicity associated with the first CSI reporting configuration. Here, n is an integer. The index of the slot associated with the starting time domain resource/ending time domain resource of the window is n*P, where n is n that minimizes the offset between the slot corresponding to n*P and the slot where the second CSI report is located.

Optionally, the N1 resources associated with one (or each) time instance associated with the first CSI report (for example, the resources corresponding to the N resource indicators) are mapped with the resource in the third resource set. Optionally, the N1 resources associated with one (or each) time instance associated with one (or each) first CSI report of the X CSI reports are mapped with the resource in the third resource set. Optionally, the X CSI reports meet the following condition: the N1 resources associated with one (or each) time instance associated with at least one (or each) first CSI report of the X CSI reports are mapped with the resource in the third resource set. Optionally, N1 resources associated with one time instance associated with the first CSI report being mapped with the resource in the third resource set means that at least one resource of the N1 resources associated with one time instance associated with the first CSI report (for example, the resources corresponding to the N1 resource indicators) is mapped with the resource in the third resource set. Optionally, the N1 resources associated with one time instance associated with the first CSI report being mapped with the third resource set means that each of the N1 resources associated with one time instance associated with the first CSI report (for example, each of the resources corresponding to the N1 resource indicators) is mapped with the resource in the third resource set. Refer other part of description in the disclosure for the mapping method of the resources.

Optionally, if one (or each) first CSI report of the X CSI reports is not mapped with the resource in the third resource set, the second CSI report is not transmitted (or the second CSI report is dropped). Optionally, the first CSI report being not mapped with the resource in the third resource set means that at least one of the N1 resources associated with each time instance associated with the first CSI report (for example, at least one of the resources corresponding to the N1 resource indicators) is not mapped with the resource in the third resource set. Optionally, the first CSI report being not mapped with the resource in the third resource set means that each of the N1 resources associated with each time instance associated with the first CSI report (for example, each of the resources corresponding to the N1 resource indicators) is not mapped with the resources in the third resource set. This method allows the UE to avoid reporting when the predicted beams associated with the X CSI reports are not mapped to the resource in the resource set for monitoring since the comparison result is already known by the base station, saving energy consumption of the UE and improving the efficiency of the communication system.

The determination method of the measurement of the third resource set is discussed below. The following method may enable the UE to use the measurement result of the monitoring set closer in time domain to the time instance associated with the report for the first CSI report for comparison, in order to improve the timeliness/accuracy of performance monitoring.

Optionally, the measurement of the third resource set may refer to the measurement result of the third resource set. Optionally, the measurement of the third resource set may refer to the measurement of the transmission occasion of the resource in the third resource set, and/or the measurement of the resource in the third resource set, and/or the measurement of all resources in the third resource set. Optionally, the resource associated with the resource indicator included in the CSI associated with each time instance in each of the X first CSI report(s) may be compared with the resource determined based on measurement of the third resource set. Here, the measurement occasion (or transmission occasion) for comparing corresponding time instance may be referred to as the transmission occasion associated with the time instance. Optionally, the transmission occasion associated with the f-th time instance associated with the x-th CSI report of the X first CSI report(s) may be at least one of the followings:
The transmission occasion of the resource in the third resource set no later than (or earlier than) the second CSI report. For example, the latest transmission occasion of the resource in the third resource set no later than (or earlier than) the second CSI report. For example, the x-th latest transmission occasion of the resource in the third resource set no later than (or earlier than) the second CSI report;
The transmission occasion of the resource in the third resource set no later than (or earlier than) the CSI reference resource corresponding to the second CSI report; for example, the latest transmission occasion of the resource in the third resource set no later than (or earlier than) the CSI reference resource corresponding to the second CSI report. For example, the x-th latest transmission occasion of the resource in the third resource set no later (or earlier) than the CSI reference resource corresponding to the second CSI report; and/or
The closest transmission occasion of the resource in the third resource set. For example, the transmission occasion of the resource in the third resource set with minimal distance to the f-th time instance associated with the x-th CSI report. Optionally, the distance between the f-th time instance associated with the x-th CSI report and the transmission occasion of the resource may be the distance between the time domain unit associated with the f-th time instance and the time domain resource where the transmission occasion of the resource is located. Here, the distance may be the offset of the time domain resource(s). Optionally, if two transmission occasions are equally distant from the f-th time instance, the later transmission occasion is used for comparison. Optionally, if two transmission occasions are equally distant from the f-th time instance, the earlier transmission occasion is used for comparison. Here, the unit of time domain resource may be slot or symbol.

Optionally, the measurement of the third resource set may refer to the measurement of the third resource set in a window associated with the time instance. Optionally, the measurement of the third resource set may refer to measurement of the transmission occasion of the resource in the third resource set, and/or measurement of the resource in the third resource set. Optionally, each time instance associated with each of the X first CSI report(s) may be compared based on measurement of the third resource set in the window. The time domain position of a window associated with the time instance may be determined by the length of the window and the starting point (e.g., starting time domain resource) and/or ending point (e.g., ending time domain resource) of the window. The determination method for the window associated with the time instance is described below.

Optionally, the length of the window associated with the f-th time instance associated with the x-th (1≤x≤X) CSI report of the X first CSI report(s) is indicated by the base station. For example, the base station indicates the number of time domain units associated with/corresponding to the length of the window via at least one of RRC signaling, MAC-CE, and DCI. Optionally, the length of the window associated with the x-th (1≤x≤X) CSI report of the X first CSI report(s) is determined based on the CSI report periodicity associated with the first CSI reporting configuration and/or the periodicity associated with the third resource set and/or F_offset. Refer above for related description of F_offset. Optionally, when the first CSI report is periodic CSI report, and/or the resources included in the third resource set are SSBs or semi-persistent/periodic CSI-RSs, and/or F≥1, the length of the window associated with the x-th (1≤x≤X) CSI report of the X first CSI report(s) is determined based on the CSI report periodicity associated with the first CSI reporting configuration and/or the periodicity associated with the third resource set and/or F_offset. Optionally, the length of the window associated with the f-th time instance associated with the x-th (1≤x≤X) CSI report of the X first CSI report(s) is determined based on the longer/shorter length of the CSI report periodicity associated with the first CSI reporting configuration and/or the periodicity associated with the third resource set and/or F_offset. Optionally, the length of the window associated with the x-th (1≤x≤X) CSI report of the X first CSI report(s) is determined based on the maximum/minimum value of the CSI report periodicity associated with the first CSI reporting configuration and/or the periodicity associated with the third resource set and/or F_offset. For example, the length of the window associated with the x-th (1≤x≤X) CSI report of the X first CSI report(s) is a*P. Optionally, P may correspond to the periodicity associated with the third resource set, or the CSI report periodicity associated with the first CSI reporting configuration, or F_offset, or the maximum/minimum value of the periodicity associated with the third resource set and/or the CSI report periodicity associated with the first CSI reporting configuration and/or F_offset. Here, a may be a scaling factor. The value of a may be one of 1, 2, 3, 4, 5, 6, 7, 8, 12, 16, and 32. Optionally, a may be predefined. Optionally, a may be indicated by the base station. For example, a may be indicated by at least one of RRC signaling, MAC-CE, and DCI. Here, refer above for description of the CSI report periodicity associated with the CSI reporting configuration and the periodicity associated with the third resource set.

Optionally, the starting time domain resource/ending time domain resource of the window associated with the f-th time instance associated with the x-th (1≤x≤X) CSI report of the X first CSI report(s) is determined based on at least one of the followings:
The indication of the base station, for example, the indication of the second CSI reporting configuration;
The f-th time instance;
The length of the window. Refer above for the determination method of the length of the window;
The CSI report periodicity associated with the first CSI reporting configuration; and/or
The periodicity associated with the third resource set.

Optionally, the starting time domain resource/ending time domain resource of the window associated with the f-th time instance associated with the x-th (1≤x≤X) CSI report of the X first CSI report(s) is determined based on the f-th time instance and/or the indication of the base station. For example, the distance between the starting time domain resource/ending time domain resource of the window associated with the f-th time instance and the f-th time instance (or the time domain unit associated with the f-th time instance) is predefined or indicated by the base station. For example, the time domain unit offset between the starting time domain resource/ending time domain resource of the window associated with the x-th CSI report and the time domain unit associated with the f-th time instance is Y, where Y may be predefined or indicated by the base station. For example, the value of Y may be one of 1, 2, 3, 4, 5, 6, 7, 8, 12, 16, and 32. For example, Y may be indicated by at least one of RRC, MAC-CE, and DCI. For example, the time domain resource where the starting time domain resource/ending time domain resource of the window associated with the f-th time instance is located is slot n−Y or n+Y, where n refers to the index of the time domain unit associated with the f-th time instance.

Optionally, the starting time domain resource/ending time domain resource of the window associated with the f-th time instance associated with the x-th (1≤x≤X) CSI report of the X first CSI report(s) is determined based on the f-th time instance (or the time domain unit associated with the f-th time instance) and/or the CSI report periodicity associated with the first CSI reporting configuration and/or the periodicity associated with the third resource set. The CSI report periodicity associated with the first CSI reporting configuration and/or the periodicity associated with the third resource set may be the maximum/minimum value of the CSI report periodicity associated with the first CSI reporting configuration and the periodicity associated with the third resource set. Optionally, the index of the slot where the starting time domain resource/ending time domain resource of the window associated with the x-th CSI report is located is n*P, where P is determined based on the CSI report periodicity associated with the first CSI reporting configuration and/or the periodicity associated with the third resource set. For example, P is the number of slots corresponding to the CSI report periodicity associated with the first CSI reporting configuration. Here, n is an integer. The index of the slot associated with the starting time domain resource/ending time domain resource of the window associated with the f-th time instance is n*P, where n is n that minimizes the offset between the slot corresponding to n*P and the slot where the f-th time instance is located. Optionally, if there is more than one n such that the offset between the slot corresponding to n*P and the slot where the f-th time instance is located is minimized, the window corresponding to the smaller/larger value of n is used for comparison.

The determination method of M measurements associated with the third resource set is discussed below. The following method can enable the base station to correctly interpret the CSI in the second CSI report corresponds to which measurements of the third resource set, so that the base station adjusts based on the reported monitoring results for the UE side model, improving the reliability of the communication system. Additionally, the M measurements associated with the third resource set may be used to determine the BAI, refer above for description.

Optionally, the measurement of the third resource set may refer to the measurement result of the third resource set. Optionally, the measurement of the third resource set may refer to the measurement of the transmission occasion of the resource in the third resource set, and/or the measurement of the resource in the third resource set, and/or the measurement of all resources in the third resource set. Here, the transmission occasion may be considered the measurement occasion. In the disclosure, the term “occasion of resource” may be used interchangeably with the term “transmission occasion of resource” or “measurement of resource” or “measurement occasion of resource.”

Optionally, the M measurements associated with the third resource set refer to the M latest measurements associated with the third resource set. Optionally, the M measurements associated with the third resource set refer to the latest M measurements associated with the third resource set. Optionally, the M measurements associated with the third resource set refer to the latest M measurements associated with the third resource set no later than the CSI reference resource corresponding to the second CSI report. Optionally, the M measurements associated with the third resource set refer to the latest M measurements associated with the third resource set no later than the second CSI report. Optionally, M may be equal to X. For example, M=X.

Optionally, the M measurements associated with the third resource set refer to M measurements associated with the third resource set in a window.

Optionally, the M measurements associated with the third resource set refer to measurements associated with the third resource set in M windows. Optionally, the M windows are no later than the second CSI report. Optionally, optionally, the M windows are no later than the CSI reference resource corresponding to the second CSI report. Optionally, the latest window of the M windows is no later than the second CSI report. Optionally, the latest window of the M windows is no later than the CSI reference resource corresponding to the second CSI report. Optionally, at least one of the M windows includes the first CSI report. Optionally, each of the M windows includes the first CSI report. Optionally, the M windows meet the following condition: at least one (or each) window of the M windows includes the first CSI report. A window including the first CSI report means that a window includes the time domain resource for carrying the first CSI report. Optionally, M may be equal to X. For example, M=X.

Optionally, the length of the window may be indicated by the base station, or the length of the window may be predefined. Optionally, the window may be a window related to M measurements associated with third resource set. Optionally, the window may be one window (or each window) of the M windows. For example, the base station may indicate the number of time domain units associated with/corresponding to the length of the window via at least one of RRC signaling, MAC-CE, and DCI. Optionally, the length of the window may be determined based on the CSI report periodicity associated with the first CSI reporting configuration and/or the periodicity associated with the third resource set. Optionally, when the first CSI report is periodic CSI report, and/or the resources included in the third resource set are SSBs or semi-persistent/periodic CSI-RSs, the length of the window is determined based on the CSI report periodicity associated with the first CSI reporting configuration and/or the periodicity associated with the third resource set. Optionally, the length of the window is determined based on the longer/shorter periodicity of the CSI report periodicity associated with the first CSI reporting configuration and the periodicity associated with the third resource set. Optionally, the length of the window is determined based on the maximum/minimum value of the CSI report periodicity associated with the first CSI reporting configuration and the periodicity associated with the third resource set.

Optionally, the distance between adjacent windows of the M windows may be indicated by the base station, or the length of the window may be predefined. Optionally, the distance between adjacent windows of the M windows may be the distance between time domain units (for example, the first time domain unit, or the last time domain unit) of the adjacent windows. For example, the base station may indicate the number of time domain units associated with/corresponding to the distance between adjacent windows via at least one of RRC signaling, MAC-CE, and DCI. Optionally, the length of the distance may be determined based on the CSI report periodicity associated with the first CSI reporting configuration and/or the periodicity associated with the third resource set. Optionally, when the first CSI report is periodic CSI report, and/or the resources included in the third resource set are SSBs or semi-persistent/periodic CSI-RSs, the length of the distance is determined based on the CSI report periodicity associated with the first CSI reporting configuration and/or the periodicity associated with the third resource set. Optionally, the length of the distance is determined based on the longer/shorter periodicity of the CSI report periodicity associated with the first CSI reporting configuration and the periodicity associated with the third resource set. Optionally, the length of the distance is determined based on the maximum/minimum value of the CSI report periodicity associated with the first CSI reporting configuration and the periodicity associated with the third resource set. Optionally, the distance between adjacent windows may be equal to the length of the windows.

Optionally, the starting time domain resource/ending time domain resource of the window (for example, the last window of the M windows, or the first window of the M windows, or a window related to M measurements associated with the third resource set) is determined based on at least one of the followings:
The indication of the base station, for example, the indication of the second CSI reporting configuration;
The time domain resource where the second CSI report is located, or the time domain resource where the CSI reference resource corresponding to the second CSI report is located;
The length of the window. Refer above for the determination method of the length of the window;
The CSI report periodicity associated with the first CSI reporting configuration; and/or
The periodicity associated with the third resource set.

Optionally, the starting time domain resource/ending time domain resource of the window is determined based on the time domain resource where the second CSI report is located and/or the indication of the base station. For example, the distance between the starting time domain resource/ending time domain resource of the window and the time domain resource where the second CSI report is located is predefined or indicated by the base station. For example, the distance between the starting time domain resource/ending time domain resource of the window and the time domain resource (for example, the first time domain resource, or the last time domain resource) of the channel carrying the second CSI report is predefined or indicated by the base station. For example, the time domain resource offset between the starting time domain resource/ending time domain resource of the window and the time domain resource where the second CSI report is located is Y, where Y may be predefined or indicated by the base station. For example, the value of Y may be one of 1, 2, 3, 4, 5, 6, 7, 8, 12, 16, and 32. For example, Y may be indicated by at least one of RRC, MAC-CE, and DCI. For example, when the time domain resource where the second CSI report is located is slot n, the time domain resource where the starting time domain resource/ending time domain resource of the window is located is slot n−Y or n+Y.

Optionally, the starting time domain resource/ending time domain resource of the window is determined based on the time domain resource where the CSI reference resource corresponding to the second CSI report is located and/or the indication of the base station. For example, the distance between the starting time domain resource/ending time domain resource of the window and the time domain resource where the CSI reference resource corresponding to the second CSI report is located is predefined or indicated by the base station. For example, the distance between the starting time domain resource/ending time domain resource of the window and the time domain resource (for example, the first time domain resource, or the last time domain resource) of the CSI reference resource corresponding to the second CSI report is predefined or indicated by the base station. For example, the time domain resource offset between the starting time domain resource/ending time domain resource of the window and the time domain resource where the CSI reference resource corresponding to the second CSI report is located is Z, where Z may be predefined or indicated by the base station. For example, the value of Z may be one of 1, 2, 3, 4, 5, 6, 7, 8, 12, 16, and 32. For example, Z may be indicated by at least one of RRC, MAC-CE, and DCI. For example, when the time domain resource where the CSI reference resource corresponding to the second CSI report is located is slot n, the time domain resource where the starting time domain resource/ending time domain resource of the window is located is slot n−Z or n+Z. Optionally, the starting time domain resource/ending time domain resource of the window is determined based on the time domain resource where the second CSI report is located and/or the CSI report periodicity associated with the first CSI reporting configuration and/or the periodicity associated with the third resource set. The CSI report periodicity associated with the first CSI reporting configuration and/or the periodicity associated with the third resource set may be the maximum/minimum value of the CSI report periodicity associated with the first CSI reporting configuration and the periodicity associated with the third resource set.

Optionally, the CSI (e.g., BAI) in the second CSI report may be determined based on comparison of each of the M measurements associated with the third resource set with the CSI associated with the time instance in the first CSI report. Optionally, the CSI (e.g., BAI) in the second CSI report may be determined based on comparison of each of the M measurements associated with the third resource set with the resource associated with the resource indicator associated with the time instance included in the first CSI report. Optionally, the CSI (e.g., BAI) in the second CSI report may be determined based on comparison of the m1-th measurement of the M measurements associated with the third resource set associated with the resource associated with the resource indicator associated with the time instance included in the (corresponding) first CSI report. Optionally, m1 may be any integer ranged from 1 to M. Optionally, one of the M measurements associated with the third resource set may be compared with the CSI associated with the time instance in the first CSI report associated with/corresponding to the measurement. Optionally, one of the M measurements associated with the third resource set may be compared with the resource associated with the resource indicator associated with the time instance included in the first CSI report associated with/corresponding to the measurement. Refer above for the method of comparing the measurement associated with the third resource set with the resource associated with the resource indicator included in the CSI report. Optionally, the CSI associated with the time instance in the first CSI report may be the N1 resource indicators associated with the time instance included in the first CSI report. Optionally, the CSI associated with the time instance in the first CSI report may be the resources associated with the N1 resource indicators associated with the time instance included in the first CSI report.

The method of determining the CSI associated with the time instance in the first CSI report for comparison corresponding to the M measurements associated with the third resource set is discussed below. Optionally, the m1-th measurement of the M measurements associated with the third resource set may be compared with the CSI associated with the time instance in the first CSI report corresponding to/associated with the m1-th measurement. Optionally, 1≤m1≤M.

Optionally, the CSI associated with the time instance in the first CSI report corresponding to the m1-th measurement of the M measurements associated with the third resource set may be determined based on at least one of the followings:
Optionally, the CSI associated with the time instance in the first CSI report corresponding to the m1-th measurement may be determined based on the time domain resource of the transmission occasion associated with the m1-th measurement and the time domain resource of the first CSI report carrying the CSI. Optionally, the CSI in the first CSI report corresponding to the m1-th measurement of the M measurements is the CSI carried by the closest/farthest first CSI report from the time domain resource associated with the m1-th measurement. Optionally, the first CSI report is no later/no earlier than the time domain resources associated with the m1-th measurement. Optionally, the closest/farthest first CSI report refers to the closest/farthest first CSI report from the corresponding uplink channel. Optionally, if there are two first CSI reports with the same distance from the time domain resource associated with the measurement, the earlier/later (or prior/posterior) first CSI report is associated with the m1-th measurement;
Optionally, the CSI associated with the time instance in the first CSI report corresponding to the m1-th measurement may be determined based on the time domain resource of the transmission occasion associated with the m1-th measurement and the time domain resource of the first CSI report carrying the CSI. Optionally, the CSI in the first CSI report corresponding to the m1-th measurement of the M measurements is the CSI carried by the closest/farthest first CSI report from the time domain resource associated with the m1-th measurement. Optionally, the CSI reference resource corresponding to the first CSI report is no later/earlier than the time domain resource associated with the m1-th measurement. Optionally, if there are two CSI reference resources corresponding to the first CSI reports with the same distance from the time domain resources associated with the measurement, the first CSI report with the earlier/later (or prior/posterior) CSI reference resource is associated with the m1-th measurement; and/or
Optionally, the CSI associated with the time instance in the first CSI report corresponding to the m1-th measurement may be determined based on the time domain resource of the transmission occasion associated with the m1-th measurement and the time domain resource associated with the time instance. Optionally, the CSI associated with the time instance in the first CSI report corresponding to the m1-th measurement of the M measurements is the CSI in the first CSI report with the time domain resource associated with the time instance being closest to/farthest from the time domain resource associated with the m1-th measurement. Optionally, the CSI associated with the time instance in the first CSI report corresponding to the m1-th measurement of the M measurements is the CSI in the first CSI report with the time domain resource associated with the time instance overlapping with the time domain resource associated with the m1-th measurement. Optionally, the CSI associated with the time instance in the first CSI report corresponding to the m1-th measurement of the M measurements is the CSI in the first CSI report with the time domain resource associated with the time instance including the time domain resource associated with the m1-th measurement. Optionally, the time instance associated with the m1-th measurement is no later/earlier than the time domain resource associated with the m1-th measurement. Optionally, if the time domain resources associated with two time instances are equally distant from the time domain resource associated with the measurement, the earlier/later (or prior/posterior) time instance is associated with the m1-th measurement.

Optionally, the CSI associated with the time instance in the first CSI report corresponding to the m1-th measurement of the M measurements associated with the third resource set may be the CSI in the first CSI report in the window associated with the m1-th measurement. Optionally, the CSI associated with the time instance in the first CSI report corresponding to the m1-th measurement of the M measurements associated with the third resource set may be the CSI of an associated time instance in the window associated with the m1-th measurement. Optionally, the CSI associated with the time instance in the first CSI report corresponding to the m1-th measurement of the M measurements associated with the third resource set may be the CSI with an associated time instance overlapping with the window associated with the m1-th measurement. Optionally, refer above for description of the method of determining the window associated with the measurement associated with the third resource set.

Optionally, the CSI in the first CSI report corresponding to the m1-th measurement of the M measurements associated with the third resource set may be the CSI in the first CSI report in the window associated with the m1-th measurement. Optionally, refer above for the method of determining the window associated with the measurement associated with the third resource set. Optionally, the length of the window associated with the m1-th measurement of the M measurements associated with the third resource set is indicated by the base station. For example, the base station indicates the number of time domain units associated with/corresponding to the length of the window via at least one of RRC signaling, MAC-CE, and DCI. Optionally, the length of the window is determined based on the CSI report periodicity associated with the first CSI reporting configuration and/or the periodicity associated with the third resource set. Optionally, when the first CSI report is periodic CSI report, and/or the resources included in the third resource set are SSBs or semi-persistent/periodic CSI-RSs, the length of the window is determined based on the CSI report periodicity associated with the first CSI reporting configuration and/or the periodicity associated with the third resource set. Optionally, the length of the window is determined based on the longer/shorter periodicity of the CSI report periodicity associated with the first CSI reporting configuration and the periodicity associated with the third resource set. Optionally, the length of the window is determined based on the maximum/minimum value of the CSI report periodicity associated with the first CSI reporting configuration and the periodicity associated with the third resource set. For example, the length of the window is a*P. Optionally, P may correspond to the periodicity associated with the third resource set, or the CSI report periodicity associated with the first CSI reporting configuration, or the maximum periodicity/minimum periodicity of the periodicity associated with the third resource set and the CSI report periodicity associated with the first CSI reporting configuration. Here, a may be a scaling factor. The value of a may be one of 1, 2, 3, 4, 5, 6, 7, 8, 12, 16, and 32. Optionally, a may be predefined. Optionally, a may be indicated by the base station. For example, a may be indicated by at least one of RRC signaling, MAC-CE, and DCI. Here, the CSI report periodicity associated with the CSI reporting configuration refers to the CSI report periodicity corresponding to the CSI reporting configuration. For example, if the CSI report corresponding to the CSI reporting configuration is periodic or semi-persistent, the CSI reporting configuration includes a report slot configuration parameter reportSlotConfig, which may indicate the periodicity of CSI report. Here, the periodicity associated with the third resource set refers to the periodicity of the resource in the third resource set. For example, when the third resource set includes semi-persistent/periodic CSI-RS, the periodicity associated with the third resource set refers to the periodicity of the CSI-RS. For example, when the third resource set includes SSB, the periodicity associated with the third resource set refers to the periodicity of SSB.

Optionally, the starting time domain resource/ending time domain resource of the window associated with the m1-th measurement of the M measurements associated with the third resource set is determined based on at least one of the followings:
The indication of the base station, for example, the indication of the second CSI reporting configuration;
The time domain resource of the m1-th measurement; for example, the time domain resource of the transmission occasion of the m1-th measurement;
The length of the window. Refer above for the determination method of the length of the window;
The CSI report periodicity associated with the first CSI reporting configuration; and/or
The periodicity associated with the third resource set.

Optionally, the starting time domain resource/ending time domain resource of the window associated with the m1-th measurement of the M measurements associated with the third resource set is determined based on the time domain resource associated with the m1-th measurement and/or the indication of the base station. For example, the distance between the starting time domain resource/ending time domain resource of the window associated with the m1-th measurement and the time domain resource where the transmission occasion of the m1-th measurement is located is predefined or indicated by the base station. For example, the distance of the starting time domain resource/ending time domain resource of the window associated with the m1-th measurement and the time domain resource (for example, the first time domain resource, or the last time domain resource) associated with the transmission occasion of the m1-th measurement/the transmission occasion of the m1-th measurement is located is predefined or indicated by the base station. For example, the time domain resource offset between the starting time domain resource/ending time domain resource of the window associated with the m1-th measurement and the time domain resource where the transmission occasion of the m1-th measurement is located is Y, where Y may be predefined or indicated by the base station. For example, the value of Y may be one of 1, 2, 3, 4, 5, 6, 7, 8, 12, 16, and 32. For example, Y may be indicated by at least one of RRC, MAC-CE, and DCI. For example, when the time domain resource where the transmission occasion of the m1-th measurement is located is slot n, the time domain resource where the starting time domain resource/ending time domain resource of the window associated with the m1-th measurement is located is slot n−Y or n+Y.

Because the total calculating resources of the UE are limited, it is necessary to specify/determine the calculating resources required by the UE when performing performance monitoring, so that the base station can reasonably allocate the calculating resources of the UE. In the disclosure, “calculating resource” may be used interchangeably with at least one of “computing power,”. “computing capacity,” “occupied calculating resource,” “consumed calculating resource,” “CSI calculating resource,” “resource for AI/ML,” “simultaneous calculating resource for AI/ML,” “calculating resource and/or storage resource for AI/ML,” “CSI processing unit (CPU)” and “number of occupied CPUs.” Optionally, the processing unit may be used for AI/ML correlation. Optionally, the processing unit may be used for AI/ML related CSI calculation. The method for determining the number of occupied CPUs (for example, OCPU) corresponding to the CSI reporting configuration is described below taking CPU as an example. Relevant definitions of OCPU is briefly described below.

The UE may indicate the number of supported simultaneous CSI calculations NCPU with first parameter (for example, simultaneousCSI-ReportsPerCC) in a component carrier, and/or with second parameter (for example, simultaneousCSI-ReportsAllCC) across all component carriers.

If the UE supports NCPU simultaneous CSI calculations it is said to have NCPU CSI processing units for processing CSI reports. If L CPUs are occupied for calculation of CSI reports in a given OFDM symbol, the UE has NCPU−L unoccupied CPUs.

if N CSI reports start occupying their respective CPUs on the same OFDM symbol on which NCPU−L CPUs are unoccupied, where each CSI report n=0, . . . , N−1 corresponds to OCPU(n), the UE is not required to update the N−M requested CSI reports with lowest priority, where 0≤M≤N and M is the largest value such that

$${\sum }_{n = 0}^{M - 1} OCP U ( n ) \leq NCPU - L$$

holds.

In the disclosure, the CSI report occupies a number of CPUs for a number of time domain units. Optionally, a time domain unit may be a slot/symbol. The number of CPUs occupied by a CSI report may be denoted as OCPU.

In the disclosure, “the number of the occupied CPUs (OCPU) corresponding to/associated with the CSI reporting configuration” may be used interchangeably with “the number of CPUs occupied (OCPU) by the CSI report corresponding to/associated with the CSI reporting configuration.”

Optionally, the number of CPUs occupied (OCPU) by the CSI report associated with/corresponding to the second CSI reporting configuration may be a third value. Optionally, the third value may be equal to one of 0, 1, 2, 3, 4, 5, 6, 7 and 8. Optionally, the third value may be predefined. Optionally, the third value may be indicated by the UE capability. Optionally, the third value may be indicated by the base station. Optionally, the third value may be determined based on f. For example, the third value may be F. For example, the third value may be an integer multiple of F. For example, the third value may be F*s, where s≥1. For example, the third value may be an integer multiple of V. For example, the third value may be V*s, where s≥1. Optionally, s is an integer. Optionally, s may be predefined. Optionally, s may be indicated by the UE capability. Optionally, s may be indicated by the base station. Because BAIs corresponding to different time instances may be computed separately, the above method can increase the number of CPUs occupied by CSI calculation as F or V increases, avoiding the insufficiency of CPU calculating resources related to the UE and improving the reliability of the communication system.

The time domain resource/time domain unit of the CPU occupied by the CSI report is discussed below.

Optionally, the time domain unit of the CPU occupied by the CSI report associated with/corresponding to the second CSI reporting configuration is determined based on at least one of the followings: 1) X CSI reports; 2) X transmission occasions of the reference signal in the third resource set associated with the X CSI reports; 3) the earliest CSI report of the X CSI reports; 4) the last CSI report of the X CSI reports; 4) the first transmission occasion of the reference signal in the third resource set associated with the X CSI reports; 5) the last transmission occasion of the reference signal in the third resource set associated with the X CSI reports.

Optionally, the time domain unit of the CPU occupied by the CSI report associated with/corresponding to the second CSI reporting configuration is determined based on at least one of the followings: 1) the time domain unit associated with the X CSI reports; 2) the time domain unit associated with the X transmission occasions of the reference signal in the third resource set associated with the X CSI reports; 3) the time domain unit associated with the earliest CSI report of the X CSI reports; 4) the time domain unit associated with the last CSI report of the X CSI reports; 4) the time domain unit associated with the first transmission occasion of the reference signal in the third resource set associated with the X CSI reports; 5) the time domain unit associated with the last transmission occasion of the reference signal in the third resource set associated with the X CSI reports.

Optionally, the time domain unit of the CPU occupied by the CSI report associated with/corresponding to the second CSI reporting configuration is from a first time domain unit to a second time domain unit.

Optionally, the second time domain unit refers to the time domain unit associated with the uplink channel carrying the CSI report associated with/corresponding to the second CSI reporting configuration. For example, the second time domain unit refers to the last time domain unit of the uplink channel carrying the CSI report associated with/corresponding to the second CSI reporting configuration.

Optionally, the first time domain unit is one of the followings, or the first time domain unit is the earliest one (for example, the first one) of the followings or the first time domain unit is the latest one (for example, the last one) of the followings: 1) the time domain unit associated with the earliest/first CSI report of the X CSI reports; 2) the time domain unit associated with the latest/last CSI report of the X CSI reports; 3) the time domain unit associated with the transmission occasion associated with the earliest/first CSI report of the X CSI reports; 4) the time domain unit associated with the transmission occasion associated with the latest/last CSI report of the X CSI reports.

Optionally, the time domain unit associated with the CSI report may be at least one of the followings: 1) the time domain unit associated with the uplink channel carrying the CSI report; 2) the time domain unit associated with the CSI reference resource corresponding to the CSI report; 3) the time domain unit associated with the transmission occasion of the reference signal resource in the second resource set associated with the CSI report; 4) the time domain unit associated with the transmission occasion of the reference signal resource in the third resource set associated with the CSI report. Optionally, the transmission occasion is the latest transmission occasion no later than the CSI reference resource corresponding to the CSI report. Optionally, the transmission occasion of the reference signal resource in the second resource set associated with the CSI report refers to the latest transmission occasion of the reference signal resource in the second resource set associated with the CSI report no later than the CSI reference resource corresponding to the CSI report.

Optionally, the time domain unit associated with the uplink channel may be the first/last time domain unit of the uplink channel. Optionally, the time domain unit associated with the uplink channel may be the first/last time domain unit where the uplink channel is located.

Optionally, the time domain unit associated with the CSI reference resource may be the first/last time domain unit of the CSI reference resource. Optionally, the time domain unit associated with the CSI reference resource may be the first/last time domain unit where the CSI reference resource is located.

Optionally, the transmission occasion associated with the CSI report may be the transmission occasion associated with the CSI report for computing BAI. Optionally, the transmission occasion associated with the CSI report may be the transmission occasion of the reference signal resource in the third resource set associated with the CSI report.

Optionally, the time domain unit associated with the transmission occasion may be the first/last time domain unit of the transmission occasion. Optionally, the time domain unit associated with the transmission occasion may be the first/last time domain unit where the transmission occasion is located.

Optionally, the above method is applicable to the case of semi-persistent CSI report and/or periodic CSI report. Optionally, the above method is applicable to the case that the first CSI reporting configuration (for example, the first CSI reporting configuration associated with the second CSI reporting configuration) corresponds to semi-persistent CSI report and/or periodic CSI report.

Because the CSI report associated with/corresponding to the second CSI reporting configuration requires comparison of the X CSI reports and the X transmission occasions of the associated resource for monitoring, the comparison may occupy the calculating resources for CSI. Therefore, the above method can allow the CSI report to occupy CPU starting from the time domain unit associated with the X CSI reports and/or the X transmission occasions of the reference signal, preventing the base station/the UE from determining the CPU occupation based on the wrong time domain unit and improving the reliability of the communication system.

In some cases, the first CSI report may be associated with the transmission occasion of the reference signal resource in the third resource set. For example, a first CSI report may be associated with a transmission occasion of the reference signal resource in the third resource set. For example, X first CSI report(s) may be respectively (or one-to-one) associated with X transmission occasion(s) of the reference signal resource in the third resource set. Refer above for the association method between the first CSI report and the transmission occasion of the reference signal resource in the third resource set.

When the UE does not receive enough occasions of the reference signal, the accuracy of the CSI report (for example, the second CSI report) for monitoring cannot be guaranteed. In this case, the UE may not transmit the CSI report in order to save power consumption and improve the efficiency of the communication system. Specific implementation methods are discussed below. Optionally, the UE determines whether to transmit the second CSI report based on the X transmission occasions of the reference signal resource in the third resource set. Optionally, the UE determines whether to transmit the second CSI report based on the reception of the X transmission occasions of the reference signal resource in the third resource set. Optionally, the UE transmits the second CSI report (only) after receiving at least X transmission occasions of the reference signal resource in the third resource set. Otherwise, the UE does not report the second CSI report. Optionally, the UE transmits the second CSI report (only) when receiving at least X transmission occasions of the reference signal resource in the third resource set. Otherwise, the UE does not report the second CSI report. In the disclosure, not reporting the CSI report may include dropping/canceling the CSI report. In the disclosure, the reference signal resource in the third resource set may include each of reference signal resources in the third resource set. In the disclosure, receiving the transmission occasion of the reference signal resource may include measuring/receiving on the transmission occasion of the reference signal resource. The X transmission occasions may be associated with X first CSI report(s). Refer above for description of X transmission occasions. Optionally, the X transmission occasions may be in DRX Active Time. Optionally, when DRX is configured, the X transmission occasions may be in DRX Active Time. Optionally, the X transmission occasions may be in the same DRX Active Time. Optionally, the X transmission occasions may be in active periods of cell DTX. Optionally, when the reference signal resource in the third resource set is in a serving cell and the cell DTX of the serving cell is activated, the X transmission occasions are in the active periods of the cell DTX of the serving cell. Optionally, the X transmission occasions may be in the same active periods of the cell DTX. Optionally, the first CSI report associated with each of the X transmission occasions is transmitted. For example, the X first CSI report(s) associated with the X transmission occasions are all transmitted.

Optionally, the above operations (for example, the UE determines whether to report the second CSI report, or the UE reports the second CSI report, or the UE does not report the second CSI report) may be after at least one of the followings: 1) CSI report (re)configuration; for example, the configuration/reconfiguration of the second CSI reporting configuration; 2) serving cell activation; 3) BWP change; 4) activation of SP-CSI. Optionally, SP-CSI may be semi-persistent CSI. Optionally, SP-CSI may be a semi-persistent CSI report.

In the disclosure, DTX refers to Discontinuous Transmission. DRX refers to Discontinuous Reception.

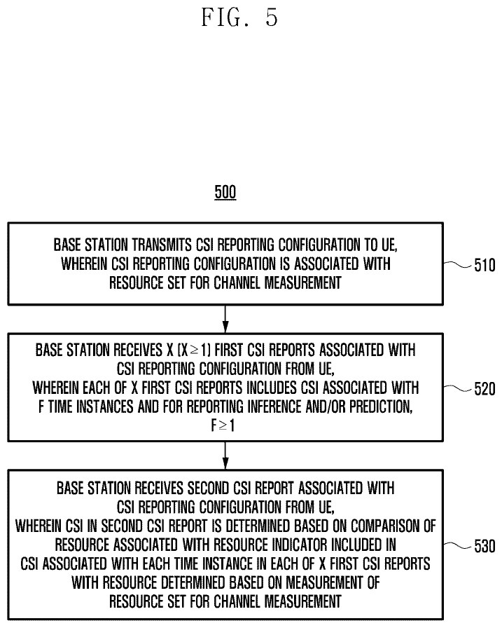

FIG. 5 illustrates a method 500 performed by a base station according to various embodiments of the disclosure. The method 500 includes: at 510, the base station transmits a CSI reporting configuration to the UE, wherein the CSI reporting configuration is associated with a resource set for channel measurement; at 520, the base station receives X (X≥1) first CSI report(s) associated with the CSI reporting configuration from the UE, wherein each of the X first CSI report(s) includes CSI associated with F time instance(s) and for reporting inference and/or prediction, F≥1; and at 530, the base station receives a second CSI report associated with the CSI reporting configuration from the UE, wherein CSI in the second CSI report is determined based on comparison of a resource associated with a resource indicator included in CSI associated with each time instance in each of the X first CSI report(s) with a resource determined based on measurement of the resource set for channel measurement.

According to an embodiment, a method performed by a user equipment (UE) in a wireless communication system, the method comprising: receiving a channel state information (CSI) reporting configuration, wherein the CSI reporting configuration is associated with a resource set for channel measurement; reporting X first CSI report(s), wherein CSI in each of the X first CSI reports is for reporting at least one of inference or prediction and is associated with F time instances, F≥1; and reporting a second CSI report, wherein CSI in the second CSI report is determined based on a comparison of a resource associated with a resource indicator included in CSI associated with each time instance in each of the X first CSI reports with a resource determined based on measurement of the resource set for channel measurement.

According to an embodiment, wherein the CSI reporting configuration indicates a number N1 of reported resources, each of the X first CSI reports includes N1 resource indicators, and wherein the CSI in the second CSI report is determined based on a comparison of resources associated with the N1 resource indicators in CSI associated with an f-th time instance in an x-th CSI report of the X first CSI reports and the resource is determined based on measurement of the resource set for channel measurement, wherein x is an integer value ranged from 1 to X and f is an integer value ranged from 1 to F.

According to an embodiment, the method further comprises: determining whether a resource with a highest measured layer 1-reference signal received power (L1-RSRP) of the resource set for channel measurement determined based on measurement of the resource set for channel measurement is one of the resources associated with the N1 resource indicators in the CSI associated with the f-th time instance in the x-th CSI report.

According to an embodiment, wherein the resources associated with the N1 resource indicators comprise: a resource associated with each of the N1 resource indicators; or a resource associated with one of the N1 resource indicators.

According to an embodiment, further comprising: determining whether the resource associated with one of the N1 resource indicators in the CSI associated with the f-th time instance in the x-th CSI report is one of N2 resources with a highest L1-RSRP of the resource set for channel measurement determined based on measurement of the resource set for channel measurement, N2≥1, wherein N2 is indicated by the CSI reporting configuration.

According to an embodiment, wherein the method further comprises: determining whether a difference of measured L1-RSRP of the resource associated with one of the N1 resource indicators in the CSI associated with the f-th time instance in the x-th CSI report and a highest measured L1-RSRP determined based on measurement of the resource set for channel measurement is less than a threshold, wherein the threshold is a predefined value, or the threshold is indicated by a base station, or the threshold is determined based on UE capability.

According to an embodiment, wherein one of the N1 resource indicators comprises: a resource indicator with a largest predicted L1-RSRP; or a first resource indicator of the N1 resource indicators.

According to an embodiment, wherein a value of the CSI in the second CSI report is k, 0≤k≤X, k is a number of CSI reports with results of corresponding comparison being true of the X first CSI reports, and wherein accuracy rate corresponding to the CSI in the second CSI report is k/X, and a size of a field of the CSI in the second CSI report is ┌log₂(X+1)┐ or log₂(X+1), wherein ┌log₂(X+1)┐ represents round up of log₂(X+1).

According to an embodiment, wherein the result of the corresponding comparison being true in the first CSI report comprises: results of the comparison of all time instances associated with the first CSI report being true; or a result of the comparison of at least one time instance associated with the first CSI report being true.

According to an embodiment, wherein a value of the CSI in the second CSI report is k, 0≤k≤F*X, k is a number of time instances with results of corresponding comparison associated with the X first CSI report(s) being true, and wherein accuracy rate corresponding to the CSI in the second CSI report is

$$\frac{k}{F \cdot X} ,$$

and a size of a field of the CSI in the second CSI report is ┌log₂(F·X+1)┐ or log₂(F·X+1), wherein ┌log₂(F·X+1)┐ represents round up of log₂(F·X+1).

According to an embodiment, wherein the CSI reporting configuration indicates a resource set for at least one of prediction or inference, and wherein the resource indicator corresponds to a resource of the resource set for the at least one of prediction or inference, and the resource associated with the resource indicator includes a resource of the resource set for channel measurement mapped with the resource of the resource set for the at least one of prediction or inference corresponding to the resource indicator.

According to an embodiment, wherein: each resource of the resource set for the at least one of prediction or inference is mapped with a resource of the resource set for channel measurement; or each resource of the resource set for channel measurement is mapped with a resource of the resource set for the at least one of prediction or inference.

According to an embodiment, wherein: each resource of the resource set for the at least one of prediction and inference is mapped with a resource of the resource set for channel measurement based on the CSI reporting configuration; each resource of the resource set for channel measurement is mapped with a resource of the resource set for the at least one of prediction or inference based on the CSI reporting configuration; when a number of resources of the resource set for the at least one of prediction or inference is a same as a number of resources of the resource set for channel measurement, an i-th resource of the resource set for the at least one of prediction or inference is mapped with the i-th resource of the resource set for channel measurement; or the i-th resource of the resource set for the at least one of prediction or inference is mapped with an ┌i/D┐-th resource of the resource set for channel measurement, where D≥1, and ┌i/D┐ represents round up of.

According to an embodiment, wherein the X first CSI reports are no later than the second CSI report or each time instance associated with each of the X first CSI reports is no later than the second CSI report.

According to an embodiment, wherein the measurement of the resource set for channel measurement comprises at least one of: measurement of a transmission occasion of a resource of the resource set for channel measurement, or measurement of the resource set for channel measurement in a window associated with a time instance.

According to an embodiment, a user equipment (UE) in a wireless communication system comprises a transceiver configured to receive a channel state information (CSI) reporting configuration, wherein the CSI reporting configuration is associated with a resource set for channel measurement; and at least one processor operably coupled to the transceiver, the at least one processor configured to: report X first CSI report(s), wherein CSI in each of the X first CSI reports is for reporting at least one of inference or prediction and is associated with F time instances, F≥1; and report a second CSI report, wherein CSI in the second CSI report is determined based on a comparison of a resource associated with a resource indicator included in CSI associated with each time instance in each of the X first CSI reports with a resource determined based on measurement of the resource set for channel measurement.

According to an embodiment, wherein: the CSI reporting configuration indicates a number N1 of reported resources, each of the X first CSI reports includes N1 resource indicators, and the CSI in the second CSI report is determined based on a comparison of resources associated with the N1 resource indicators in CSI associated with an f-th time instance in an x-th CSI report of the X first CSI reports and the resource is determined based on measurement of the resource set for channel measurement, wherein x is an integer value ranged from 1 to X and f is an integer value ranged from 1 to F.

According to an embodiment, wherein the at least one processor is further configured to determine whether a resource with a highest measured layer 1-reference signal received power (L1-RSRP) of the resource set for channel measurement determined based on measurement of the resource set for channel measurement is one of the resources associated with the N1 resource indicators in the CSI associated with the f-th time instance in the x-th CSI report.

According to an embodiment, wherein the resources associated with the N1 resource indicators comprise: a resource associated with each of the N1 resource indicators; or a resource associated with one of the N1 resource indicators.

According to an embodiment, wherein: the at least one processor is further configured to determine whether the resource associated with one of the N1 resource indicators in the CSI associated with the f-th time instance in the x-th CSI report is one of N2 resources with a highest L1-RSRP of the resource set for channel measurement determined based on measurement of the resource set for channel measurement, N2≥1, and N2 is indicated by the CSI reporting configuration.

According to an embodiment, a method performed by a user equipment (UE) in a communication system comprises: receiving a first channel state information (CSI) report configuration associated with predicted CSI; receiving a second CSI report configuration including an identifier (ID) of the first CSI report configuration; identifying that the second CSI report configuration is associated with the first CSI report configuration based on the ID of the first CSI report configuration; determining at least one transmission occasion corresponding to the second CSI report configuration; and transmitting a CSI report including a report quantity field associated with a number of the at least one transmission occasion, wherein the at least one transmission occasion includes a transmission occasion where: the transmission occasion corresponding to the second CSI report configuration is associated with a report corresponding to the first CSI report configuration; and a resource in a resource set for channel measurement corresponding to the second CSI report configuration associated with the transmission occasion is mapped to one of a first number of resource indicators of the associated report.

According to an embodiment, wherein the transmission occasion being associated with the report is identified based on a slot corresponding to a f-th time instance among F time instances of the report has a minimal slot offset from a slot corresponding to the transmission occasion, and wherein the first CSI report configuration includes information indicating a value of F.

According to an embodiment, wherein the first number of resources indicators are associated with the f-th time instance among F time instances.

According to an embodiment, wherein the transmission occasions are included in X transmission occasions no later than a CSI reference resource corresponding to the second CSI report configuration, wherein size of the field is ┌log₂(X+1)┐, and wherein the second CSI report configuration includes information indicating X.

According to an embodiment, wherein the CSI report is transmitted in case of receiving at least the X transmission occasions of reference signal resources in the resource set no later than the CSI reference resource, after CSI report configuration, CSI report reconfiguration, serving cell activation, bandwidth part (BWP) change, or activation of semi-persistent CSI.

According to an embodiment, wherein the resource is included in a second number of resources in the resource set, wherein the first CSI report configuration includes information indicating the first number, and wherein the second CSI report configuration includes information indicating the second number.

According to an embodiment, a method performed by a base station in a communication system comprises transmitting a first channel state information (CSI) report configuration associated with predicted CSI; transmitting a second CSI report configuration including an identifier (ID) of the first CSI report configuration, wherein the second CSI report configuration being associated with the first CSI report configuration is indicated based on the ID of the first CSI report configuration; and receiving a CSI report including a report quantity field associated with a number of the at least one transmission occasion corresponding to the second CSI report configuration, wherein the at least one transmission occasion includes a transmission occasion where: the transmission occasion corresponding to the second CSI report configuration is associated with a report corresponding to the first CSI report configuration; and a resource in a resource set for channel measurement corresponding to the second CSI report configuration associated with the transmission occasion is mapped to one of a first number of resource indicators of the associated report.

According to an embodiment, wherein the transmission occasion being associated with the report is identified based on a slot corresponding to a f-th time instance among F time instances of the report has a minimal slot offset from a slot corresponding to the transmission occasion, wherein the first CSI report configuration includes information indicating a value of F, and wherein the first number of resources indicators are associated with the f-th time instance among F time instances.

According to an embodiment, wherein the transmission occasions are included in X transmission occasions no later than a CSI reference resource corresponding to the second CSI report configuration, wherein size of the field is ┌log₂(X+1)┐, wherein the second CSI report configuration includes information indicating X, and wherein the CSI report is transmitted in case of receiving at least the X transmission occasions of reference signal resources in the resource set no later than the CSI reference resource, after CSI report configuration, CSI report reconfiguration, serving cell activation, bandwidth part (BWP) change, or activation of semi-persistent CSI.

According to an embodiment, wherein the resource is included in a second number of resources in the resource set, wherein the first CSI report configuration includes information indicating the first number, and wherein the second CSI report configuration includes information indicating the second number.

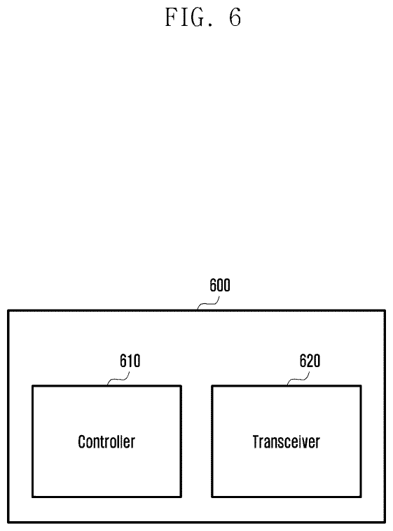

FIG. 6 illustrates a structure 600 of a user equipment according to various embodiments of the disclosure. As shown in FIG. 6, the user equipment 600 includes a controller 610 and a transceiver 620, where the controller 610 is configured to perform various methods disclosed herein as performed by the user equipment, and the transceiver 620 is configured to transmit and receive channels or signals.

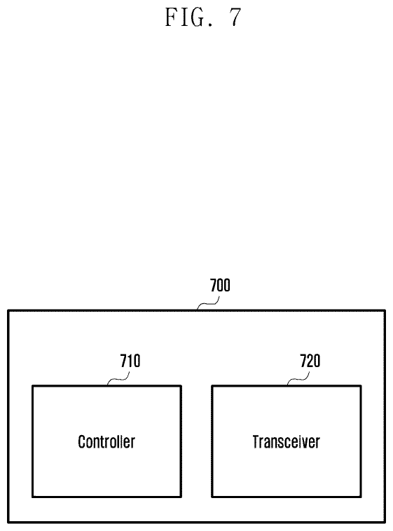

FIG. 7 illustrates a structure 700 of a base station according to various embodiments of the disclosure. As shown in FIG. 7, the network device 700 includes a controller 710 and a transceiver 720, where the controller 710 is configured to perform various methods disclosed herein as performed by the network device, and the transceiver 720 is configured to transmit and receive channels or signals.

Furthermore, “at least one of/at least one” described in the present disclosure includes any and/or all possible combinations of the listed items, and various embodiments and various examples of the embodiments described in the present disclosure may be changed and combined in any appropriate form, and “/” described in the present disclosure means “or.”

The various illustrative logical blocks, modules, and circuits described in the present disclosure may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. The general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in this disclosure may be embodied directly in hardware, in a software module executed by a processor, or in a combination of both. A software module may reside in RAM memory, flash memory, ROM memory, EPROM memory, EEPROM memory, registers, hard disk, a removable disk, or any other form of storage medium known in the art. An exemplary storage medium is coupled to the processor such the processor can read information from, and write information to, the storage medium. In the alternative, the storage medium may be integrated to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored in computer-readable media or transmitted over computer-readable media as one or more instructions or code. Computer-readable media includes both computer storage media and communication media including any medium that facilitates transfer of a computer program from one place to another. Storage media may be any available media that can be accessed by a general purpose or special purpose computer.

The description set forth herein, in connection with the appended drawings, describes example configurations, methods, and apparatuses and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

While this specification contains many specific implementation details, these should not be construed as limitations on the scope of any disclosure or of what may be claimed, but rather as descriptions of features specific to particular embodiments of particular disclosure. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be deleted from the combination, and the claimed combination may be directed to a subcombination or variation of the subcombination.

It is to be understood that the specific order or hierarchy of steps in the methods of the present disclosure is an illustration of exemplary processes. Based on design preferences, it is understood that the specific order or hierarchy of steps in the methods may be rearranged to achieve the functions and effects disclosed in the present disclosure. The accompanying method claims present elements of the various steps in an example order, and are not meant to be limited to the specific order or hierarchy presented unless specifically recited therein. Furthermore, although elements may be described or claimed in the singular, the plural form is contemplated unless limitation to the singular is explicitly stated. Accordingly, the disclosure is not limited to illustrated examples and any means for performing the function described herein are included in aspects of the disclosure.

The text and drawings are provided as examples only to aid the reader in understanding the present disclosure. They are not intended, nor should they be construed, to limit the scope of the disclosure in any way. Although certain embodiments and examples have been provided, it will be apparent to those skilled in the art, based on this disclosure, that changes can be made to the embodiments and examples shown without departing from the scope of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving a first channel state information (CSI) report configuration associated with predicted CSI;
receiving a second CSI report configuration including an identifier (ID) of the first CSI report configuration;
identifying that the second CSI report configuration is associated with the first CSI report configuration based on the ID of the first CSI report configuration;
determining at least one transmission occasion corresponding to the second CSI report configuration; and
transmitting a CSI report including a report quantity field associated with a number of the at least one transmission occasion,
wherein the at least one transmission occasion includes a transmission occasion where:
the transmission occasion corresponding to the second CSI report configuration is associated with a report corresponding to the first CSI report configuration; and
a resource in a resource set for channel measurement corresponding to the second CSI report configuration associated with the transmission occasion is mapped to one of a first number of resource indicators of the associated report.

2. The method of claim 1, wherein the transmission occasion being associated with the report is identified based on a slot corresponding to a f-th time instance among F time instances of the report has a minimal slot offset from a slot corresponding to the transmission occasion, and
wherein the first CSI report configuration includes information indicating a value of F.

3. The method of claim 2, wherein the first number of resources indicators are associated with the f-th time instance among F time instances.

4. The method of claim 1, wherein transmission occasions are included in X transmission occasions no later than a CSI reference resource corresponding to the second CSI report configuration,
wherein size of the field is ┌log₂ [symbol] (X [symbol] +1)┐, and
wherein the second CSI report configuration includes information indicating X.

5. The method of claim 4, wherein the CSI report is transmitted in case of receiving at least the X transmission occasions of reference signal resources in the resource set no later than the CSI reference resource, after CSI report configuration, CSI report reconfiguration, serving cell activation, bandwidth part (BWP) change, or activation of semi-persistent CSI.

6. The method of claim 1, wherein the resource is included in a second number of resources in the resource set,
wherein the first CSI report configuration includes information indicating the first number, and
wherein the second CSI report configuration includes information indicating the second number.

7. A user equipment (UE) in a communication system, the UE comprising:
a transceiver; and
a processor coupled with the transceiver and configured to:
receive a first channel state information (CSI) report configuration associated with predicted CSI;
receive a second CSI report configuration including an identifier (ID) of the first CSI report configuration;
identify that the second CSI report configuration is associated with the first CSI report configuration based on the ID of the first CSI report configuration;
determine at least one transmission occasion corresponding to the second CSI report configuration; and
transmit a CSI report including a report quantity field associated with a number of the at least one transmission occasion,
wherein the at least one transmission occasion includes a transmission occasion where:
the transmission occasion corresponding to the second CSI report configuration is associated with a report corresponding to the first CSI report configuration; and
a resource in a resource set for channel measurement corresponding to the second CSI report configuration associated with the transmission occasion is mapped to one of a first number of resource indicators of the associated report.

8. The UE of claim 7, wherein the transmission occasion being associated with the report is identified based on a slot corresponding to a f-th time instance among F time instances of the report has a minimal slot offset from a slot corresponding to the transmission occasion, and
wherein the first CSI report configuration includes information indicating a value of F.

9. The UE of claim 8, wherein the first number of resources indicators are associated with the f-th time instance among F time instances.

10. The UE of claim 7, wherein transmission occasions are included in X transmission occasions no later than a CSI reference resource corresponding to the second CSI report configuration,
wherein size of the field is ┌log₂ [symbol] (X [symbol] +1)┐, and
wherein the second CSI report configuration includes information indicating X.

11. The UE of claim 10, wherein the CSI report is transmitted in case of receiving at least the X transmission occasions of reference signal resources in the resource set no later than the CSI reference resource, after CSI report configuration, CSI report reconfiguration, serving cell activation, bandwidth part (BWP) change, or activation of semi-persistent CSI.

12. The UE of claim 7, wherein the resource is included in a second number of resources in the resource set,
wherein the first CSI report configuration includes information indicating the first number, and
wherein the second CSI report configuration includes information indicating the second number.

13. A method performed by a base station in a communication system, the method comprising:
transmitting a first channel state information (CSI) report configuration associated with predicted CSI;
transmitting a second CSI report configuration including an identifier (ID) of the first CSI report configuration, wherein the second CSI report configuration being associated with the first CSI report configuration is indicated based on the ID of the first CSI report configuration; and
receiving a CSI report including a report quantity field associated with a number of at least one transmission occasion corresponding to the second CSI report configuration,
wherein the at least one transmission occasion includes a transmission occasion where:
the transmission occasion corresponding to the second CSI report configuration is associated with a report corresponding to the first CSI report configuration; and
a resource in a resource set for channel measurement corresponding to the second CSI report configuration associated with the transmission occasion is mapped to one of a first number of resource indicators of the associated report.

14. The method of claim 13, wherein the transmission occasion being associated with the report is identified based on a slot corresponding to a f-th time instance among F time instances of the report has a minimal slot offset from a slot corresponding to the transmission occasion,
wherein the first CSI report configuration includes information indicating a value of F, and
wherein the first number of resources indicators are associated with the f-th time instance among F time instances.

15. The method of claim 13, wherein transmission occasions are included in X transmission occasions no later than a CSI reference resource corresponding to the second CSI report configuration,
wherein size of the field is ┌log₂ [symbol] (X [symbol] +1)┐,
wherein the second CSI report configuration includes information indicating X, and
wherein the CSI report is transmitted in case of receiving at least the X transmission occasions of reference signal resources in the resource set no later than the CSI reference resource, after CSI report configuration, CSI report reconfiguration, serving cell activation, bandwidth part (BWP) change, or activation of semi-persistent CSI.

16. The method of claim 13, wherein the resource is included in a second number of resources in the resource set,
wherein the first CSI report configuration includes information indicating the first number, and
wherein the second CSI report configuration includes information indicating the second number.

17. Abase station in a communication system, the base station comprising:
a transceiver; and
a processor coupled with the transceiver and configured to:
transmitting a first channel state information (CSI) report configuration associated with predicted CSI;
transmitting a second CSI report configuration including an identifier (ID) of the first CSI report configuration, wherein the second CSI report configuration being associated with the first CSI report configuration is indicated based on the ID of the first CSI report configuration; and
receiving a CSI report including a report quantity field associated with a number of at least one transmission occasion corresponding to the second CSI report configuration,
wherein the at least one transmission occasion includes a transmission occasion where:
the transmission occasion corresponding to the second CSI report configuration is associated with a report corresponding to the first CSI report configuration; and
a resource in a resource set for channel measurement corresponding to the second CSI report configuration associated with the transmission occasion is mapped to one of a first number of resource indicators of the associated report.

18. The base station of claim 17, wherein the transmission occasion being associated with the report is identified based on a slot corresponding to a f-th time instance among F time instances of the report has a minimal slot offset from a slot corresponding to the transmission occasion,
wherein the first CSI report configuration includes information indicating a value of F, and
wherein the first number of resources indicators are associated with the f-th time instance among F time instances.

19. The base station of claim 17, wherein transmission occasions are included in X transmission occasions no later than a CSI reference resource corresponding to the second CSI report configuration,
wherein size of the field is ┌log₂ [symbol] (X [symbol] +1)┐,
wherein the second CSI report configuration includes information indicating X, and
wherein the CSI report is transmitted in case of receiving at least the X transmission occasions of reference signal resources in the resource set no later than the CSI reference resource, after CSI report configuration, CSI report reconfiguration, serving cell activation, bandwidth part (BWP) change, or activation of semi-persistent CSI.

20. The base station of claim 17, wherein the resource is included in a second number of resources in the resource set,
wherein the first CSI report configuration includes information indicating the first number, and
wherein the second CSI report configuration includes information indicating the second number.
